(19) United States
(12) Patent Application Publication
(10) Pub. No.: US 2016/0022541 A1
(43) Pub. Date: Jan. 28, 2016

(54) SYSTEM AND METHOD FOR SECURE MEDICATION DISPENSING

(71) Applicant: EXACTMED LTD., Toronto (CA)

(72) Inventors: Aliasgher Abbas Ali DALAL, Toronto (CA); Syed Akhtar Hasnain NAJMI, Toronto (CA)

(21) Appl. No.: 14/808,727

(22) Filed: Jul. 24, 2015

Related U.S. Application Data
(60) Provisional application No. 62/028,357, filed on Jul. 24, 2014.
(60) Provisional application No. 62/028,363, filed on Jul. 24, 2014.
(60) Provisional application No. 62/028,392, filed on Jul. 24, 2014.
(60) Provisional application No. 62/029,489, filed on Jul. 27, 2014.
(60) Provisional application No. 62/028,410, filed on Jul. 24, 2014.
(60) Provisional application No. 62/028,514, filed on Jul. 24, 2014.
(60) Provisional application No. 62/029,529, filed on Jul. 27, 2014.

(51) Int. Cl. A61J 7/00; A61J 7/04; A61J 7/02

(52) U.S. Cl. CPC A61J 7/0084; A61J 7/02; A61J 7/0418; A61J 7/0454; A61J 7/0436; A61J 7/049; A61J 2205/10; A61J 2205/30; A61J 2205/60; A61J 2205/00

(57) ABSTRACT

A dispenser and vial system is disclosed. At least one vial is loaded into a dispenser to automatically dispense dosages of medication made up of units of medication. The vial stores and releases the units of medication. The dispenser has a delivery mechanism configured to dispense a plurality of units of medication (from one or more vials) to make up a dosage of medication, and trigger or actuate the release of the plurality of units of medication based on information on the at least one vial readable by the dispenser to validate the at least one vial prior to the trigger or actuation by a link between, the dosage of medication, a user or patient and the at least one vial.

### CROSS-REFERENCE TO RELATED APPLICATIONS

This application claims the benefit of U.S. Provisional Application No. 62/028,357 filed Jul. 24, 2014, U.S. Provisional Application No. 62/028,363 filed Jul. 24, 2014, U.S. Provisional Application No. 62/028,392 filed Jul. 24, 2014, and U.S. Provisional Application No. 62/029,489 filed Jul. 27, 2014, the content of each of which is hereby incorporated by reference in its entirety. This application claims the benefit of U.S. Provisional Application No. 62/028,410 filed Jul. 24, 2014, U.S. Provisional Application No. 62/028,514 filed Jul. 24, 2014, U.S. Provisional Application No. 62/029,529 filed Jul. 27, 2014, the content of each of which is hereby incorporated by reference in its entirety.

### FIELD

The improvements generally relate to the field of medicine, healthcare and health information technology, and in particular, to dispensing of medication by a secure system.

### INTRODUCTION

Today medication is prescribed by physicians and fulfilled by individual pharmacies. When patients receive the fulfilled medication from the pharmacies, it may be in the form of a pill bottle or blister packs. A challenge faced by patients and health care providers is that once the medication has left the pharmacy's counter, health care providers or pharmacist have no control over how the medication is taken. It may be entirely up to the patients, or the patient's family members or caregiver, to adhere to the prescribed medication schedule, which may lead to missed or delayed medication taking or worse, accidental overdose on human error. Occasionally, for controlled substances such as Oxycodone (a pain killer), the medication may be tampered with or abused by patients or patient's family members, without the knowledge of the physician or the pharmacist. For example, if the medication is in the form of pills in bottles, these bottles are often used by the patients to manually dispense the medication for themselves.

Compliance and adherence with a prescribed medication schedule is often critical in helping a patient get better. Therefore, solutions are needed to improve various aspects of medications management.

### SUMMARY

In accordance with one aspect, there is provided a vial for storing and automatically dispensing medication. The vial may include: a housing comprising a medication information label area readable by a dispensing device to validate the vial and a user receiving the medication; a first opening at a first end of the housing; and a container storing a plurality of units of medication, each unit of medication of a same amount of medication, the container including a plurality of slots, each slot configured to release a single unit of medication of the plurality of units of medication through the first opening when the respective slot is aligned with the first opening, wherein the first opening is configured to engage with the dispensing device to trigger dispensing of a dosage of medication made up of a number of units of medication of the plurality of units of medication of the vial, the dispensing by a number of slots of the plurality of slots corresponding to the number of units of medication.

In one embodiment, the first opening may be sealed prior to engagement with the dispensing device.

In another embodiment, there may be provided a locking mechanism configured to engage with a corresponding locking mechanism of the dispensing device to secure the vial within the dispensing device.

In yet another embodiment, the vial may include a second opening at a second end of the housing, the second opening configured to receive the plurality of units of medication and to be sealed after the plurality of units of medication have been stored within the vial.

In still another embodiment, the medication information label area may include machine-readable data comprising one or more of: an identification number, patient information, medication information, dosage information, user information linking the vial to the user receiving the medication, and tamper evidence information.

In one embodiment, the machine-readable data may include a bar code, a QR code, a NFC circuit, or other electronic chip.

In another embodiment, the plurality of units of medication are arranged within a strip of medication, the strip containing the plurality of slots on one or more sides of the strip.

In still another embodiment, one or more disks may be included within the housing, each disk comprising one or more slots of the plurality of slots, each slot configured to release a unit of medication.

In yet another embodiment, the one or more disks are configured to rotate about a common axis to align a slot of the one or more slots with the first opening to release the unit of medication through the respective slot.

In one embodiment, the one or more disks are configured to dispense a unit of medication by aligning a slot containing the unit of medication with the first opening.

In another embodiment, the dispensing device rejects the vial if it cannot validate the vial or the user using the medication information label area.

In yet another embodiment, the container comprises one or more spur gears that engage the dispensing device to rotate the container about a common axis to align one of the plurality of slots at a time with the first opening to release the corresponding unit of medication of the respective slot.

In still another embodiment, the container has two faces, one face having a set of slots for releasing a first type of medication and the other face having a set of slots for releasing a second type of medication, the dosage of medication made up of the first and second type of medication.

In one embodiment, there is provided a dispensing device configured to automatically dispense a dosage of medication made up of a number of units of medication released from one or more vials. The dispensing device may include: a housing; one or more inlets on an upper portion of the housing, each inlet configured to receive one of the one or more vials; an outlet on a lower portion of the housing, the outlet configured to receive a dosage of medication made up of one or more units of medication released from at least one of the one or more vials; a sensor within the housing configured to receive information from at least one of the one or more vials to validate the at least one vial, the dosage of medication, and a user receiving the dosage of medication; and an actuating mechanism to actuate releasing of the dosage of medication from the one or more vials upon a trigger based on the information received from at least one vial.

In one embodiment, the dispensing device is wirelessly connected to a network to receive data to validate the at least one vial and transmit compliance or adherence data after dispensing.

In another embodiment, the actuating mechanism comprises a gear configured to engage the at least one of the one or more vials or at least a portion of the one or more vials.

In still another embodiment, the dispensing device is configured to, for each of the one or more vials based on information of the vial, determine or receive: vial identification, current amount of available units of medication, patient or user information, medication and dosage information and tamper evidence information.

In yet another embodiment, the dispensing device is configured to trigger the actuating mechanism for releasing of the one or more units of medication from one or more vials based on the medication and dosage information.

In one embodiment, the medication and dosage information may include one or more of: medication ingredients, total dosages available, prescribed usage, current amount of available units of medication, and timing information for taking medication.

In another embodiment, the dispensing device is configured to receive, from an external device via a network communication interface, a stop notification relating to medication contained in a vial of the one or more vials and stop dispensing using the vial based on the stop notification.

In still another embodiment, the stop notification is based on at least one of a recall notification, a physician discretionary notification, expiry notification, safety notification, and prescription notification.

In accordance with one aspect, there is provided a system for automatically dispensing medication. The system may include a plurality of vials, each vial storing a plurality of units of medication, and a dispensing device to dispense of a dosage of medication made up of a number of units of medication of one or more vials of the plurality of vials, the dosage of medication of released by the one or more vials. Each of the plurality of vials may have: a housing comprising a medication information label area readable by a dispensing device to validate the vial; a first opening at a first end of the housing; and a container storing the plurality of units of medication, each unit of medication of a same amount of medication, the container comprising a plurality of slots, each slot configured to release a single unit of medication of the plurality of units of medication.

In one embodiment, the dispensing device may have: a housing; one or more inlets on an upper portion of the housing, each inlet configured to receive one of the one or more vials; an outlet on a lower portion of the housing, the outlet configured to receive the dosage of medication from at least one of the one or more vials; and a sensor within the housing configured to receive information from at least one of the one or more vials about the dosage of medication; and an actuating mechanism to actuate each vial of the one or more vials to align at least one slot of the plurality of slots of the respective vial with the first opening of the respective vial, upon a trigger based on the information received from the respective vial, releasing of the dosage of medication by a number of slots of the plurality of slots corresponding to the number of units of medication.

In another embodiment, the dosage of medication is made up of at least two types of medication stored by the one or more vials.

In accordance with another aspect, there is provided a method of automatically dispensing a dosage of medication made up of a number of units of medication released from one or more vials by a dispensing device, the method comprising: a) receiving information, by a sensor on a dispensing device, from an information label area on at least one of the one or more vials loaded within the dispensing device; b) verifying, by the dispensing device, based on the received information, that the vials are associated with a user authorized to receive the dosage of medication; c) determining, by the dispensing device, based on the received information, the dosage of medication for a patient or user, the dosage made up of the number of units of medication, and medication information; d) determining, by the dispensing device, which vials of the one or more vials have available units of medication to make up the dosage of medication; and d) engaging a trigger within the dispensing device to release the one or more units of medication from the one or more vials to dispense the dosage of medication.

In one embodiment, the method may include scanning each of the vials to determine a number of available units of medication for each of the vials.

In another embodiment, the method includes scanning to determine presence or absence of a unit of medication inside a vial slot to ensure dispensing operation on the slot is performed.

In yet another embodiment, the method includes scanning to generate a geo-mapping of the vial to indicate if each slot does or does not have a unit of medication.

In still another embodiment, the method includes verifying the determined number of available units of medication by comparison to the received data from the information label area.

In one embodiment, the method includes scanning, by the dispensing device, for each of the vials, for tampering by detecting a seal on each of the vials.

In another embodiment, engagement of the trigger is dependent on a current date and a current time, and wherein the received information further includes timing information for engaging the trigger to release the dosage of medication.

In another embodiment, the method includes performing verification on one or more of: vial identity, patient identity, tamper evidence of the one or more vials, a link between the one or more vials and a patient or a user, and location of the one or more vials.

In still another embodiment, the method includes discharging the vial by the dispensing device once the vial is emptied of the units of medication or else if the vial is not emptied of the units of medication the discharging is without compromising tampering evidence on the vial.

In yet another embodiment, the method includes counting the released units of medication in a holding chamber of the dispensing device.

In one embodiment, each of the one or more vials contains a strip of the units of medication, and the strip of the units of medication comprises a single array of the units of medication, the strip of the units of medication having a plurality of pre-cut slots on opposing sides of the strip, such that each unit of medication in the array of units of medication is aligned with a left slot and a right slot.

In another embodiment, the method includes, upon engagement of the trigger, actuating a gear mechanism to engage the left slot and the right slot of a single unit of medication from the strip of units of medication.

In yet another embodiment, the method includes comprising cutting open the blister pack to release the single unit of medication from the strip of units of medication.

In still another embodiment, the method includes producing a compliance package based on the medication dosage for the flexible requested or pre-configured duration.

In accordance with yet another aspect, a dispenser-and-vial system is provided, the system including at least one vial with a delivery mechanism configured to dispense a plurality of units of medication to make up a dosage of medication, the release of the plurality of units of medication triggered or actuated by the dispenser based on information on the at least one smart vial readable by the dispenser to validate each of the at least one vial prior to the trigger or actuation by a link between, the dosage of medication, a user or patient and the respective vial.

In one embodiment, the dispenser collects adherence data from the triggers and actuations for initiating dosage dispensing and a number of units of medication within the vial, and the information on the at least one vial readable by the dispenser.

In another embodiment, adherence data further includes prescription transaction events and prescription scheduling events.

In still another embodiment, the system further includes a packaging layer to convert the bulk medications sent from the pharmaceutical into the spools of strips of units of medications or disk vials batches with each vial containing units of medications as requested by pharmacy(ies).

Many further features and combinations thereof concerning embodiments described herein will appear to those skilled in the art following a reading of the instant disclosure.

### BRIEF DESCRIPTION OF THE FIGURES

In the Figures,

FIG. 1 shows a schematic diagram of an example architecture for a medication dispensing system 10, exemplary of an embodiment;

FIG. 2A shows a schematic diagram of a dispensing device 100 of FIG. 1, exemplary of an embodiment;

FIG. 2B shows a schematic diagram of a computing device that may be used to implement the controller 22 of FIG. 2A;

FIG. 3 is a perspective view of a dispensing device 100 with a magazine 5000 loaded therein, exemplary of an embodiment;

FIG. 4 is a perspective view of a magazine 5000 of FIG. 3, comprised of a plurality of vials 30, exemplary of an embodiment;

FIG. 5 is a perspective view of a vial, exemplary of another embodiment;

FIG. 6 is a perspective view of a covering disk for a vial;

FIG. 7A is a front view of a flange for a vial;

FIG. 7B is a perspective view of the flange for a vial;

FIG. 7C is another perspective view of the flange for a vial;

FIG. 7D is yet another perspective view of the flange for a vial;

FIG. 8A is a front view of a second flange for a vial;

FIG. 8B is a perspective view of the second flange for a vial;

FIG. 8C is a side view of the second flange for a vial;

FIG. 8D is yet another perspective view of the second flange for a vial;

FIG. 9A is a front perspective view of a spur gear;

FIG. 9B is a perspective view of the spur gear;

FIG. 9C is a side view of the spur gear;

FIG. 9D is yet another perspective view of the spur gear;

FIG. 9E is a back view of the spur gear;

FIG. 10A is a front view of a body of a vial (or vial body);

FIG. 10B is a perspective view of the vial body;

FIG. 10C is another perspective view of the vial body;

FIG. 10D is yet another perspective view of the vial body;

FIG. 11A is a front view of a vial assembly including a flange, a second flange, a spur gear and a vial body;

FIG. 11B is a perspective view of the vial assembly;

FIG. 11C is a side view of the vial assembly;

FIG. 11D is yet another side view of the vial assembly;

FIG. 11E is another perspective view of the vial assembly;

FIG. 12A is a front view of an inner gear;

FIG. 12B is a perspective view of the inner gear;

FIG. 12C is another perspective view of the inner gear;

FIG. 13A is a perspective view of an inner ring;

FIG. 13B is another perspective view of the inner ring;

FIG. 13C is yet another perspective view of the inner ring;

FIG. 14 is a perspective view of an inner gear with an inner ring;

FIG. 15A is a front perspective view of a second spur gear;

FIG. 15B is a perspective view of the second spur gear;

FIG. 15C is a back view of the second spur gear;

FIG. 16 is a perspective view of an inner gear, an inner ring and a second spur gear;

FIG. 17 is a perspective view of two inner gears, two inner rings and a second spur gear;

FIG. 18 is a perspective view of two inner gears, two inner rings and two second spur gears;

FIG. 19 is a perspective view of two inner gears, two inner rings, two second spur gears, a flange and a second flange;

FIG. 20 is a perspective view of a second vial assembly, including two inner gears, two inner rings, two second spur gears, a flange, a second flange and a vial body;

FIG. 21A is a perspective view of the second vial assembly with a cover disk;

FIG. 21B is another perspective view of the second vial assembly with a cover disk;

FIG. 21C is yet another perspective view of the second vial assembly with a cover disk;

FIG. 22A is a perspective view of a slotted disk in one exemplary embodiment;

FIG. 22B shows three rings to be used with the slotted disk in FIG. 22A in one exemplary embodiment;

FIG. 23 shows an optional optical chamber for a dispensing device 100;

FIG. 24A shows another embodiment of a dispensing device 100;

FIG. 24B shows a reloadable or refillable container or vial for use with the dispensing device 100 in FIG. 24A;

FIG. 25 shows exemplary flowcharts for fulfilling medication for patients;

FIG. 26A shows an exemplary process for loading and using dispensing device;

FIG. 26B shows another exemplary process for loading and using dispensing device; and

FIG. 27 shows an exemplary process for production and package of units of medication.

### DETAILED DESCRIPTION

Embodiments described herein may provide a vial, a dispensing device, and/or a system including the vial and the dispensing device for automated dispensing of one or more dosages of medication to patients, where each dosage is made up of one or more units of medication (e.g. in the form of pills, capsules, tablets, drugs, remedies, tabs, lozenges, etc.).

The system may provide safety, transportability, traceability, security, usability, and/or minimization of human error. The system may automate the medication dispensing process such that a patient does not need to worry about remembering when to take the medication, or how many units of medication to take for each dosage. The system may validate vials loaded into the dispenser prior to dispensing to check if the correct medication contained therein, that there is an authorized link between the patient or user and the medication contained therein, that another vial of the same medication is not already loaded into the dispenser, and so on.

The dispensing device may receive a vial or a plurality of vials in the form of a magazine or stack for the purpose of dispensing the medication contained therein. A magazine may include one vial or multiple vials. A magazine may only refer to a collection of vials, or may include material in addition to the collection of vials (e.g. a cover or housing for receiving vials). A dispensing device may engage the one or more vials to validate the vials (and a user associated therewith) and, after validation, trigger dispensing (via a dispensing mechanism) of a dosage of medication for a user or patient, where the dosage of medication is made up of a number of units of medication released from one or more vials. A vial contains and releases medication (e.g. units of medication) and may also be referred to as a container, vessel, body, chamber, assembly, reservoir, cartridge, cell and so on. A magazine may refer to a stack of vials such that a collection of or a plurality of vials placed together form a magazine. A magazine may refer to two or more three dimensional vials (e.g. disk-type, cube-type, or other geometric shape) are stacked together.

A vial may release units of medication through a slot. In some example embodiments, a vial slot may release one and only one unit of medication. A vial however can contain and release more than one type of medication (e.g. the example implementation of a vial with two faces where each face has slots for releasing one type of medication). Accordingly, each slot may release one unit of medication where a dosage of medication may be made of one or more units of that medication. In addition, as the dispensing device may hold multiple vials of medications, a dosage of medication may be formed by multiple units of multiple types of medications. A dispensing device dispensing a dosage of medication composed of multiple types medications may ensure that medication dispensed in the tray are not reactive and may include separate dispensing compartments, and so on.

As an illustrative example, dispenser or dispending device may hold multiple vials (e.g. 6 to 8 as a non-limiting example). Each vial can contain and release one or more types of medication that make up units of medication. A vial can carry more than one type of medication without compromising the dispensers ability to dispense a dosage of medication correctly. An example vial may have two faces where each face has slot for releasing one type of medication, for example, as units of medication (that may include one or more pills of the given type of medication). Accordingly, one or more vials may be loaded into the dispensing device where each vial can carry the same or different types of medications. Each vial may have the same or different units of medication. For example, vial 1 may have medication type 1 where a unit of medication for vial 1 is two pills of medication type 1. As another example, vial 2 may have medication type 2 where a unit of medication for vial 2 is three pills of medication type 2. As a further example, vial 3 may have medication type 3 where a unit of medication for vial 3 is one pill of medication type 3. As another example, vial 4 may have medication type 1 where a unit of medication for vial 4 is three pills of medication type 1. A dispensing machine loaded with vial 1, vial 2, vial 3 and vial 4 may be configured to dispense different dosages of medication made up of different numbers and combinations of units of medications from the various vials (e.g. vial 1, vial 2, vial 3 and vial 4). Further, the vials may be replaced with different vials containing different types of medication and/or different units of medication to provide further options for different dosages of medication. In addition, additional vials (e.g. in addition to vial 1, vial 2, vial 3 and vial 4) may be loaded in dispensing device containing different types of medication and/or different units of medication to provide even further options for different dosages of medication. The dispensing device may receive input data configuring specific dosages of medications. The dispensing device may dispense the same dosage of medication each time (e.g. one unit of medication from vial 1, two units of medication from vial 2, two unit of medication from vial 3, one unit of medication from vial 4) or may dispense different dosages of medication at different times, such as a morning dosage (e.g. one unit of medication from vial 1, two unit of medication from vial 3) and an evening dosage (e.g. two units of medication from vial 2, two unit of medication from vial 3, one unit of medication from vial 4). This provides a flexible automatic dosage dispensing configuration. In some instance, the dispensing device may detect the types of medication and/or units of medication in a vial when it is loaded and may reject a vial with the same type of medication and/or same unit of medication that is already in another vial loaded into the dispenser, or provide an alert or notification indicating the overlapping type of medication and/or unit of medication.

The dispensing device may be configured to alert the patients (or the patients' caretaker or friends) prior to when a dosage of medication (made up of one or more units of medication from one or more vials) is to be taken per a predetermined schedule or prescription, or a schedule that may be dynamically updated by input data configurations. Accordingly, both the specific dosage and the timing of the dosage may be predetermined or may dynamically update via received input data configurations. The dispensing device may be further configured to dispense the dosage of medication upon an actuation by a patient or based on a predetermined schedule. The dispensing device may be also configured to scan or read information (e.g. input data) from the vial or the magazine (in examples where the magazine is made of material in addition to the collection of vials) upon the vial(s) or magazine being inserted or loaded therein. The information may contain data relating to patient ID, medication ingredients, prescription, dosage information, medication schedule, potential allergies and so on. The information may also contain links or URIs for downloading of further information if required. The dispensing device may be connected to a network to receive input data and provide output data. The dispensing device may be further connected to remote servers in pharmacies, health care providers, insurance companies and so on for providing additional services to the health care community and other stakeholders. For insurance, a remote insurance server may be given adherence data in real-time or non-real-time to calculate premiums and this may be followed up with a separate application with scoring algorithm for adherence in some examples.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product in some example embodiments. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

In some aspects, the embodiments described herein may be implemented using physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

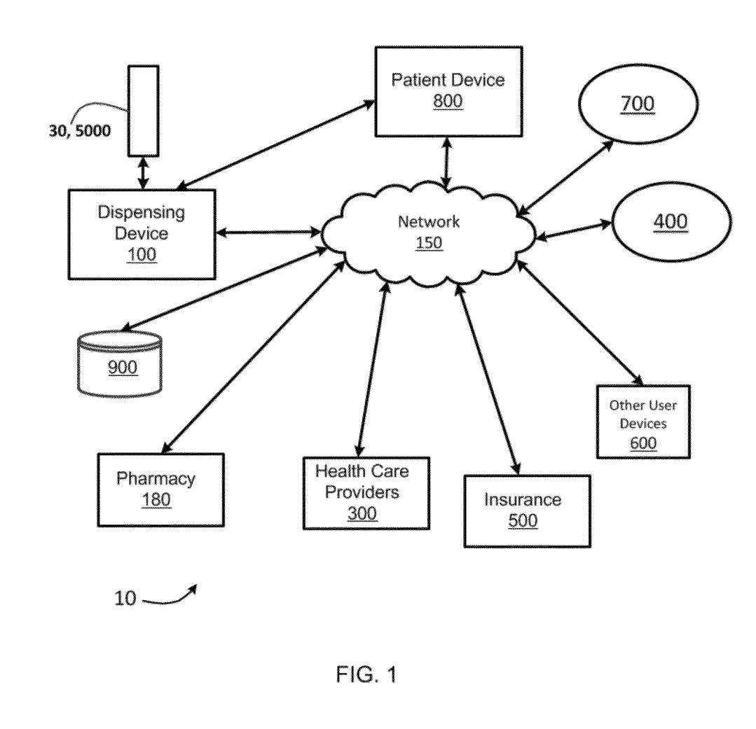

FIG. 1 shows a schematic diagram of an example architecture for a medication dispensing system 10, which may include one or more vials 30, one or more magazines 5000, a dispensing device 100, patient devices 800, pharmacies 180, health care providers 300, insurance companies 500, other user devices 600, for example, remote computers or those belonging to patient's caregivers or friends. The system 10 may further include data recipients 400 (e.g. government agencies or electronic health data network) and mobile ad network 700. Components of said system 10 may be connected over a network 150. There may also be a central server monitoring all components via network 150 to collect and store dispensing data (e.g. adherence data) relating to different dispensing devices. The central server may be implemented as part of one or more of patient devices 800, pharmacies 180, health care providers 300, insurance companies 500, other user devices 600, and may be referred to as an ExactMed server. The central server may provide a central collection of dispensing, medication and patient data relating to devices 100 connected to network 150.

Dispensing device 100 may be associated with a unique code. This may help with uniquely identifying the dispensing device 100 to various entities (e.g. patient device 800 or pharmacies 180) connected over network 150. A unique code may be generated by a manufacturer of the dispensing device 100 or by a pharmacy 180. The unique code may link the dispensing device 100 with a user or patient (e.g. recipient of the dosages of medication). For example, the unique code may be associated with a patient name, medical card, OHIP code, and/or a medical insurance number and stored in local memory associated with a dispensing device 100 and/or local memory associated with a remote computer, for example, a computer at a pharmacy 180.

A dispensing device 100 may store electronic data, for example, in local memory. The electronic data may relate to information read from vials, adherence or compliance data, validation data, and so on.

In one embodiment, a dispensing device 100 may transfer to or receive data from a remote server or device, for example, a server at a pharmacy 180; a vial 30; a magazine 5000 of vials 30 (if, for example, the magazine 5000 is made of material in addition to the vials 30); or a compliance pack over a network 150. For example, a dispensing device 100 may be connected to a network 150 (e.g. the Internet) and/or a cloud based application that may, for example, allow access to a user portal, where, for example, a user may view and/or modify data relating to patient prescription history and adherence record. The dispensing device 100 may validate vials 30 using local components or may implement one or more data exchange operations via network 150 to validate the vials 30. A dispensing device 100 may be configured to connect to a remote computer; to a network, for example, a mobile data network; and/or to a personal computing device, using, for example, the Internet, Wi-Fi technology, Bluetooth technology, radio technology, or other wireless technology. In one embodiment, a dispensing device 100 may store data, for example, in local memory such as an NRC circuit or other chip, or contain data in a QR code, a bar code, and so on.

In one embodiment a dispensing device 100 may receive, store, and/or transmit data representing a variety of information, such as time(s) that dispensing device 100 released one or more dosages of medication, time(s) that a patient may have retrieved one or more dosages of medication from the dispensing device 100 (as detected by sensors in a tray, for example), whether a patient retrieved one or more dosages of medication from the dispensing device 100, the number of dosages of medication or units of medication released from the dispensing device 100, the type or types of medication dispensed and/or retrieved, one or more identification codes, for example, uniquely identifying a dispensing device 100, vial 30, magazine 5000, and/or pharmacy 180; and whether a new prescription is required based on current amount of medication stored in the vial 30 or magazine 5000.

Various embodiments and examples of dispensing device 100 are described herein.

Patients may be associated with various devices 800, such as mobile phones, smart phones, computing devices (e.g., a laptop), tablets, smart watches, etc. Patients may operate these devices 800 to interact with dispensing device 100 if needed, for example, to request detailed medication or prescription information.

In one embodiment, patient device 100 is operable to register and authenticate users (using a login, unique identifier, and password for example) prior to providing access to digital data, a local network, network resources, other networks and network security devices.

Upon receiving an indication or command from dispensing device 100 or another remote server such as a server at pharmacy 180, the patient device 800 is operable to issue an alert to the patient, prompting the patient to take a dosage of medication dispensed by the dispensing device 100. The patient may then push a button or otherwise actuate the dispensing device 100 to release the appropriate medication dosage. In another embodiment, the dispensing device 100 may automatically dispense the medication after a predetermined period from issuing the alert to patient device 800. For example, the dispensing device 100 may wait for 5 minutes from the alert before automatically dispensing a medication dosage in an exit chamber or pick-up tray for the patient.

In one embodiment, system 10 may be configured to issue alerts or notification for one or more of the following example events:

a. time for a dosage of medication;

b. time for refill of one or more vials (e.g. when one or more vial is empty or near empty);

c. expiry of medication in one or more vials or a validation period for the medication;

d. recalls of medication in one or more vials; and

e. regimen changes for specific dosages of medication or timing of dosages of medication.

In another embodiment, the dispensing device 100 and other connected devices 600, 800 may be able to issue or receive audio/visual alerts.

Patient device 800 may connect to the dispensing device 100 via network 150. Concurrently or alternatively, patient device 800 may be connected to dispensing device 100 via USB, Wi-Fi, Bluetooth, radio, or infrared (IR) technology.

For simplicity only one patient computing device 800 is shown but system may include more computing devices operable by users to access remote network resources 100, 900 and exchange data. The computing devices 800 may be the same or different types of devices. The computing device may have at least one processor, a data storage device (including volatile memory or non-volatile memory or other data storage elements or a combination thereof), and at least one communication interface. The computing device components may be connected in various ways including directly coupled, indirectly coupled via a network, and distributed over a wide geographic area and connected via a network (which may be referred to as “cloud computing”).

For example, and without limitation, the computing device may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

Computing devices 100, 600, 800 may be operable to register and authenticate patients or users (using a login, unique identifier, and password for example) prior to providing access to applications, a local network, network resources, other networks and network security devices. Computing devices 100, 600, 800 may serve one user or multiple users. Computing device may also be authenticated using its serial number to perform binding or association with user or patient.

A data store 900 may be connected to the network 150. Data store 900 may be comprised of non-transitory computer-readable media storing various elements of information, such as patient profiles, medication information, medication constraints, heuristic information, prescriptions and renewal requests, historical data, analytic data, event data, sensory data, dosage data, etc. The information may be stored in various formats, such as flat files, database records, spreadsheets, etc. Data store 900 may be a relational database. The data store 900 may have a persistent record of users, prescriptions, devices, transactions taking place, processed data stored in compliance with privacy regulation and legislation.

Network 150 may be any network capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Health care providers 300 may include doctors, nurses, physicians, pharmacists, employees, and other individuals who are involved with caring for the patient.

Other user devices 600 may include patients' friends and family members who are authorized to access or read information from dispensing device 100. For example, an alert may be sent to the other user devices 600 at the same time it is sent to the patient device 800, such that the patient's friends or family may be made aware of the patient's medication schedule. The dispensing device 100 may be further configured to send a confirmation to the other user devices 600 once the dosage of medication has been picked up from the dispensing device 100, such that the patient's friends or family may know that the medication has likely been taken by the patient. Such real-time or near real-time information may be helpful to better monitor a patient's adherence to a medication schedule. The same information may be further processed (e.g. stripped of identification as required by law) before being transmitted to pharmacy 180, health care providers 300, insurance companies 500, other data recipients 400 and mobile ad network 700 over network 150. The system may connect friend and family (via user devices 600) and devices operated by health care providers 300 from a dispensing device 100 via a network 150 to provide real time data exchange between stakeholders in the medication process.

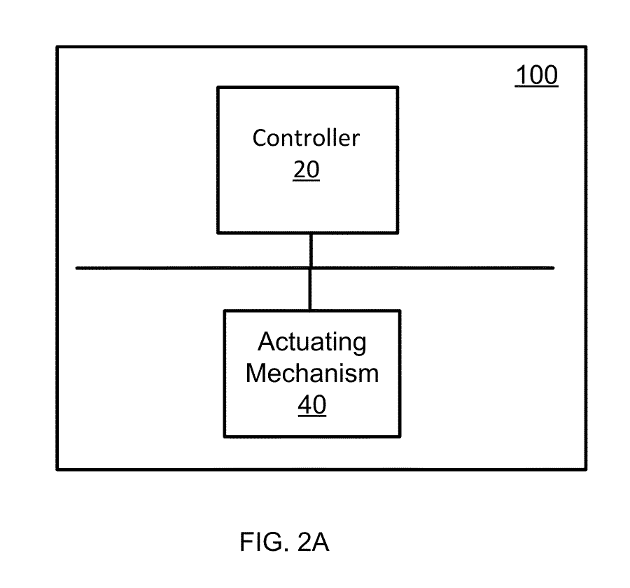

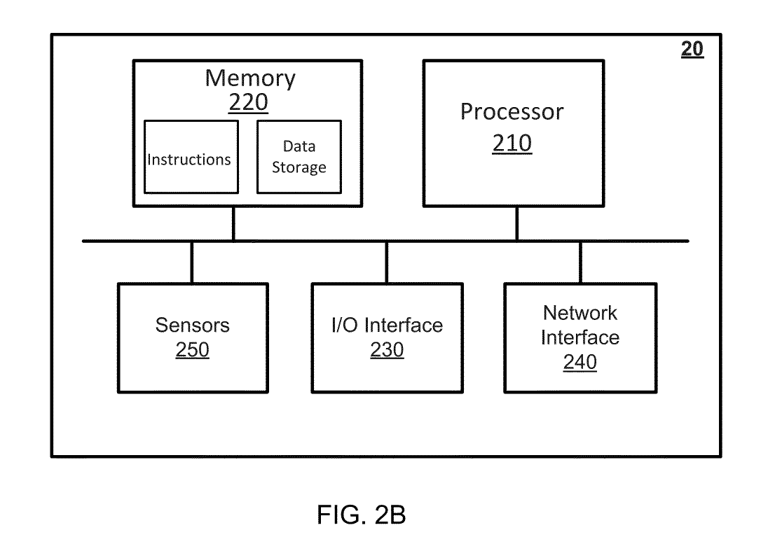

FIG. 2A shows a schematic diagram of a dispensing device 100 of FIG. 1, which may include one or more controllers 20 and one or more actuating mechanisms 40. In addition, FIG. 2B shows a schematic diagram of a computing device that may be used to implement the controller 22 of FIG. 2A.

Controller 20 may be configured to control actuating mechanism 40 based on inputs received from patient or from patient device 800, or other device. For example, the patient may push a button or a knob on the dispensing device 100 to dispense a medication, the pushed button or knob may send an electronic signal to activate the controller 20, which in turn controls the actuating mechanism 40 to dispense the appropriate medication from one or more vials 30 or one or more magazines 5000 (e.g. collection of vials 30) inserted within the dispensing device 100. The controller 20 may be also configured to control the actuating mechanism 40 at a predetermined schedule to automatically dispense the medication at appropriate times, or in response to an external trigger received as input data.

Turning now to FIG. 2B, controller 20 may include one or more processors 210, local memory 220, I/O interfaces 230, network interfaces 240, and/or sensors 250. Dispensing device 100 may be an Internet of Things device, or a “thing” embedded with electronics, software, sensors, and connectivity to enable objects to exchange data with different devices and components (e.g. doctor, pharmacy, heath care providers).

Each processor 210 may be, for example, any type of general-purpose microprocessor or microcontroller, a digital signal processing (DSP) processor, an integrated circuit, a field programmable gate array (FPGA), a reconfigurable processor, or any combination thereof. The processor 210 may also be system on a chip (SOC), for example, given that device 100 may be an Internet of Things device.

Local memory 220 may include a first storage portion that stores program instructions and a second storage portion that stores other types of data. Local memory 220 may be directly accessible to the processor 210 by means of a memory bus (not shown).

In one embodiment, local memory 220 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 230 enables device 100 to interconnect with one or more input devices, such as a keyboard, mouse, camera, touch screen and a microphone, or with one or more output devices such as a display screen and a speaker.

Each network interface 240 enables device 10 to communicate with other components, to exchange data with other components, to access and connect to network resources, to serve applications, and perform other computing applications by connecting to a network (or multiple networks) capable of carrying data, e.g., one more networks 150.

One or more sensors 250 that may sense, detect, receive, and/or transmit sensor data relating to one or more types of medication or an association with, for example, storage in, one or more compartments associated with a dispensing device 100. The sensors 250 may include one or more sensors configured to sense signals based on optical, LED, infrared, pressure, and/or other technologies. The sensors 250 may be internal to dispensing device 100 or may be external to dispensing device 100 and connected thereto to provide sensor data to dispensing device 100.

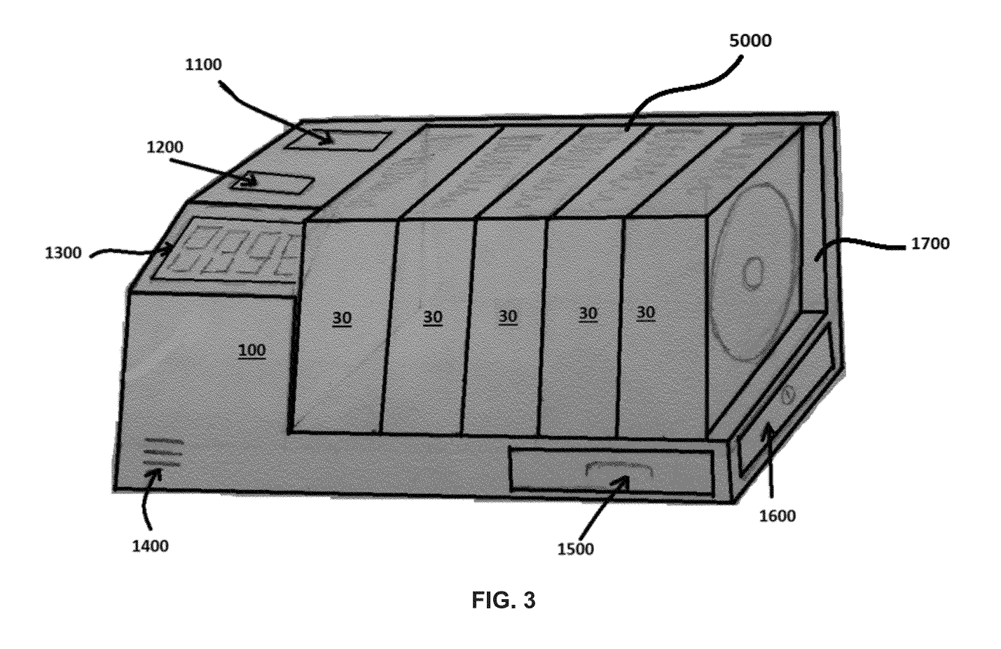

FIG. 3 is a perspective view of a dispensing device 100 with a magazine 5000 of vials 30 loaded therein, exemplary of an embodiment. As shown, the dispensing device 100 may include a status indicator 1100, a dispense button 1200, a display 1300 for displaying current time or other suitable information, speaker(s) 1400 (or other output), a pick-up tray 1500 where patient may pick up dispensed dosages of medication, a reject tray 1600, and a loading area 1700.

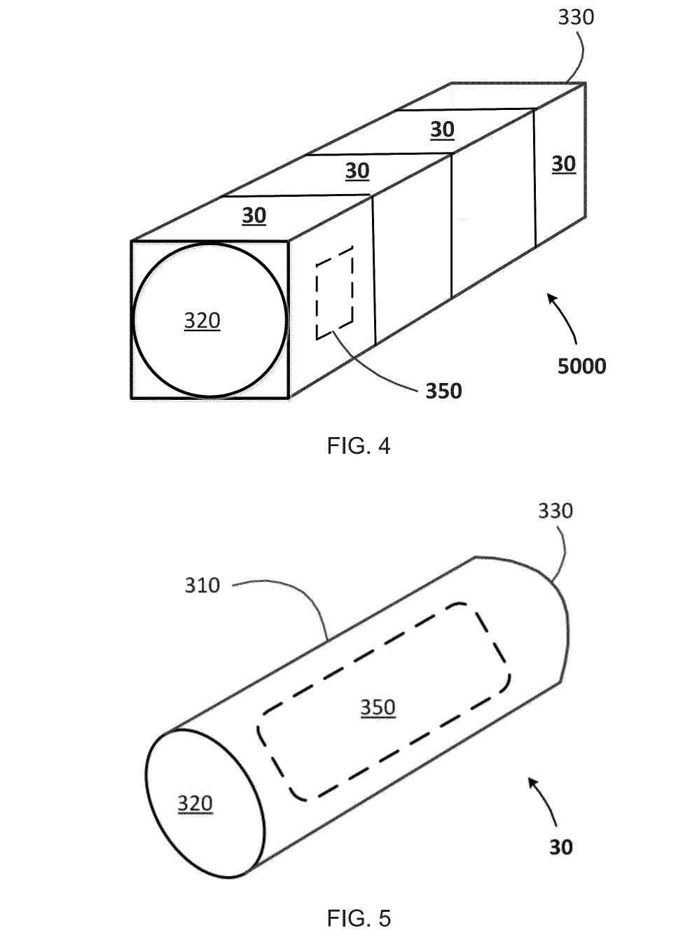

FIG. 4 is a perspective view of a magazine 5000 of FIG. 3, comprised of a plurality of vials 30, exemplary of an embodiment. A magazine 5000 (shown as a longitudinal view) is collection of vials 30 and, in some examples may contain material or components in addition to the collection of vials 3). Accordingly, the magazine 5000 may represent the collection of vials 30 or may be a separate device or material that may receive the collection of vials 30.

Each vial 30 in this example embodiment may be a cuboid, a rectangular prism, cube or other three dimensional shape. A vial 30 is configured for storing and dispensing medication. A vial 30 has a housing with a medication information label area 350 readable by the dispensing device 100 to validate the vial 30. The medication information label area 350 may be readable by a dispensing device 100 to validate the associated user to confirm that they are permitted to receive dosages of medication. The dispensing device 100 may refuse to allow loading of the vial 30 (e.g. reject a loaded vial 30) or dispensing of medication by the vial 30 if the dispensing device 100 cannot validate the vial 30 or the user by way of the medication information label area 350. The medication information label area 350 may also include dosage data readable by a dispensing device 100 to determine dosages of medications (e.g. specific units of medications and quantity of units of medication) and frequency of dosages (e.g. a dosage is two units of medication, three times a day). The medication information label area 350 may include computer readable medium storage validation and dosage data. The medication information label area 350 may include a bar code, chip. QR code, NFC circuit or other readable medium.

The vial 30 is used for the purpose of automated dispensing that is secured, safe, traceable such that the medication within the vial is not accessible to the user except when its dispensed by the dispensing device based on the schedule and after validation.

The vial 30 has a first opening at a first end of the housing to release a dosage of medication. The vial 30 has a container storing a plurality of units of medication, each unit of medication containing the same amount of medication. A dosage of medication is a multiple of units of medication (e.g. a quantity of units of medication). For example, a dosage may be five units of medication, one unit of medication, and so on. A dosage of medication may be made up of different units of medication from different vials. For example, a dosage may be one unit of medication from vial 1 and two units of medication from vial 2. A dosage of medication may be made up of different types of medication and different types of units of medication from one or more vials 30. A vial 30 may contain and release more than one type of medication and more than one type of unit of medication (e.g. one unit of medication may be two pills of medication Y and another unit of medication may be one pill of medication A). Multiple vials 30 may contain and release multiple types of medication and multiple types of units of medication.

In an example embodiment, the container has a plurality of slots, where each slot is configured to release a single unit of medication of the plurality of units of medication at a time through the first opening when the respective slot is aligned with the first opening. This is an example dispensing configuration and other techniques may be used to release units of medication from slots. The first opening is configured to engage with the dispensing device 100 (e.g. an actuating mechanism 40) to trigger dispensing of a dosage of medication made up of a number of units of medication (e.g. a dosage is a multiple of the units of medication). The dispensing by the vial 10 of the dosage of medication is from a number of slots that correspond to the number of units of medication (required for the specific dosage), as each slot releases a unit of medication. A unit of medication may be one or more pills or tablets of medication for example. Each different dosage of medication may be made up of a different number of units of medication. A dosage of medication may be made up of different units of medication from one or more vials 30, and different types of medication, for example. For example, a morning dosage may be made up of two units of medication and an evening dosage may be made up of three units of medication. As another example, a morning dosage may be made up of two units of medication A and one unit of medication B, and an evening dosage may be made up of one unit of medication A and three units of medication B. Accordingly, a vial 30 provides a flexible, dynamic automated dispensing mechanism for different dosages of medication built up from units of medication (or different units of medication).

Each slot of a vial 30 may have one and only one unit of medication. A vial 30 may have more than one type of medication. A vial 30 may release different types of units of medication. An example implementation may be a vial 30 with two faces (e.g. containers) where one face has slots for releasing units of one type of medication and another face has slots for releasing units of another type of medication. As another example implementation may be a vial 30 with two faces (e.g. containers) where one face has slots for releasing one type of unit of medication and another face has slots for releasing another type of unit of the same or different medication. For example, one type of unit of medication may be three pills and another type of unit of medication may be two pills. Accordingly, a unit of medication may be of one or more items of medication (e.g. pills, capsules, tablets).

Referring back to FIGS. 3 and 4, a magazine 500 may comprise one or more vials 30. Each vial 30 may contain multiple units of medication where a dosage may be made up of a multiple, a quantity or a number of one or more types of units of medication. A unit of medication may be one or more pills, for example. A type of unit of medication may be defined by a quantity of medication (e.g. unit of measurement, number of items) and a type of medication, for example. A vial 30 may have a container of slots, where each slot may release a unit of medication when aligned with an opening. A dosage of medication may be made up of one or more units of medication and one or more slots of the same number of units for the dosage may dispense the dosage. The one or more slots may be from one or more vials 30. For example, if three units of medication are required for the dosage then three slots of one vial 30 may be dispense three units of medication to make up the dosage. Each vial 30 may contain a single type of medication, for example, the same type of pills. Alternatively, the one or more vials 30 in a magazine 500 may contain the same or different types of medication. A unit of medication may contain one or more types of medication for example.

Each slot of a vial 30 releases one unit of medication where a dosage could be made of one or more units of that medication, or another medication. For example, dispensing device 100 may have multiple vials 30 of medications, where one vial 30 may have one type of medication and another vial has another type of medication. A dosage of medication may be formed from one or more units of one type of medication from one vial 30 and one or more units of another type of medication from another vial 30. Accordingly, a dispensing device 100 may dispense a dosage of medication composed of multiple types of medication. The types of medication may be validated by dispensing device 100 to ensure that the different types of medications dispensed in the tray of the dispensing device 100 are not reactive. In such case they may dispensed in separated trays or compartments, for example.

The magazine 5000 may have a first end 320, a second end 330 opposite the first end 320, and an information label area 350. The first end 320 and second end 330 may each has a cover 3000. Embodiments of the vials or assembled vials 30 are described in detail below. The information label area 350 may contain, for example, an NRC circuit, QR code, a barcode, or any other suitable technology to store electronic data that may be read upon proximity or contact with one or more sensors 250 of dispensing device 100.

The magazine 5000 may be loaded or inserted into the dispensing device 100 into the loading area 1700. Status indicator 1100 may indicate whether the dispensing device is on (e.g. green light), off (no light), or in error mode (red light). A dispense button 1200 may be used by patient or patient's caretaker to dispense medication. A display 1300 may display current time or other suitable information (e.g. “REFILL REQUIRED”). Speakers 1400 may output audio alert at appropriate times to remind patient for taking medication, or to alert patient that one or more vials need to be replaced, or to indicate that there is a change in the medicine regime as detected by controller 22. A pick-up tray 1500 is where patient may pick up dispensed medication dosage, the pick-up tray 1500 may be optionally connected to an exit chamber into which the dosage of medication may be dropped upon dispensing. A reject tray 1600 may be operable to hold medication that have been rejected by controller 22 for a number of reasons, such as medication that has been dispensed in error, or recalled medicine.

In one embodiment, the dispensing device 100 dispenses medication units individually and collects them in a pick-up tray 1500 or exit chamber to form a prescription.

The dispensing device 100 maintains the details of the prescription and the time of the prescription and dispenses pill in the correct quantity at the correct time. It then logs the medicine pick-up time in a local memory or a remote data store 900.

The dispensing device 100 can accommodate a number of different pill types supplied by the pharmacy in vials. The dispensing device 100 can ensure that the correct vial is inserted and that the vial has not been tampered with.

Following is a list of possible functions of the dispensing device 100:

Validate that the correct Vial is inserted in the pill dispenser;

Check for tampering of the vial;

Validate the contents of the Vial against the prescription;

Validate the number of pills in the vial against label printed on the vial;

Store and maintain the prescription and accept updates from the physician;

Send out alerts at the prescription time;

Dispenser one pill at a time as per the prescription in an error proof manner when instructed by the client;

Make a dosage on the fly and present it to the client;

Withdraw dosage in case it is not picked within a predetermined time;

Store withdrawn pills in a secure and lockable container;

Connects to the internet over Wi-Fi;

Connects to smart devices over Blue Tooth;

Connect to mobile data networks;

Connect to the backend and updates dosage pick-up information;

Has a back-up power supply; and

Send out alerts in case of loss of mains power and low back-up power.

FIG. 5 is a perspective view of a vial 30, exemplary of another embodiment, which may comprise a housing 310, with a first end 320, a second end 330 opposite the first end 320, and includes an information label area 350.

Each vial 30 or magazine 5000 may be uniquely identified. A vial 30 or magazine 5000 may store data in information label area 350, which may contain data stored in a format such as a QR code, a bar code, an NRC circuit, mechanical encoding, magnetic encoding, optical encoding, electrical encoding, or chemical encoding. In another embodiment, a vial 30 or magazine 5000 may store data in local memory associated with, for example, installed in, the vial 30 or magazine 5000. In another embodiment, a vial 30 or magazine 5000 may store data in both plain text and in machine readable format. This may assist with medication dispensing in accordance with a patient's prescription and help transmit correct prescription data to the dispensing device 100. The data stored may include data relating to the type or types of medication in the vial 30 or magazine and the patient for whom the dosages of medication are associated or prescribed. In one embodiment, the data may correspond to: a prescription code, patient, medication code, quantity, repeats, expiry, one or more tamper evident foil measurements; one or more prescription schedules; current time; one or more types of medication currently loaded within the vial 30 or magazine 5000 may contain; patients, for example, relating to identification of a patient for whom the medication are associated or prescribed; one or more identification codes associated with a dispensing device 100, vial 30, magazine 5000, or pharmacy 180; and medication or prescription information. The information label area 350 may be configured to enable for data, such as one or more prescription schedules, to be verified against records on the vial 30 or magazine 5000. In one embodiment, it may facilitate a dispensing device 100 to verify that the vial 30 or magazine 5000 corresponds to the correct patient and medication, so as to help with traceability and security of the medication from the vial 30 or magazine to the dispensing device 100. For example, based on the data embedded within the information label area 350, the controller 20 on the dispensing device 100 may be configured to determine a proper owner, user, or patient identification associated with the vial 30 and compare the determined patient identification against that stored on the dispensing device 100. If the patient identification from informal label area 350 does not correctly match with that on dispensing device 100, the controller 20 may be configured to reject the vial 30 and display an error code or message accordingly. This may include the scenario when the data on information area label 350 is corrupt or otherwise incapable of being successfully read by the controller 20. In another example, the information label area 30 may simply contain a link or URI pointing to data stored at a remote location (e.g. data store 900), and the controller 20 may be configured to fetch the appropriate data (e.g. based on a pre-determined schema) at the link or URI, and then verify said data accordingly. In some embodiment, the patient identification may take the form of, or be associated with, a government ID (e.g. provincial or federal health card number) or a private insurance ID.

In one embodiment, a pharmacy 180 may replace or update data stored by the vial 30 or magazine 5000. For example, a pharmacy 180 may replace or update the data stored in an information label area 350 to reflect a change in data, such as the type of medication contained in the vial 30 or magazine 5000, the medication prescribed or the prescription schedule. For example, the updated data may also be reflected in a record at the pharmacy 180, or data store 900, for the particular patient. This may improve efficiency or provide financial savings, for example, to the pharmacy 180, as the vial 30 may not need to be replaced each time a prescription is refilled or changed.

A vial 30 may contain one type of medication or pill. A magazine 5000 may contain one or more types of medication. A magazine 5000 may contain one or more vials 30. In one embodiment, after a vial 30 or magazine 5000 is sealed, for example, heat sealed, for example, at one or both or all openings, the contents of a vial 30 or magazine 5000 are only accessible after actuation by a dispensing device 100. For example, a vial 30 or magazine 5000 may be made of material that is hard to breach or that may provide at least the same durability as conventional pill bottles, for example, medical grade plastic; may be wrapped in whole or in part with tamper evident foil; may transfer data, for example, to a remote computer, relating to damage; and may be sealed, for example, heat sealed after filled with units of medication. This may improve the safety for patients who may otherwise overdose, lose their medication, or take medication at times other than as prescribed. In one embodiment, a vial 30 or magazine 5000 may only be filled with one or more units of medication by a pharmacy 180 or system 10 with access to unsealed vials 30 and/or magazines 5000. In one embodiment, a dispensing device 100 may be associated with only one patient. This may also improve the safety for patients who may otherwise overdose and/or improve the medication adherence, as patients may not be able to use another patient's dispensing device 100 to obtain access to their medication contrary to their prescription schedules. The prescription schedule may be associated with the vial 30 and patient (e.g. a prescription links a user and medication, including dosages of medication). There may be safety issues if two people share the same dispensing device as one person may dispense and take another person's dosage of medication (e.g. husband and wife may dispense off a single device without wife knowing she is taking husband's dosage of medication). The dispensing device 100 may be configured to implement precautionary operations such as a user name alert or password requirement to flag the user or patient associated with the dispensed dosage. Alternatively, only one patient may be linked to one dispensing device 100 to avoid such errors, including rejecting vial insertion altogether if the vial is associated with a different patient.

For example, a controller 20 in a dispensing device 100, remote computer, vial 30, and/or magazine 5000 may store, generate, or transfer data relating to an association between data relating to the identification of a patient and data relating to unique identification of the dispensing device 100. In one embodiment, a dispensing device 100, remote computer, vial 30, and/or magazine 5000 may transfer said data to a remote computer, for example, a computer at a pharmacy 180. In one embodiment, the data relating to patient identification and/or the data relating to identification of the dispensing device 100 may be unique. The vial 30 may be disposable.

In one embodiment, the vial 30 may be reloadable and refilled with one or more units of medication.

In other embodiments, conventional medication bottles or containers may be retrofitted to hold units of medication and those containers each may be used as a vial 30 with a dispensing device 100.

A vial 30 may be made of suitable material, such as moulded plastic, and may be associated with one or more components that may facilitate the pulling of a strip of units of medication or the winding of a strip of units of medication. The material may be, for example, ultrasonic wieldable or inkjet printable.

In one embodiment, a vial 30 may have two ends, 320 and 330, each of which includes an opening that may be covered with a covering 3000. The first end 320 may be configured to receive one or more units of medication from a pharmacy 180. The same end 320 may be inserted into a dispensing machine 100. In another embodiment, the first end 320 may be configured to receive a unit of medication from a pharmacy 180 and the second end 330 may be opposite the first end and may be configured to be inserted into the dispensing device 100. In one embodiment, one end may be inserted into a dispensing device 100 for automatic dispensing of one or more units of medication by an actuating mechanism 40 within the dispensing device 100. In one embodiment, the first end 320 may have a lid that may be sealed, for example, using ultrasonic wielding, after one or more units of medication are placed in the vial 30. In one embodiment, the end configured to be inserted into the dispensing device 100 may be configured to only allow the release of one or more units of medication when associated with, for example, inserted into, a dispensing device 100 that has been verified to belong to the particular patient or to be used with the vial 30.

The vial 30 may have various shapes and configurations. For example, the vial 30 may be shaped similar to a rectanguloid (e.g. a USB drive shape) where each slot may be opened to release a unit of medication through magnetic force.

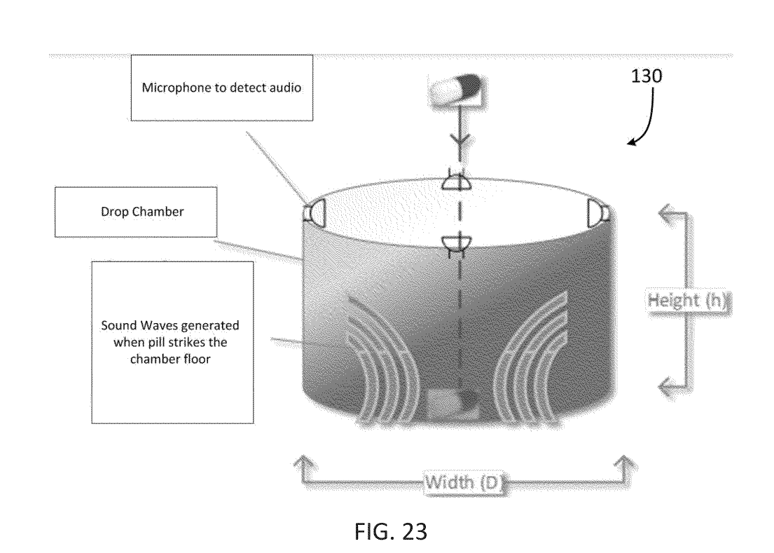

In one embodiment, as shown in FIG. 5, a vial 30 may be comprised of a medication strip vial. A vial 30 may contain a strip of units of medication (e.g. pills), for example, comprising a blister package with multiple slots or cavities or pockets, where each slot or cavity or pocket contains and releases units of medication. As an illustrative example, the strip of units of medication may have a plurality of pre-cut slots on opposing sides of the strip, such that each pill in the array of medication is aligned with a left slot and a right slot. In one embodiment, a strip of units of medication may be one pill wide. The slots may be used by an optional counting mechanism associated with a dispensing device 100 to count the number of units of medication that are being moved through the end 330 of the vial 30 that is inserted into the dispensing device 100. The counting may be carried out by an acoustic or optical chamber component as shown in FIG. 23. In one embodiment, the units of medication that a vial 30 contains may be packaged, for example, in a roll of blister strips. A dispensing device 100 may use a counting mechanism to dispense a number of units of medication corresponding to a number of units of medication for which an actuating mechanism 40 has been actuated to dispense. For example, a controller 20 associated with a dispensing device 100 may receive data relating to the number of units of medication that are being or have been moved through the end 330 of the vial 30 and actuate the stopping of a mechanism that moves the strip of units of medication. A bulk reel packing machine may produce blister strip reels from bulk packaged pills and a strip dispensing machine located, for example, at a pharmacy 180, may produce a blister strip from a blister strip reel.

In one embodiment, a strip of units of medication in a blister package contained in a vial 30 is moved through the end 330. For example, mechanical arrangement may pull the strip of units of medication through the end 330. In one embodiment, said mechanical arrangement may rotate a gear mechanism that engages a plurality of slots on the sides of a strip, and said gear mechanism may be configured to pull a strip through the end 330 of the vial 30. A breaching mechanism such as a cutting mechanism may be actuated by the actuating mechanism 40 to breach the strip of units of medication and a unit of medication contained therein may move, for example, by gravity, into the dispensing device 100 into a holding chamber, an acoustic chamber, or exit chamber or pick-up tray 1500. In one embodiment, a pushing mechanism associated with the dispensing device 100 may push a unit of medication out of the strip of units of medication. In one embodiment, a mechanical arrangement may roll and/or wind the strip of units of medication back into the vial 30. In another embodiment, a mechanical arrangement may push and/or wind the strip of pills back into the vial 30. This may help ensure that only one unit of medication is released from a vial 30 or magazine at one time. In one embodiment, the mechanism by which a strip of units of medication is moved through the end 330 of a vial 30 may be the same mechanism by which a blister strip is rolled back into the vial 30. In one embodiment, a portion of the strip of units of medication that is opposite the portion of the strip of units of medication that remains in the associated vial 30 may move, for example, by gravity, into the pick-up tray 1500 of dispensing device 100.

In one embodiment, a strip of pills that may be contained in a vial 30 may be as side as a single unit of medication.

### Disk Configurations

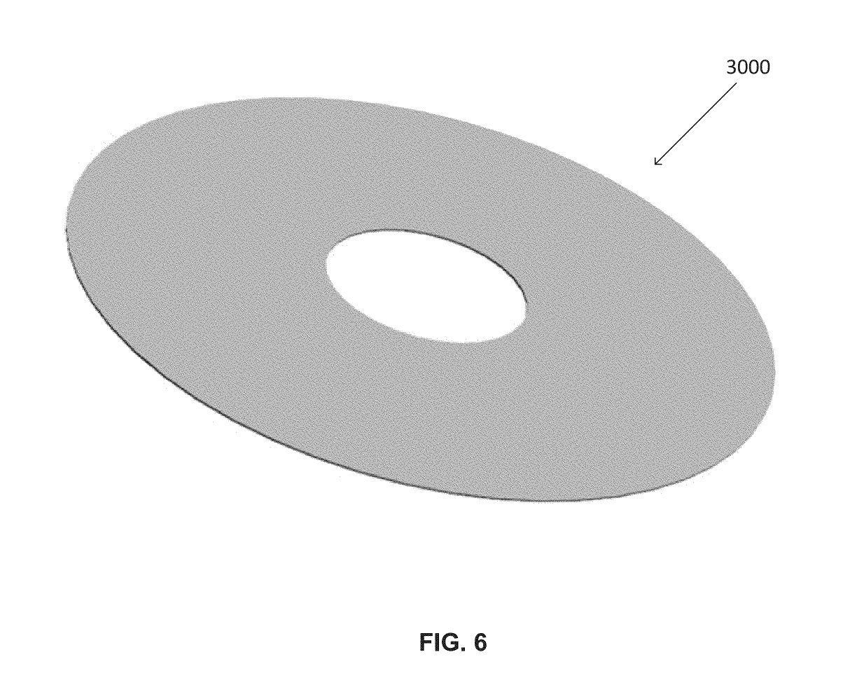

In one embodiment, vial 30 may be of a slotted disk vial design, such as shown in FIGS. 6-21C.

FIG. 6 is a perspective view of a covering disk for a vial 30.

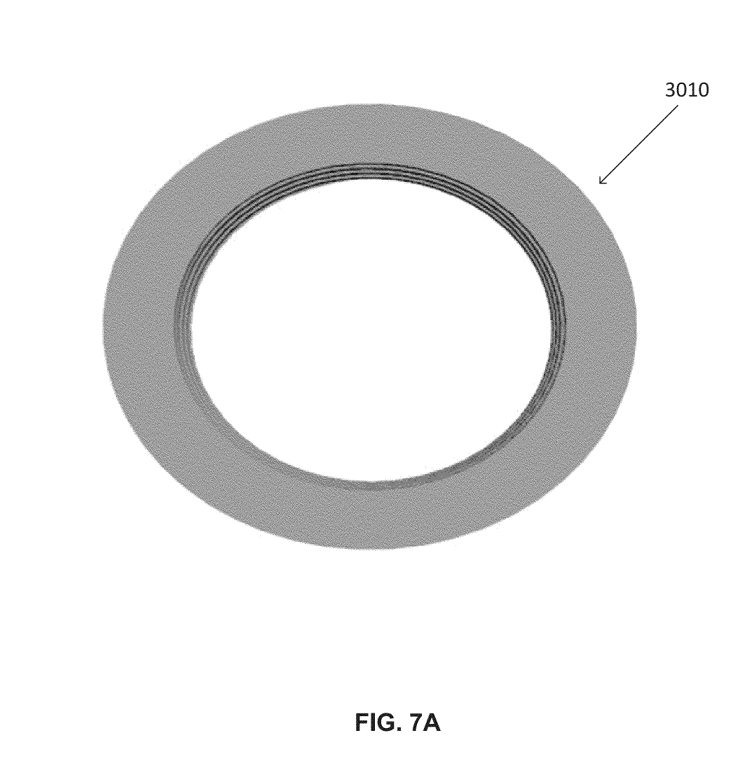

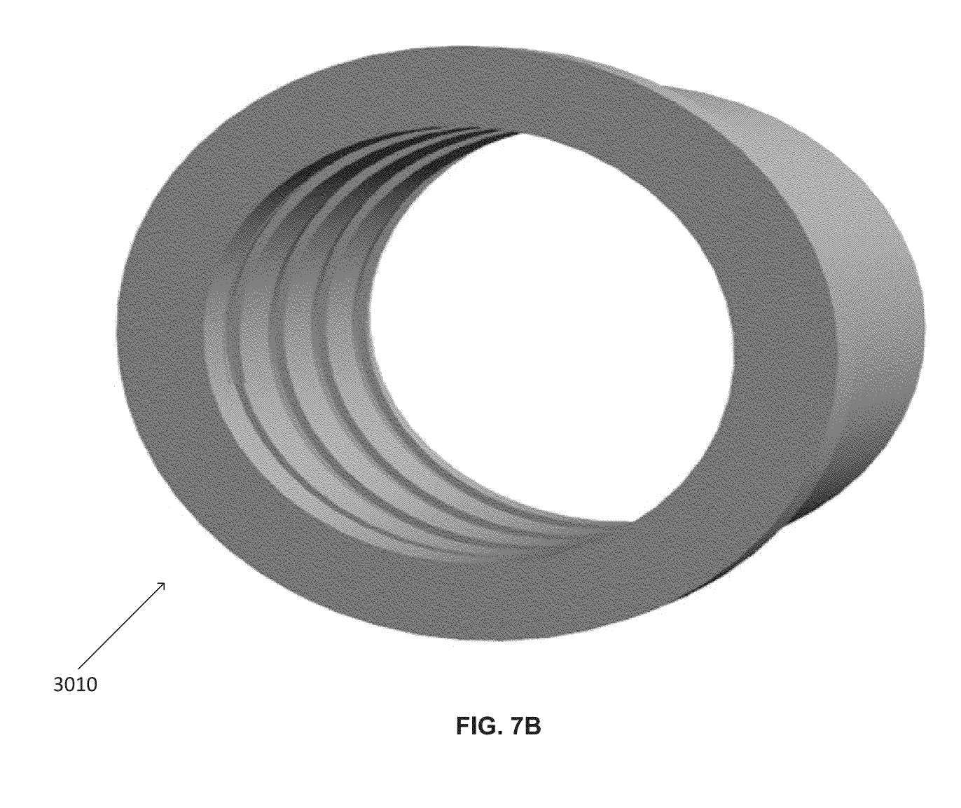

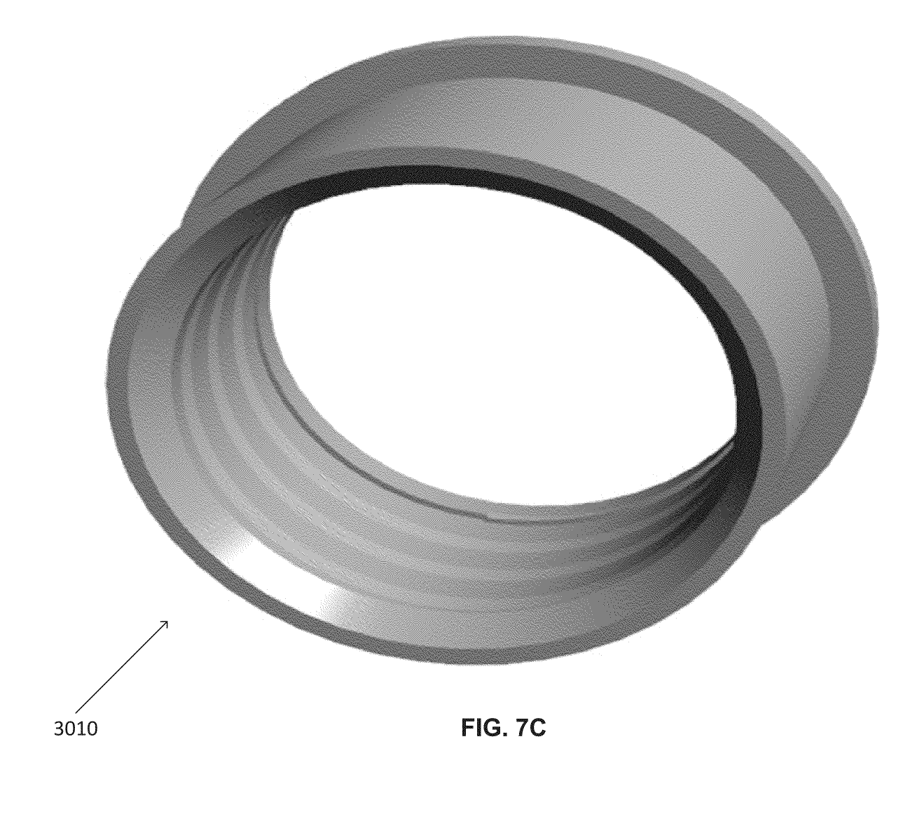

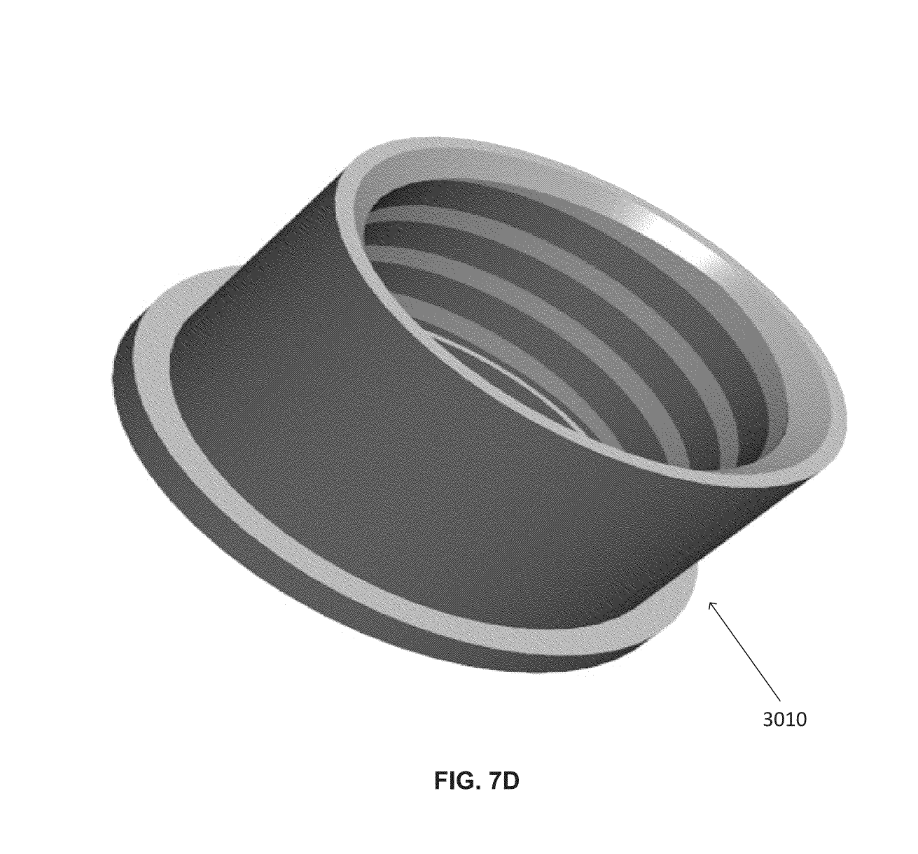

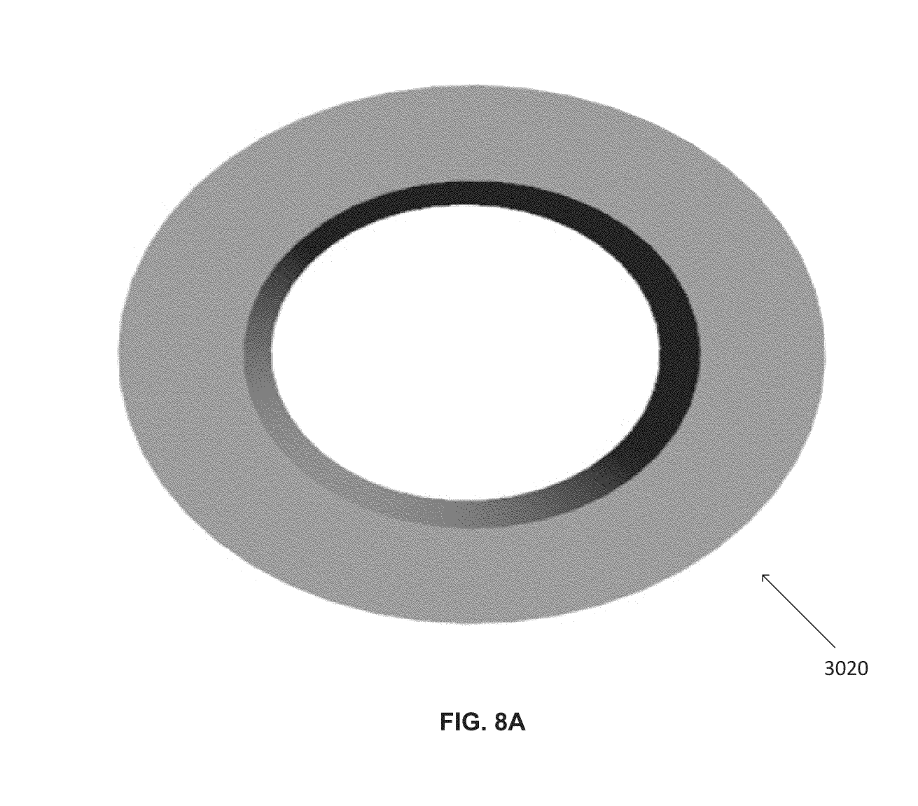

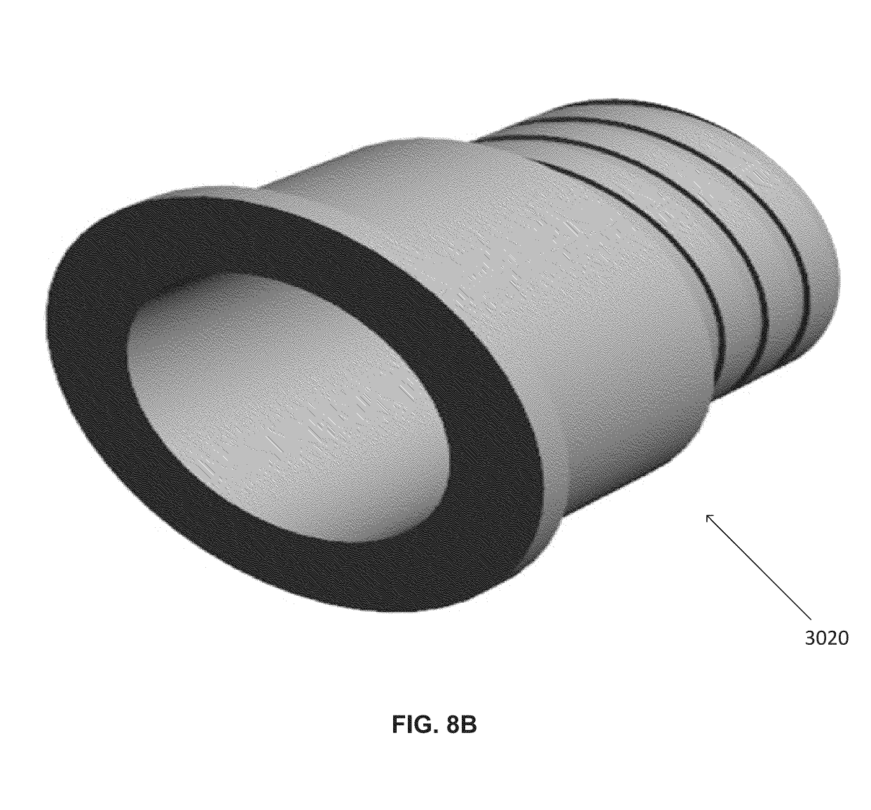

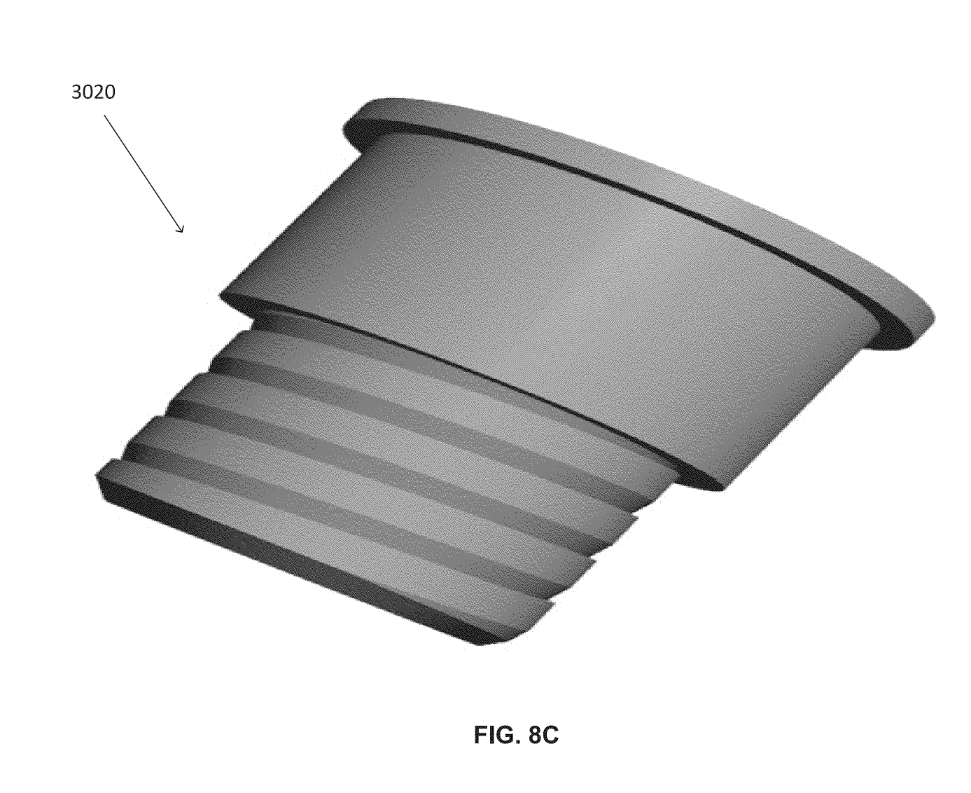

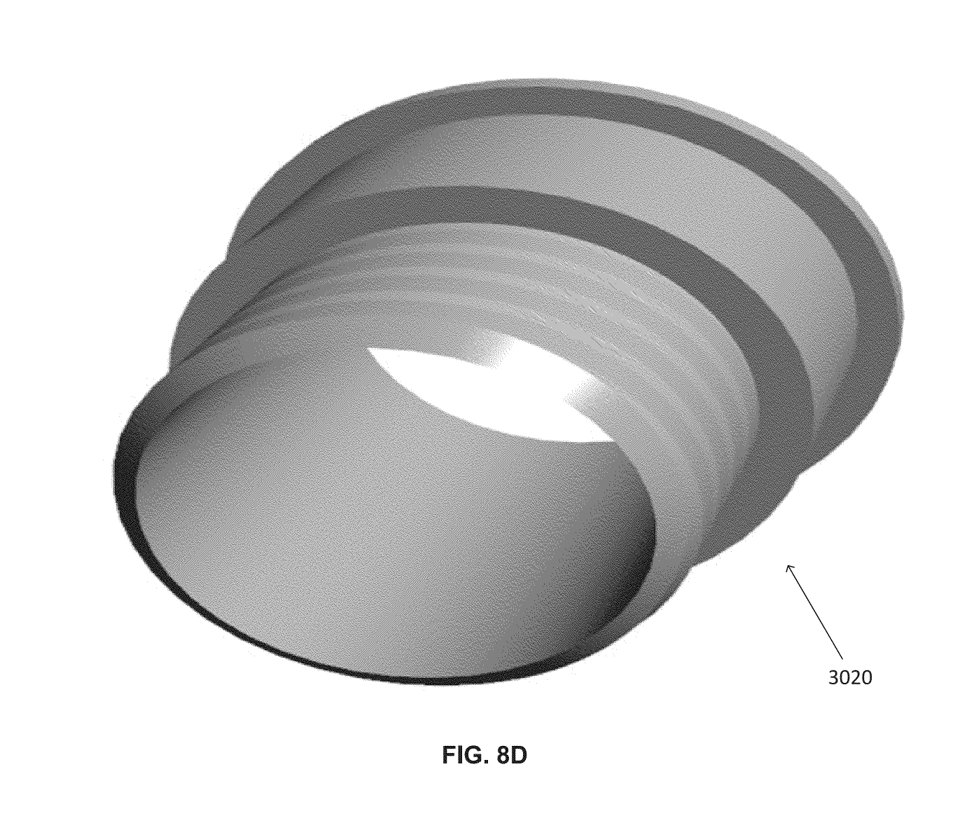

FIG. 7A is a front view of a first flange 3010 for a vial; FIG. 7B is a perspective view of the flange 3010 for a vial; and FIG. 7C is another perspective view of the flange 3010 for a vial; FIG. 8A is a front view of a second flange for a vial; FIG. 8B is a perspective view of the second flange for a vial; FIG. 8C is a side view of the second flange for a vial; and FIG. 8D is yet another perspective view of the second flange for a vial.

Flange 3010 may comprise a hollow cylinder with a lip forming the periphery of one end of said cylinder. Said lip may protrudes in a direction perpendicular to the face of the walls of said cylinder. The inner walls of said cylinder may contain grooves, for example, that enable coupling of flange 3010 with flange 3020. Flange 3020 may include a hollow first cylinder with a lip forming the periphery of one end of said cylinder. Said lip may protrude in a direction perpendicular to the face of the walls of first cylinder. Extending from the inner wall of first cylinder may be a cylindrical protrusion, that is, second cylinder, whose outer wall is adjacent to the periphery of the inner wall of first cylinder and located at the end of the first cylinder that is opposite the lip. The outer wall of second cylinder may contain grooves, for example, that enable coupling of flange 3020 with flange 3010. The circumference of the outer wall of second cylinder of flange 3020 and of the inner wall of the cylinder of flange 3010 may be such that upon coupling, the outer wall of second cylinder of flange 3020 and the inner wall of the cylinder of flange 3010 are adjacent and form a tight fit. Upon said coupling, the outer wall of first cylinder of flange 3020 may be flush with the outer wall of the cylinder of flange 3010.

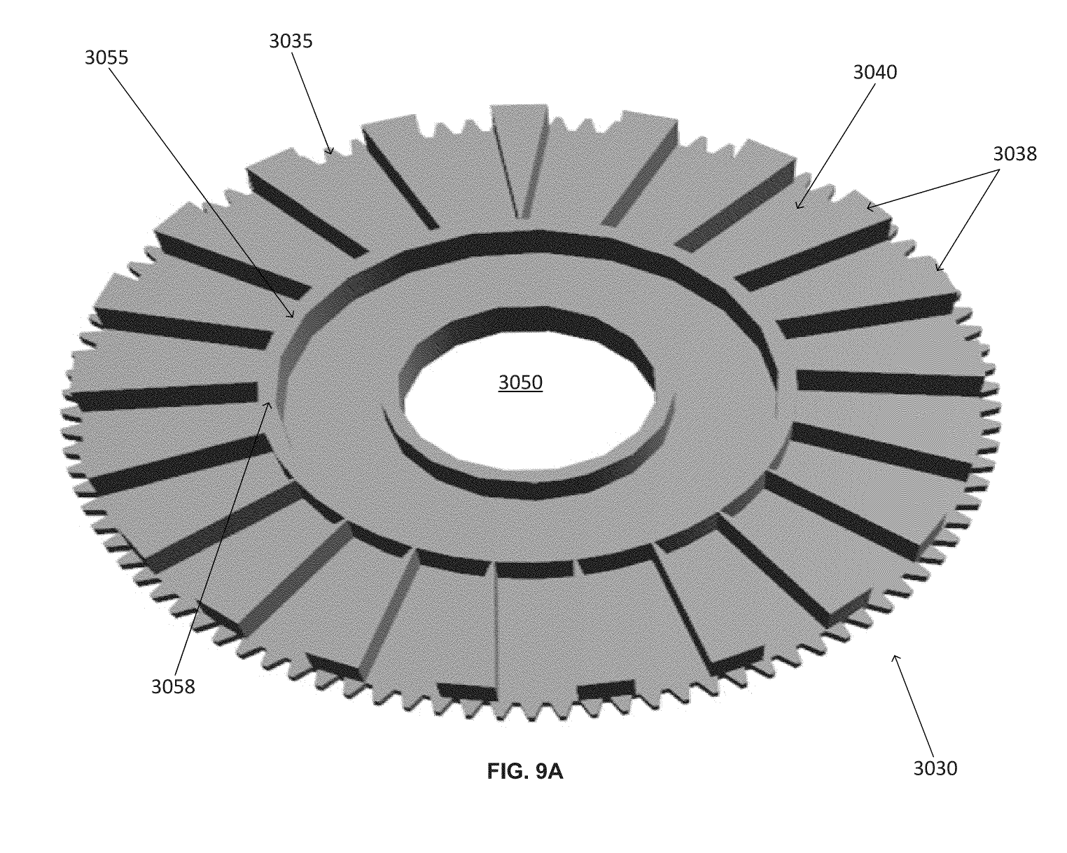

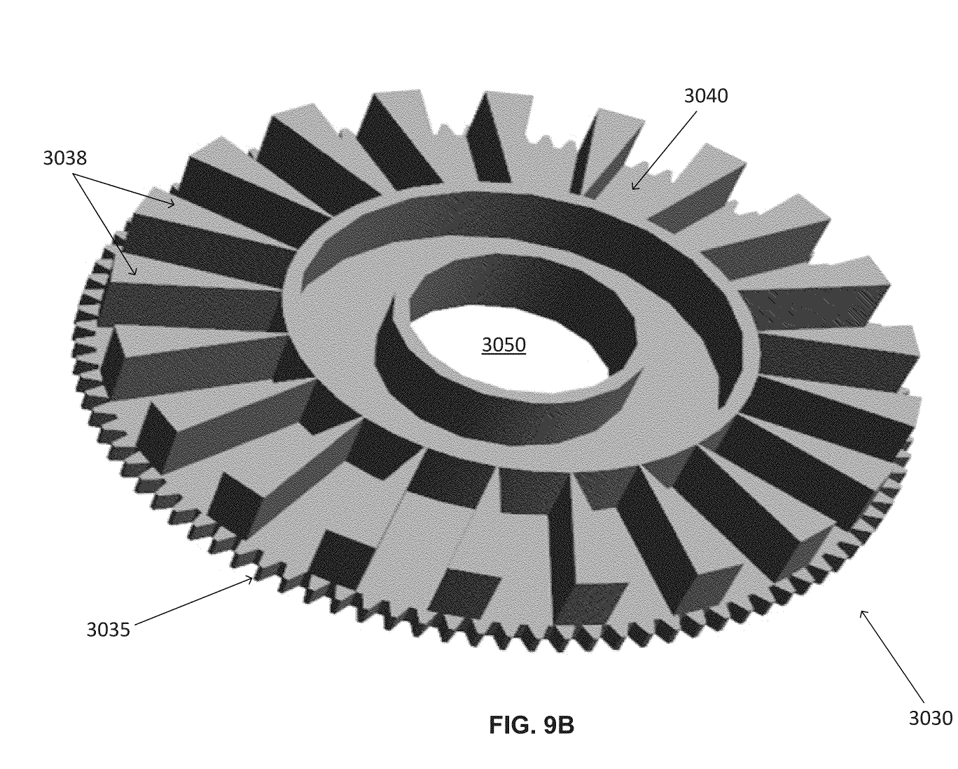

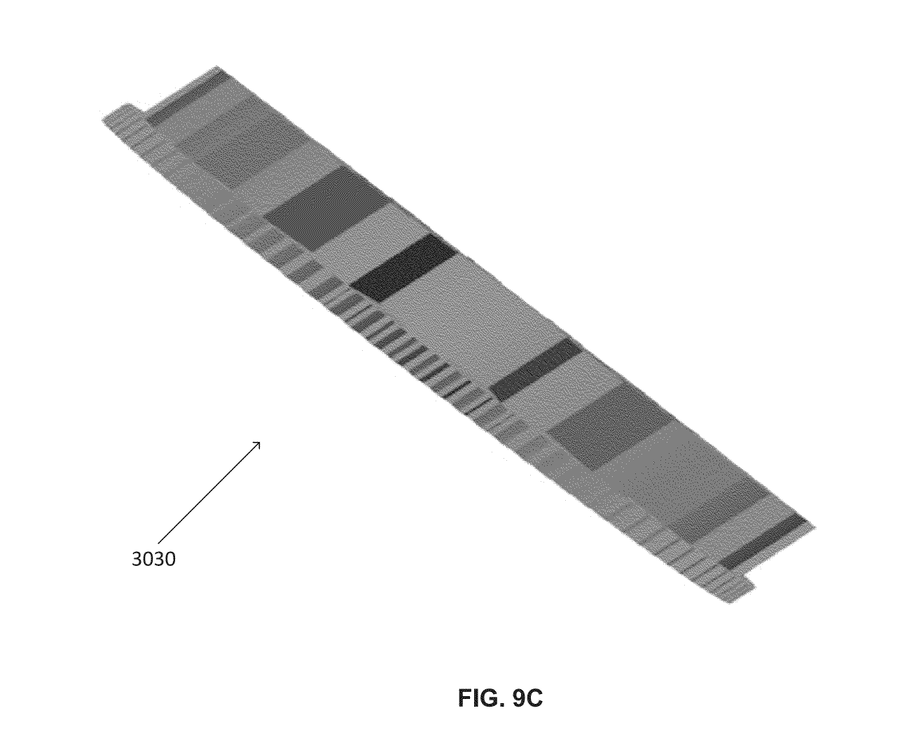

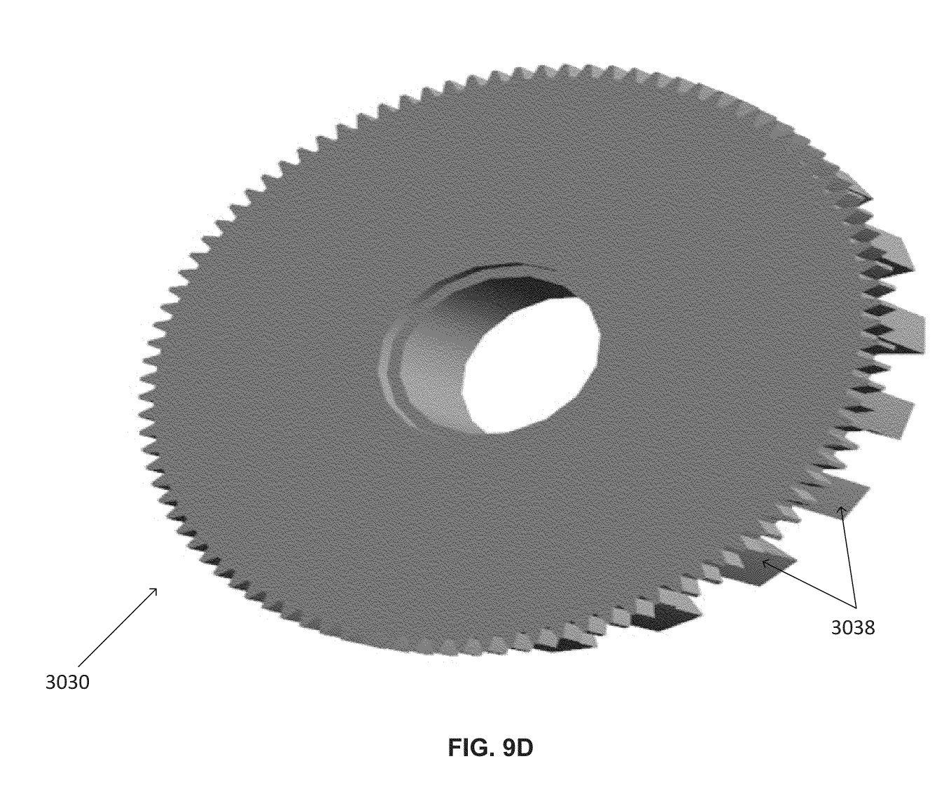

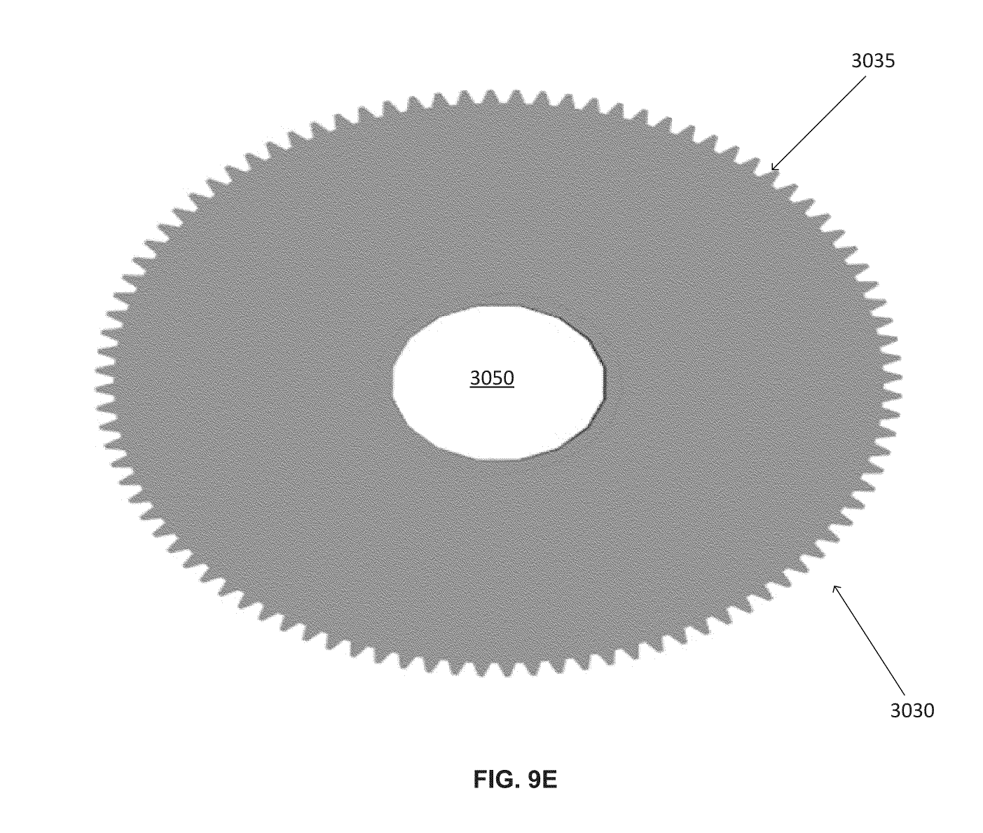

FIG. 9A is a front perspective view of a spur gear 3030; FIG. 9B is a perspective view of the spur gear 3030; FIG. 9C is a side view of the spur gear 3030; FIG. 9D is yet another perspective view of the spur gear 3030; and FIG. 9E is a back view of the spur gear 3030.

A spur gear 3030 may have a first opening or ring 3055 that may be coaxial to a second ring 3058. First ring 3055 may form the periphery of inner opening 3050. Wedge-shaped protrusions 3038 may radiate out from second ring 3058 at distances apart that create equally spaced protrusion-created gaps 3040 between adjacent protrusions 3038. The number of protrusion-created gaps 3040 that are formed may depend on a variety of factors, for example, such as the size of the units of medication to be stored in one or more protrusion-created gaps 3040, the size of the spur gear 3030, and the number of units of medication to be stored per spur gear 3030. Different disk sizes may be compatible with different combinations of different sizes and numbers of units of medication. Said protrusions 3038, first ring 3055, and second ring 3058 may protrude in the same direction and on an axis perpendicular to the face of an inner opening 3050. Additional protrusions 3035 may protrude on an axis parallel to the face of an inner opening 3050, where teeth 3035 are formed on the outer periphery of spur gear 3030. Said protrusions 3035 may taper towards the outer wall of second ring 3058.

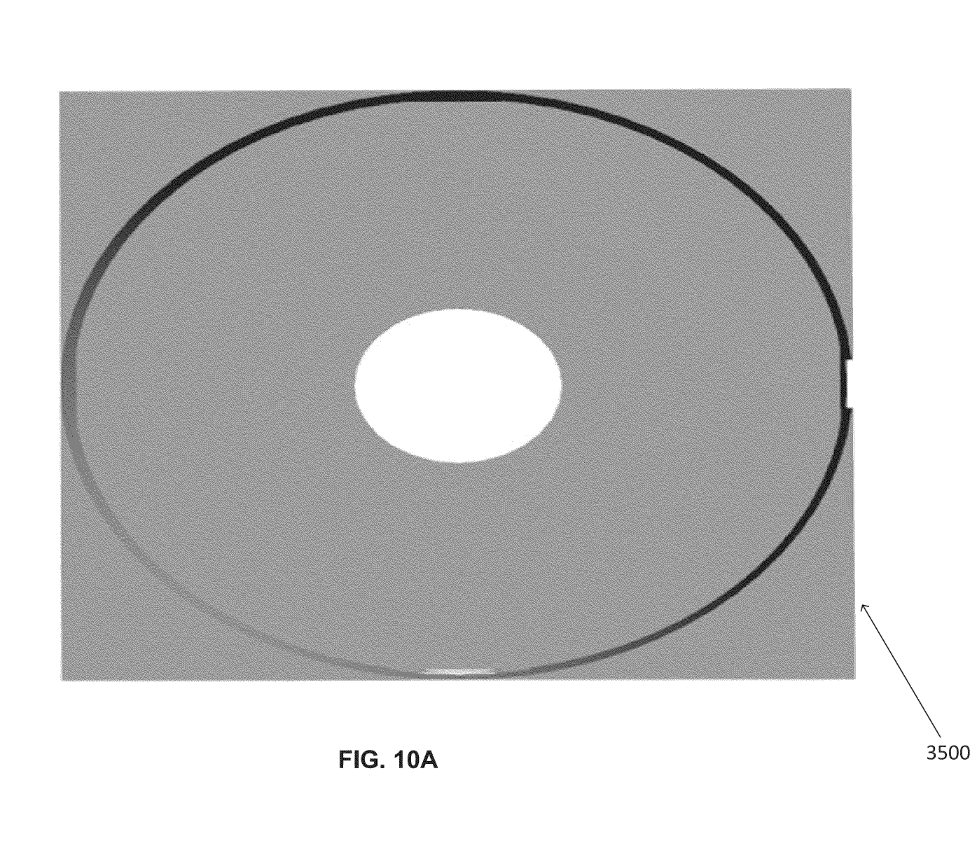

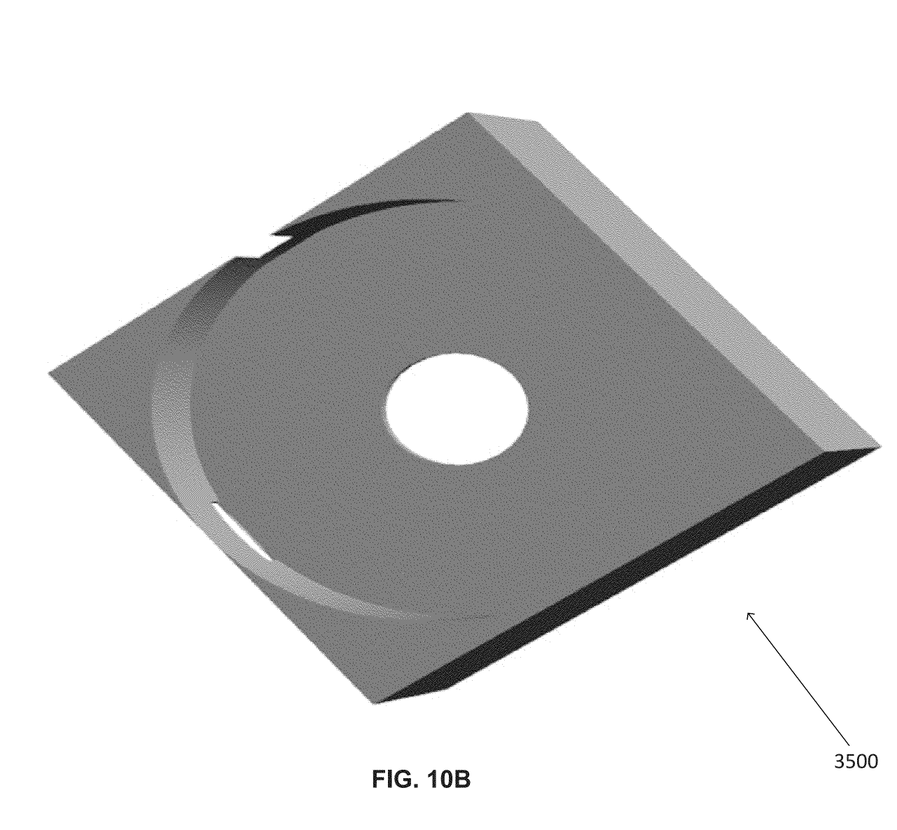

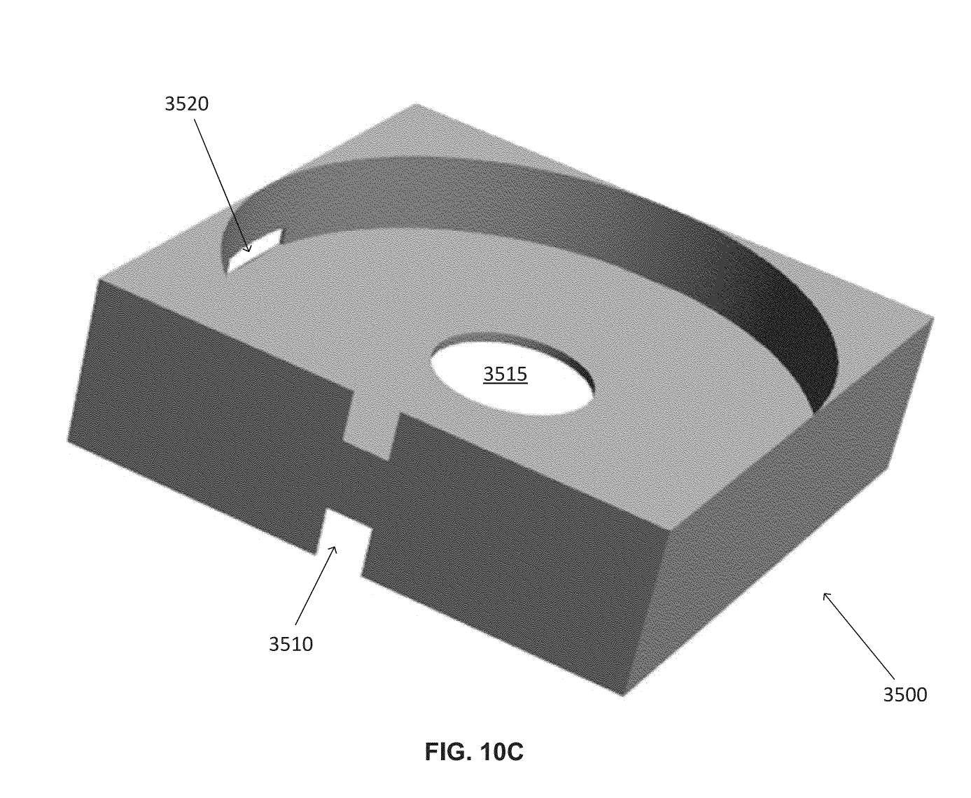

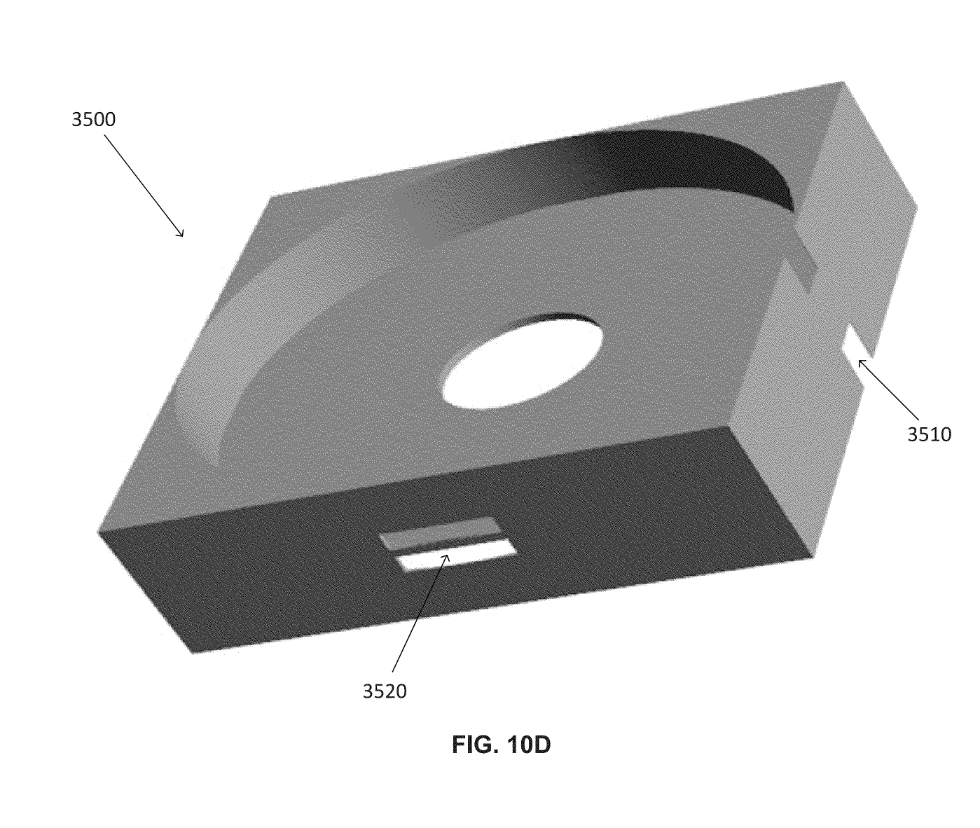

FIG. 10A is a front view of a housing of a vial 3500 (or vial body); FIG. 10B is a perspective view of the vial body 3500; FIG. 10C is another perspective view of the vial body 3500; and FIG. 10D is yet another perspective view of the vial body 3500.

One or both face(s) of the vial body 3500 may have an indented portion. Vial body 3500 may have an inner opening 3515 through said indented portion. One or more pill outlets 3510 may form one or more openings on one face of vial body 3500 that is perpendicular to the face with an indented portion. Said pill outlet(s) 3510 may extend through a portion of said face that forms the periphery of one or both of said indented portions of vial body 3510, where each pill outlet 3510 extends through the periphery of a different indented portion of vial body 3510. Said one or more pill outlets 3510 may be located so as to be able to align with protrusion-created gap 3040 of one or more spur gears 3030 if said spur gear(s) 3030 are installed, as follows, in vial body 3500. One or more gear outlets 3520 may form one or more openings on one face of vial body 3500 that is perpendicular to the face with an indented portion. Said one or more gear outlets may be located so as to be able to align with teeth 3035 of one or more spur gears 3030 if said spur gears 3030 are installed, as follows, in vial body 3500.

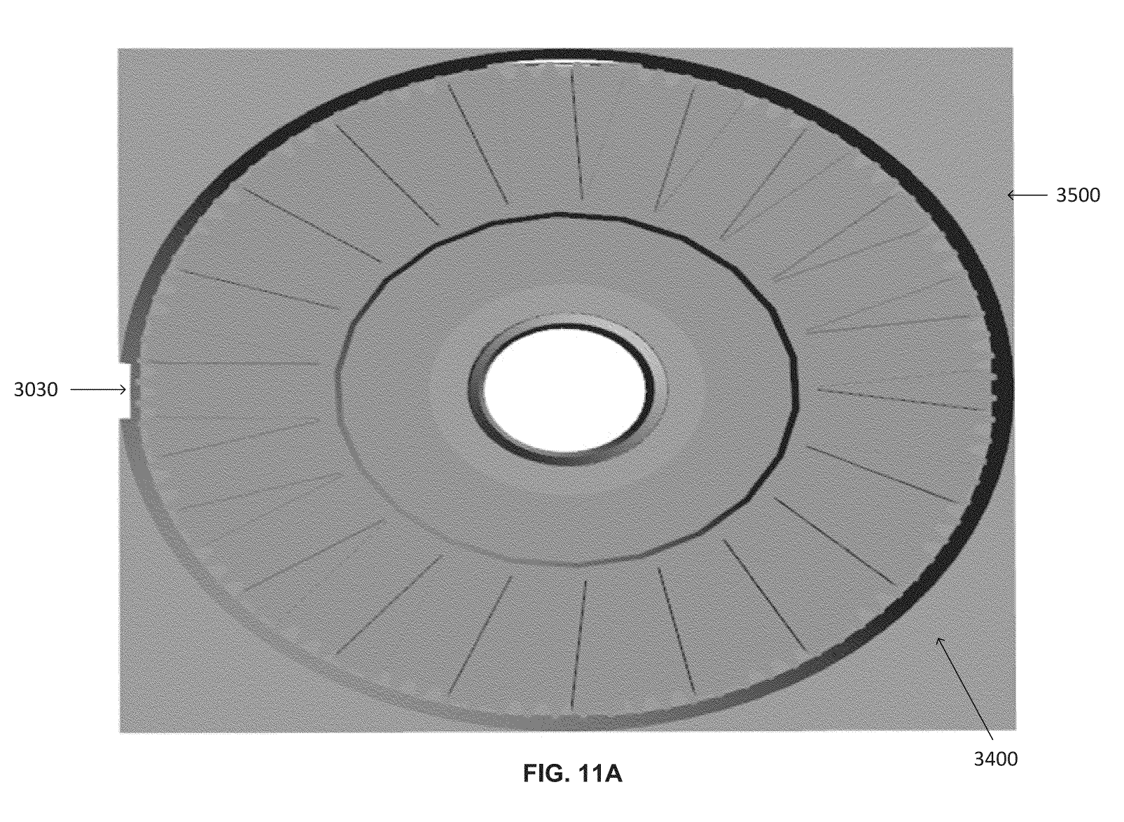

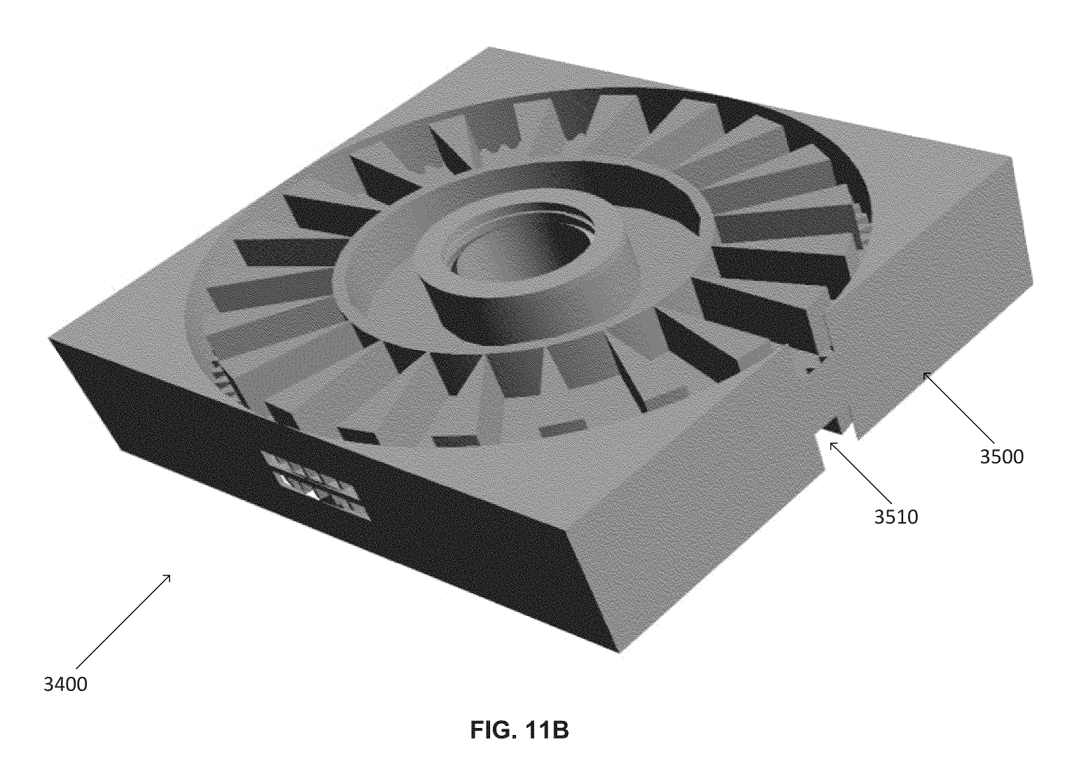

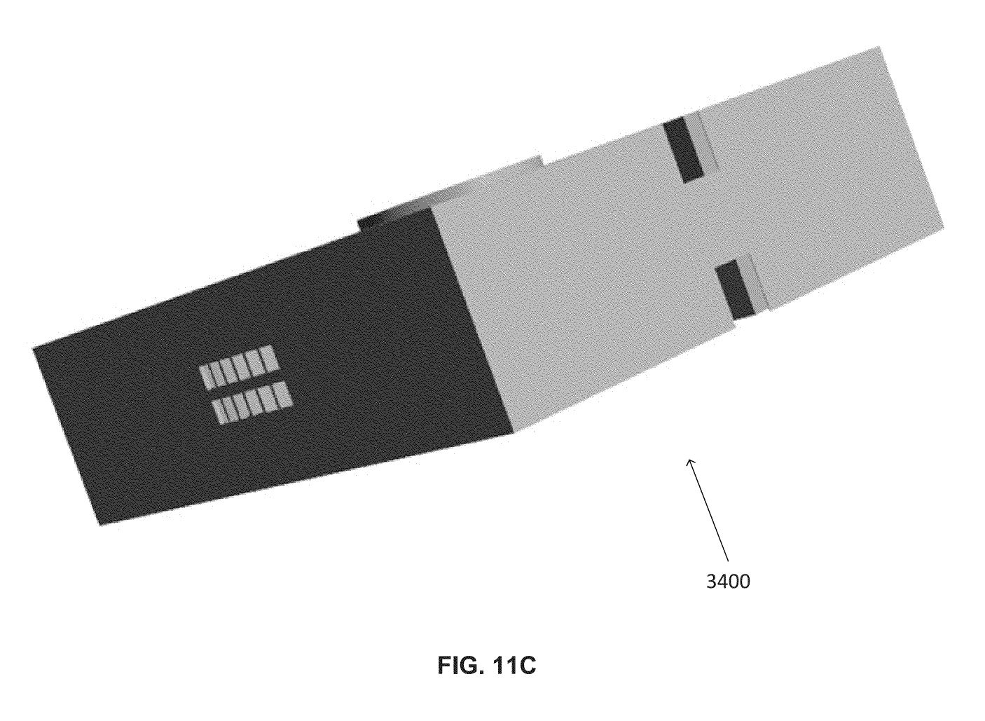

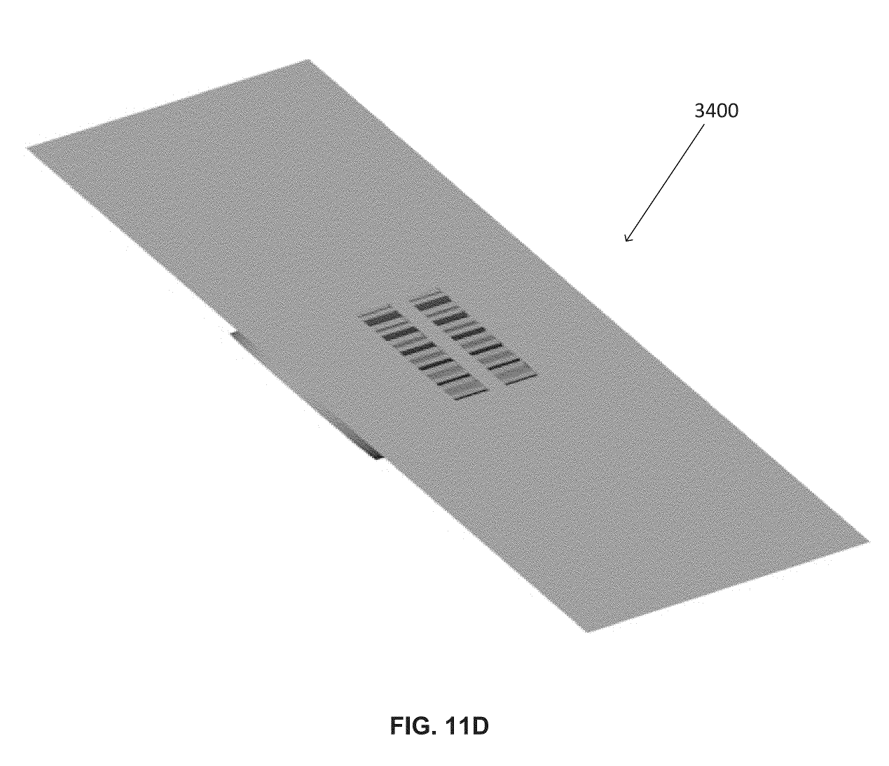

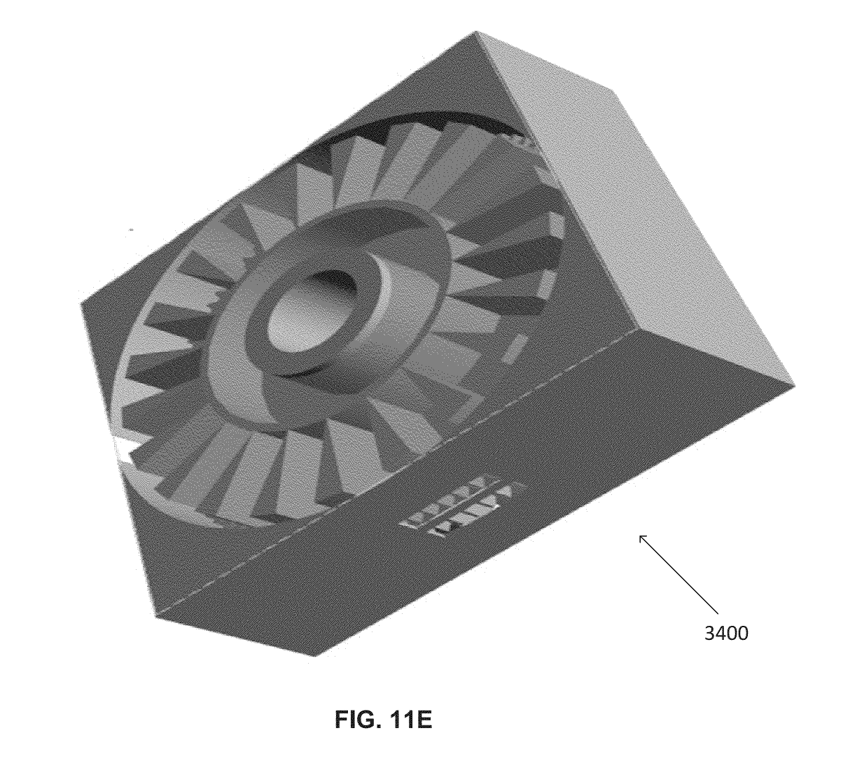

FIG. 11A is a front view of a vial assembly 3400 including a flange, a second flange, a spur gear and a vial body; FIG. 11B is a perspective view of the vial assembly 3400; FIG. 11C is a side view of the vial assembly 3400; FIG. 11D is yet another side view of the vial assembly 3400; and FIG. 11E is another perspective view of the vial assembly 3400.

In one embodiment of vial assembly 3400 as shown, a spur gear 3030 may be placed in one of the said indented portions of vial body 3500 and/or another spur gear 3030 may be placed in the opposite said indented portion of vial body 3500, such that the spur gear(s) 3030 are co-axial to the vial body 3500. If such placement or placements are made, inner opening 3050 of spur gear 3030 may be aligned with inner opening 3515 of vial body 3500. Flange 3010 may be coupled with flange 3020 to create a tight or secure fit. A flange 3010 and a flange 3020 may be coupled and fitted through both the inner opening 3050 of spur gear 3030 and the inner opening 3515 of vial body 3500 and the outer walls of said flanges 3010 and 3020 also may be adjacent to the walls of the vial body 3500. The installation in the opening 3050 may secure the spur gear 3030 to the vial body 3500 and extend perpendicularly through opening 3515 in vial body 3500. The spur gear 3030 may be secured to the vial body 3500 within an indented portion of one face of the vial body 3500. Covering disk 3000 may be placed to enclose spur gear 3030 within vial body 3500. Each assembly 3400 may accommodate up to two spur gears 3030. Each assembly 3400 may Iso be referred to as a single vial 30. Two or more assemblies 3400 may form a magazine 5000.

A face of the vial body 3500 that is perpendicular to the face with an indented portion may have one or more pill outlets 3510, which may be associated with or attached to, for example, teeth, hooks, and/or one or more gears, that may be associated with a dispensing device 100. An actuating mechanism 40 associated with a dispensing device 100, for example, a mechanism including a gear, may engage teeth-like protrusions 3035 of a spur gear 3030. Said actuating mechanism 40 may separately engage one or more spur gears 3030 through one or more gear outlets 3520. For example, a controller 20 in dispensing device 100 may select the spur gear 3030 to engage based on data relating to pill type contained in an associated vial 30, data relating to an association between an associated vial 30 and its location in a dispensing device 100, and pill type required to be dispensed, for example, based on data relating to a prescription schedule. In one embodiment, the mechanism may engage teeth-like protrusions 3035 and rotate a measured distance to effect the successive alignment of one or more protrusion-created gaps 3040 with a gap 3510. Said gap 3510 may be located in a face of vial body 3500, where said face is perpendicular to one or more faces of vial body 3500 that has an indented portion. Said protrusion-created gaps 3040 may be located between adjacent protrusions 3038. This assembly may provide the controlled release of one pill at a time from a vial 30. For example, a single pill may be located in a protrusion-created gap 3040 and each protrusion-created gap 3040 may contain one pill. If an actuating mechanism 40 of a dispensing device 100 actuates the dispensing of one or more units of medication, the mechanism may engage teeth 3035 and rotate a distance to allow the desired number of protrusion-created gaps 3040 to each successively align with a medication outlet 3510, such that upon each alignment, one pill may be released by gravity from the vial 30, up to the number of units of medication desired to be dispensed. Upon association, for example, installation or insertion, of body 3400 in a dispensing device 100, a covering, for example, tamper evident foil, over one or more pill outlets 3510 may be breached. When a pill is released from the vial 30, a sensor in the dispensing device 100 receives data relating to said release and the dispensing device 100, for example, through a controller 20, may cause an actuating mechanism 40 to stop. A dispensing device 100 may configure the actuating mechanism 40 to stop, for example, the rotation of a spur gear 3900, upon receipt by a processor 210 of data relating to the quantity of units of medication in a vial 30 and/or data relating to the appropriateness of units of medication contained in a vial 30, for example, data relating to the expiry or recall or that one or more units of medication contained therein are of a type no longer prescribed to the patient associated with said dispensing device 100.

### Centric Slotted Disk Configuration

In one embodiment, vial 30 may be of a concentric slotted disk vial design.

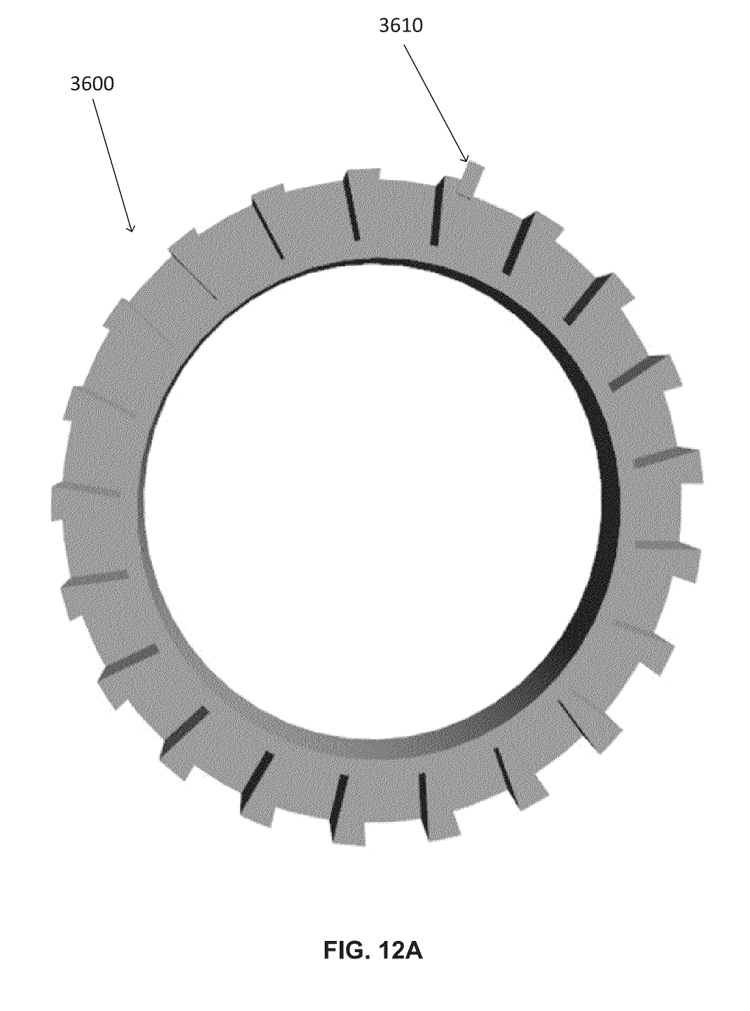

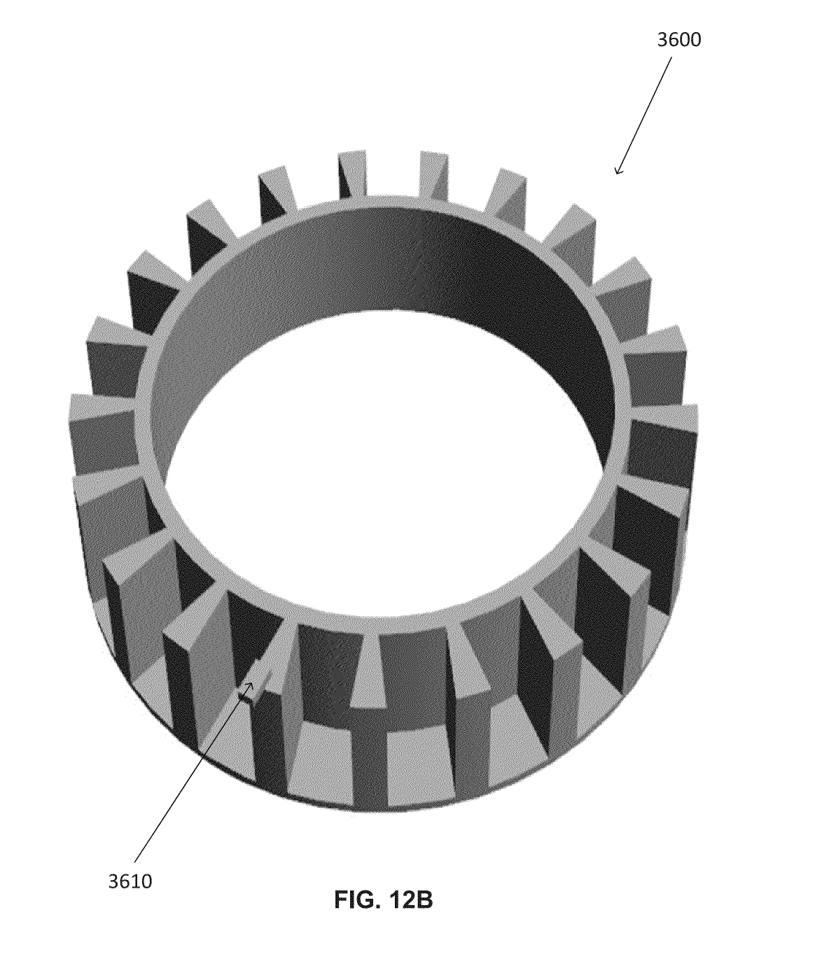

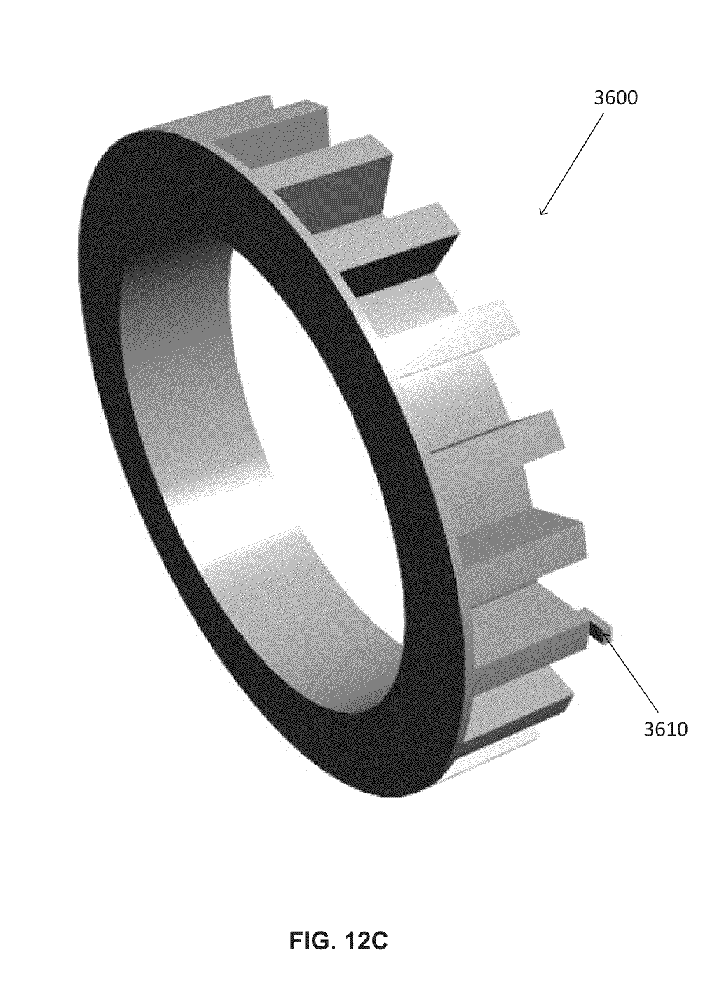

FIG. 12A is a front view of an inner gear 3600; FIG. 12B is a perspective view of the inner gear 3600; and FIG. 12C is another perspective view of the inner gear 3600.

In one embodiment, inner gear 3600 may comprise a hollow cylinder that forms the periphery of an inner opening and said cylinder may have wedge-shaped protrusions that radiate out from an outer wall of said cylinder in a direction perpendicular to said inner opening. Said wedge-shaped protrusions may be adjacent to the entire length of outer wall of said cylinder. A lip may extend from the periphery of an inner wall of said cylinder to the outer periphery of said wedge-shaped protrusions. The number of protrusion-created gaps that are formed may depend on factors, for example, the size of the units of medication to be stored in one or more protrusion-created gaps, the size of the inner gear 3600, and the number of units of medication to be stored per inner gear 3600. Different disk sizes may be compatible with different combinations of different sizes and numbers of units of medication. Said wedge-shaped protrusions may taper towards the outer wall of said cylinder. A stud 3610 may be attached near a wide end of one wedge-shaped protrusion and protrude from said wedge-shaped protrusion in a direction away from the centre said cylinder.

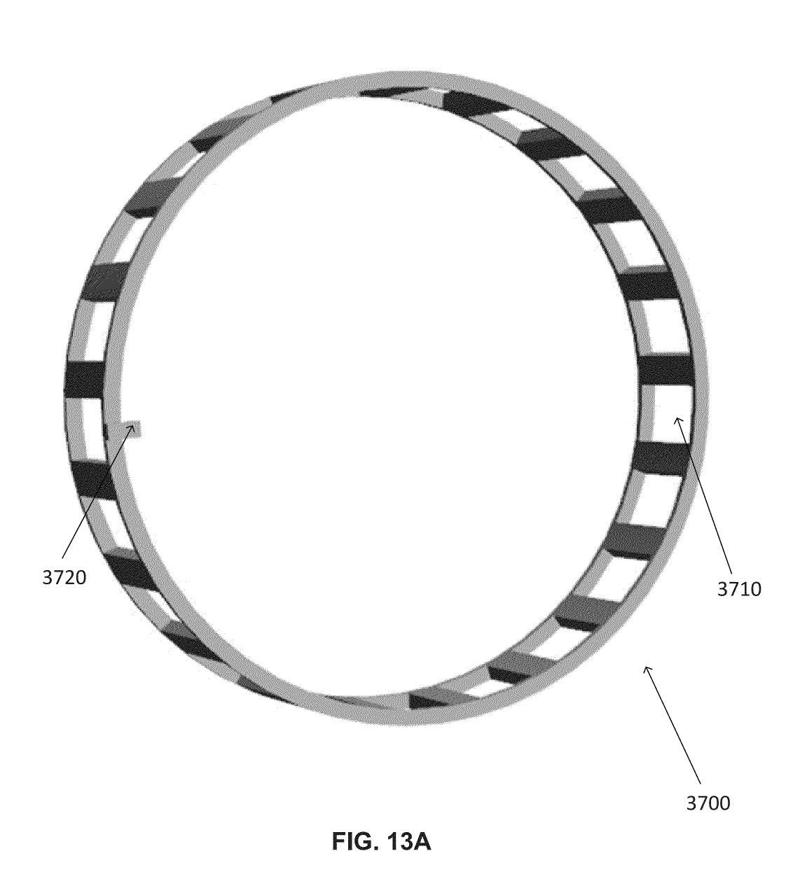

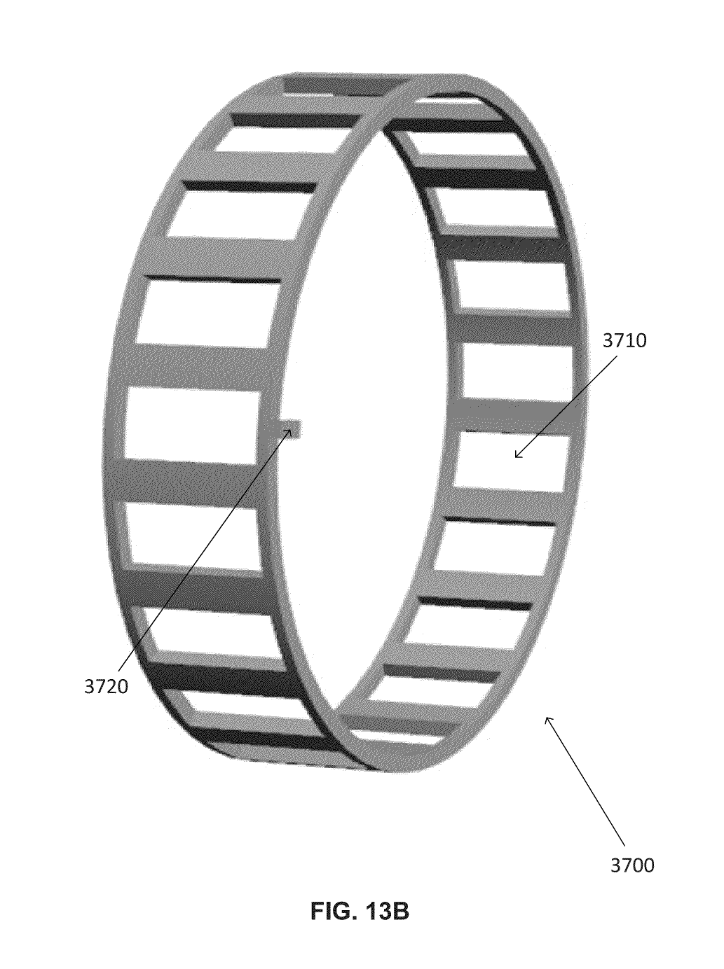

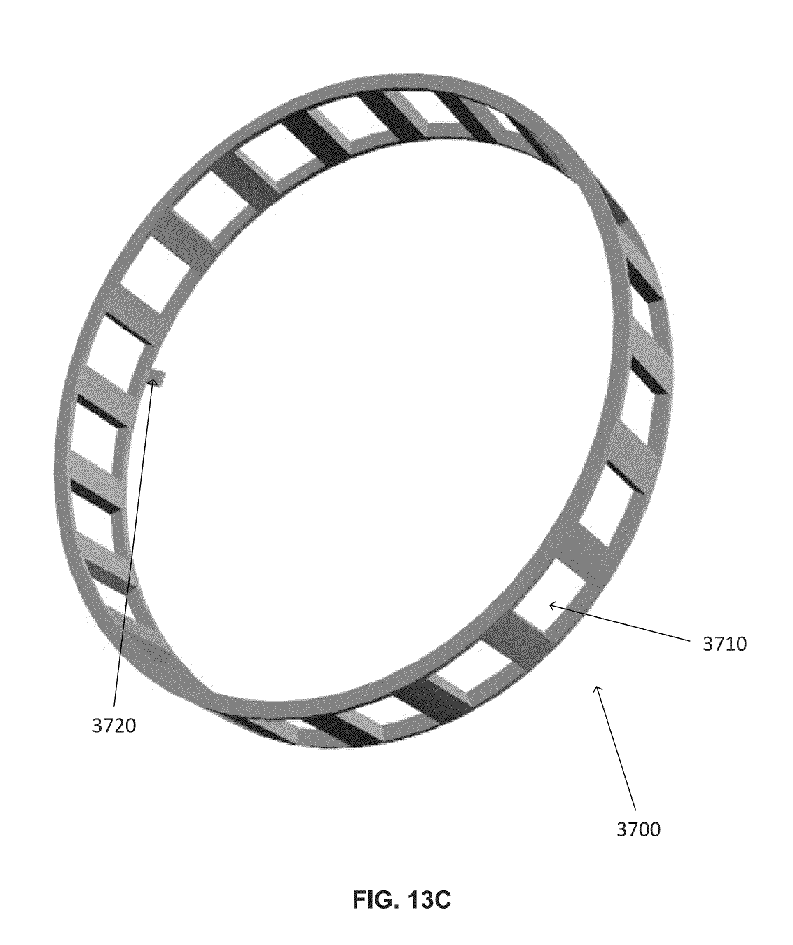

FIG. 13A is a perspective view of an inner ring 3700; FIG. 13B is another perspective view of the inner ring 3700; FIG. 13C is yet another perspective view of the inner ring 3700.

Inner ring 3700 may be comprised of a first ring that is opposite to, runs parallel to, and is co-axial with a second ring. Said first and second rings may be joined along their inner walls at equally spaced intervals by protrusions that extend from inner wall of first ring to inner wall of second ring. Said first and second rings may form the periphery of an inner opening. Said protrusions may form equally sized openings 3710. A stud 3720 may be attached to the outer wall of first ring and protrude towards the centre of said ring. A notch may be present in outer periphery of a first ring of inner ring 3700.

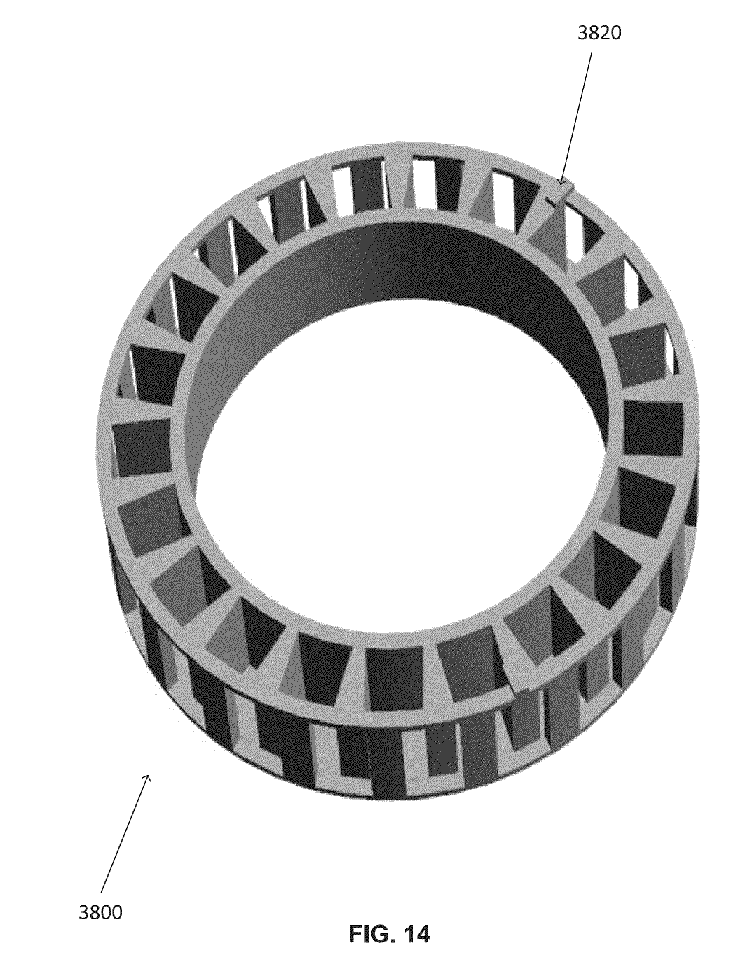

FIG. 14 shows perspective view of an inner gear 3600 Installed in inner ring 3700, forming a wheel 3800. The inner opening of said inner ring 3700 may be intermittently adjacent to an edge of the wide end of wedge-shaped protrusions of the inner gear 3600 when inner gear 3600 and/or inner ring 3700 are rotated.

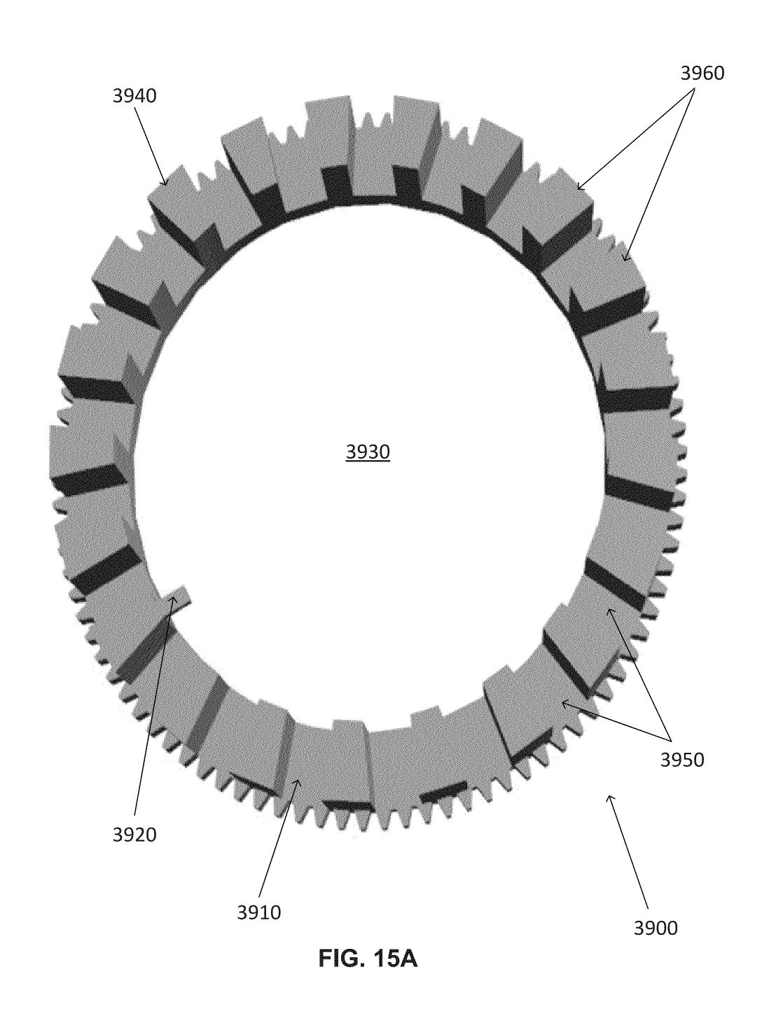

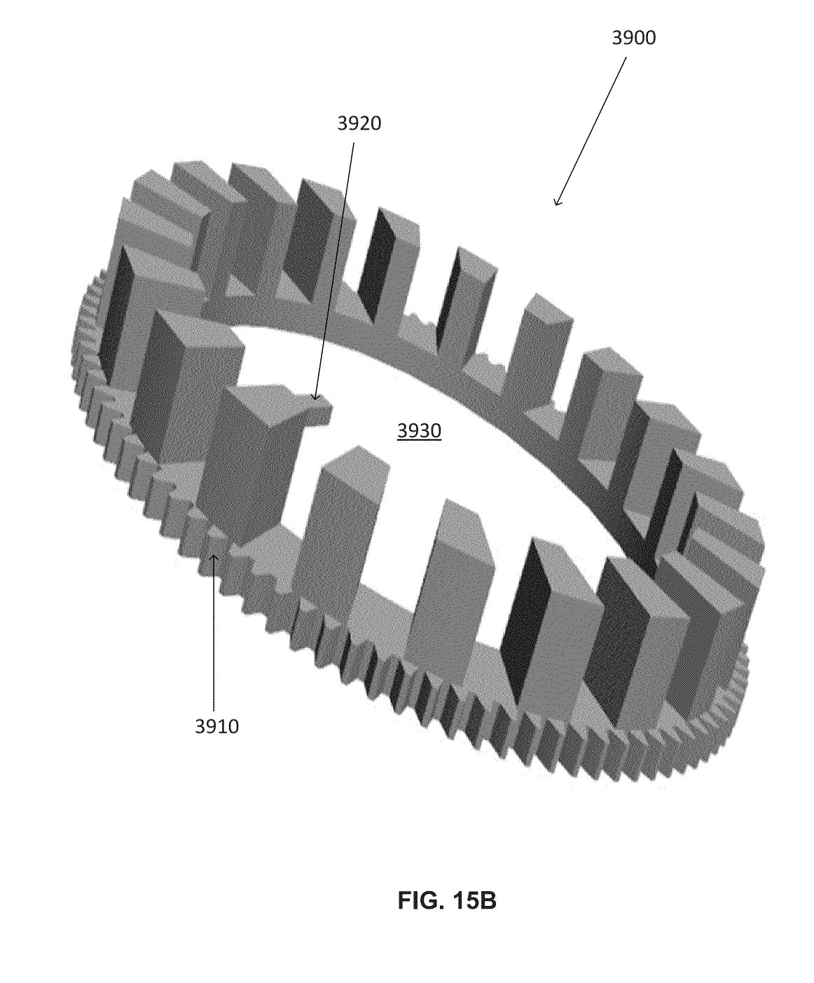

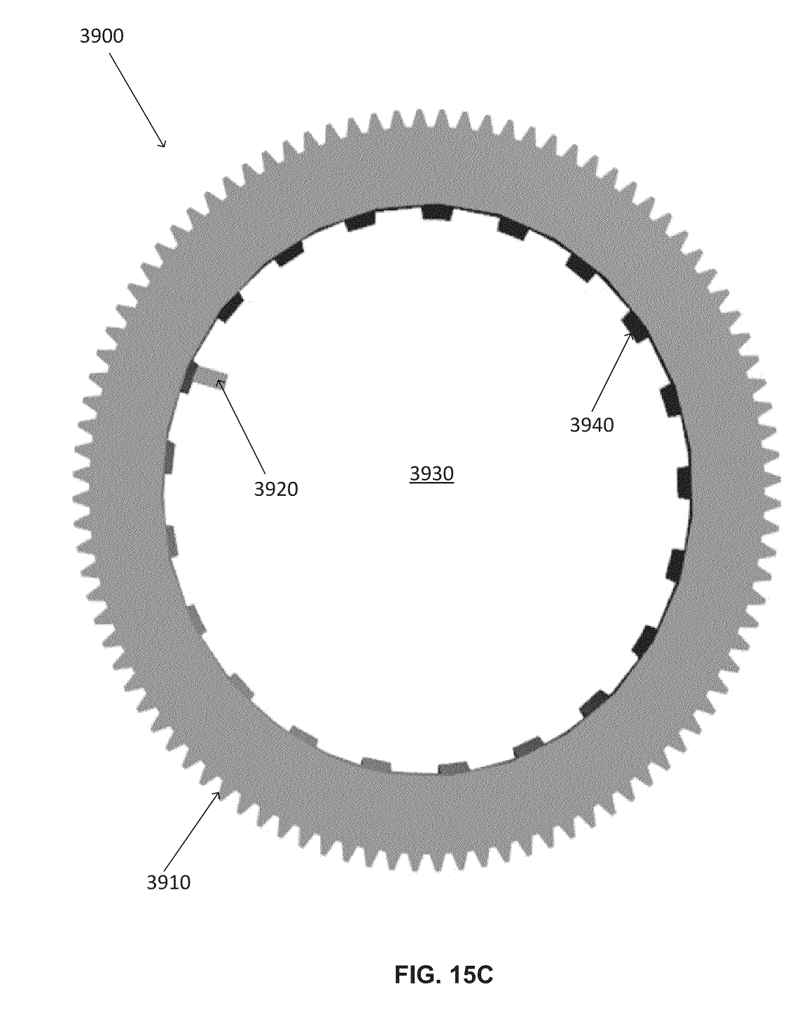

FIG. 15A is a front perspective view of a second spur gear 3900; FIG. 15B is a perspective view of the second spur gear 3900; and FIG. 15C is a back view of the second spur gear 3900.

A second spur gear 3900 may have an ring whose inner walls form the periphery of opening 3930 and whose outer wall consists of teeth-like protrusions 3910 that extend away from opening 3930. Wedge-shaped protrusions radiate out along the length of the same face of said ring at distances apart that create equally spaced protrusion-created gaps between adjacent protrusions. Said face may be perpendicular to inner wall of said ring. Said wedge-shaped protrusions may taper toward opening 3930 and be equally spaced along said face of said ring. A stud 3920 may be attached to one wedge-shaped protrusion on the wall of said protrusion, where said wall is flush with the inner wall of said ring. The attachment may be at the end of said face that is opposite the face of inner ring that said protrusion extends away from. Said stud 3920 may protrude towards the centre of opening 3930. The number of protrusion-created gaps that are formed may depend on factors, for example, the size of the units of medication to be stored in one or more protrusion-created gaps, the size of the spur gear 3030, and the number of units of medication to be stored per spur gear 3030. Different disk sizes may be compatible with different combinations of different sizes and numbers of units of medication.

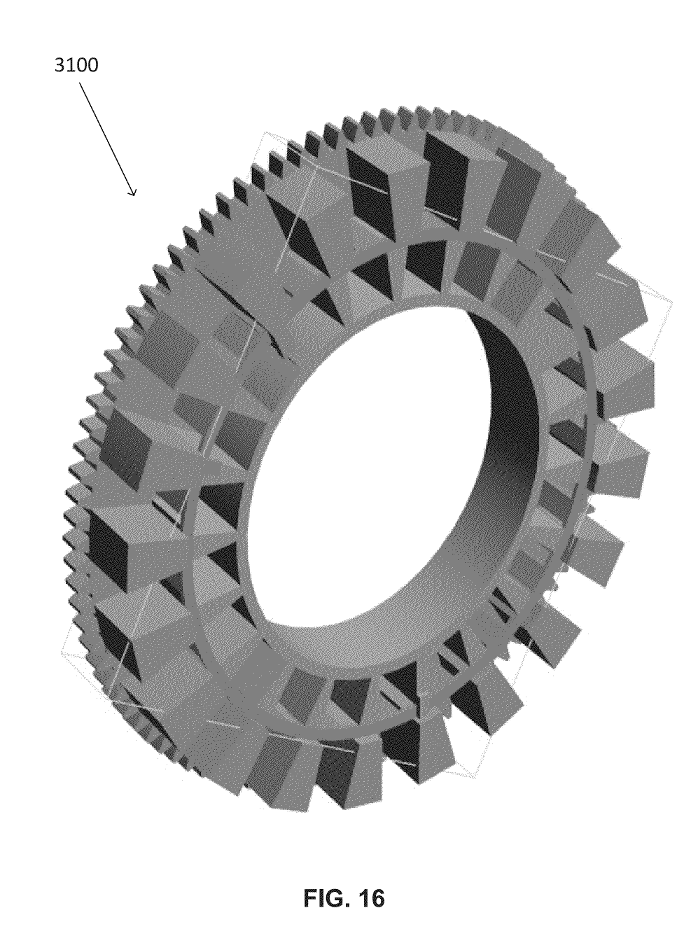

FIG. 16 is a perspective view of an inner gear 3600, an inner ring 3700 and a second spur gear 3900. The inner wall of the ring that forms the periphery of opening 3930 may be adjacent to the outer periphery of the first and second rings that comprise inner ring 3700. In other embodiments, concentric wheel 3100 may comprise one or more additional wheels 3800 that are installed co-axial to spur gear 3900 and such that the outer periphery of the first and second rings that comprise inner ring 3700 of a first inner ring 3700 may be adjacent to the inner periphery of the first and second rings that comprise inner ring 3700 of a second inner ring 3700. In any embodiment, any inner ring 3700 may rotate independently of any inner gear 3600.

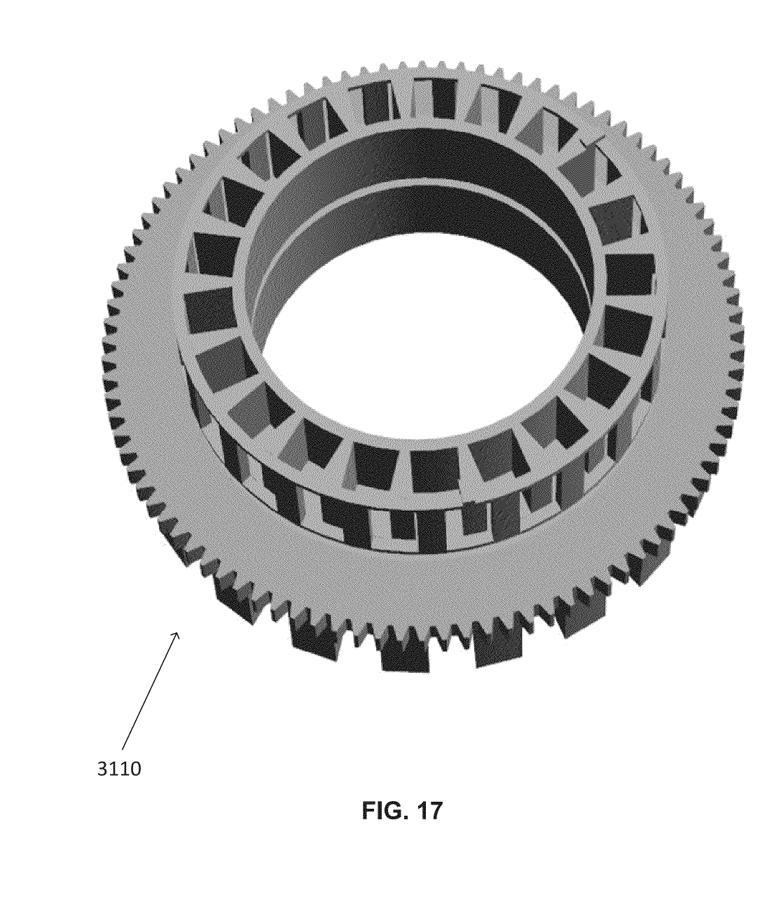

FIG. 17 is a perspective view of two inner gears, two inner rings and a second spur gear body, forming a first concentric wheel 3100 and wheel 3800, where wheel 3800 is co-axial with and stacked on top of the wheel 3800 in concentric wheel 3100.

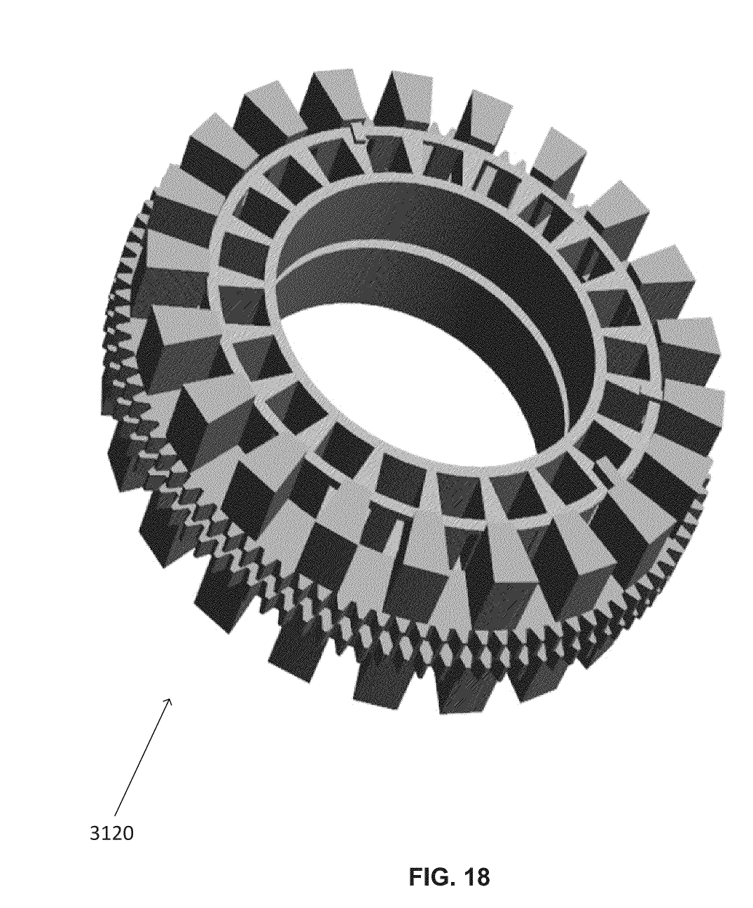

FIG. 18 is a perspective view of two inner gears, two inner rings and two second spur gears, forming paired concentric wheel 3120. Paired concentric wheel 3120 may comprise a first concentric wheel 3100 that may be coupled with a second concentric wheel 3100, such that the face of the spur gear 3900 of the first concentric wheel 3100 that is opposite the face that the wedge-shaped protrusions are attached to is adjacent to the corresponding face of the second spur gear 3900. In one embodiment, each wheel 3800 may store only one type of pill. This may be one way to allow a dispensing device 100 to accurately dispense the desired type of pill, as a controller 20 in a dispensing device 100 may receive data about one or more pill types to be dispensed, for example, based on a prescription schedule, and said controller 20 may base its selection of vial 30 on said data.

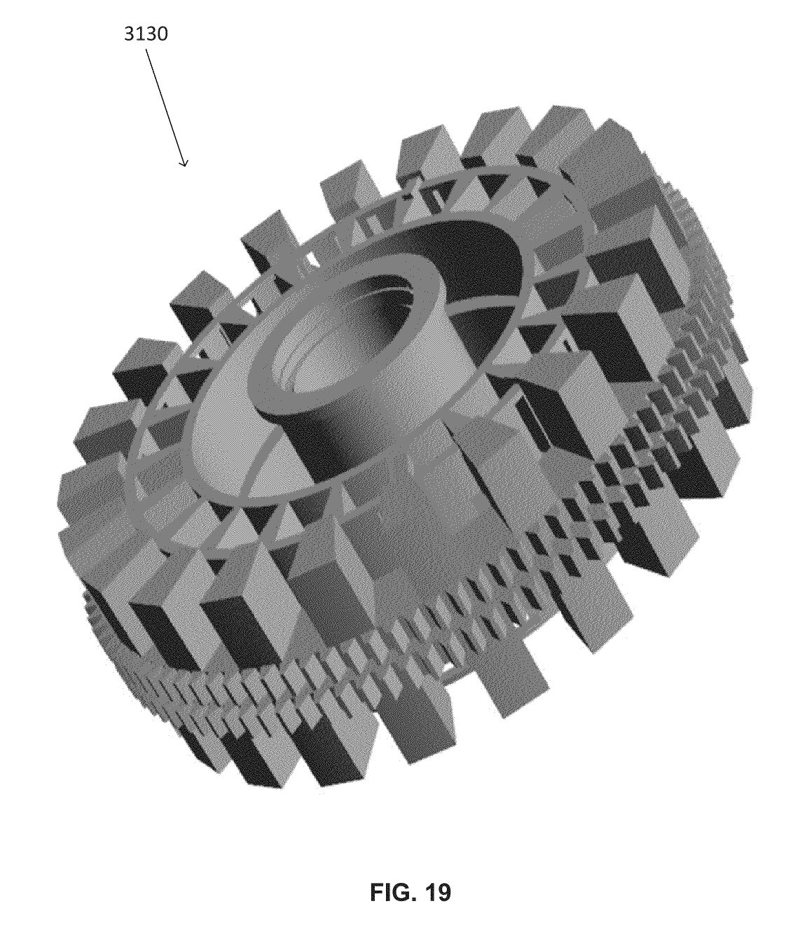

FIG. 19 is a view of an example of the installation of a flange 3010 and flange 3020 in a paired concentric wheel 3120, together comprising partially assembled body 3130. Flange 3010 may be coupled with flange 3020 to connect the flange 3010 with flange 3020 and may, for example, create a tight fit. A flange 3010 and a flange 3020 may be installed, for example, coupled, through the portion of the inner opening 3930 of spur gear 3900 that remains open in a paired concentric wheel 3120 when one or more wheels 3800 are installed in spur gear 3900. A coupled flange 3010 and flange 3020 may extend perpendicularly through said inner opening 3930. The outer walls of a coupled flange 3010 and flange 3020 may be adjacent to the inner wall of a wheel 3800 that has been installed in the spur gear 3900. The installation of flange 3010 and flange 3020 in said inner opening may hold the spur gear 3900 and one or more wheels 3800 together. One or more bodies 3100 and a vial body 3500 may also be held together with spur gear 3900 and wheels 3800 by said installation. One or more wheels 3800, inner gears 3600, and/or inner rings 3600 may move, for example, rotate, around an axis defined by a coupled flange 3020 and flange 3010 in said installation. Said rotation may be actuated, for example, by an actuating mechanism 40 of a dispensing device 100 of teeth-shaped protrusions 3910 on an outer edge of a spur gear 3900.

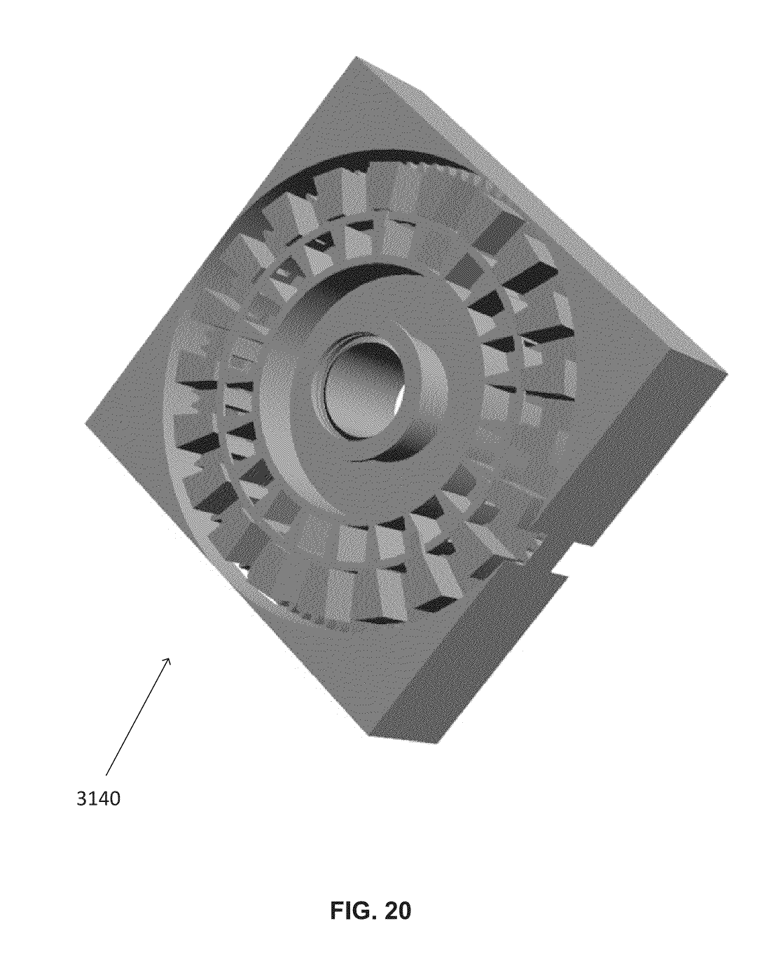

FIG. 20 is a view of an example of a paired concentric wheel 3120 installed in a vial body 3500, together comprising assembled body 3140. In one embodiment, a paired concentric wheel 3120 may be placed in one of the indented portions of vial body 3500 and/or another paired concentric wheel 3120 may be placed in the opposite said indented portion of vial body 3500, such that the body or bodies 3120 are co-axial to the vial body 3500. If such placement or placements are made, the inner opening of paired concentric wheel 3120 may be aligned with inner opening 3515 of vial body 3500.

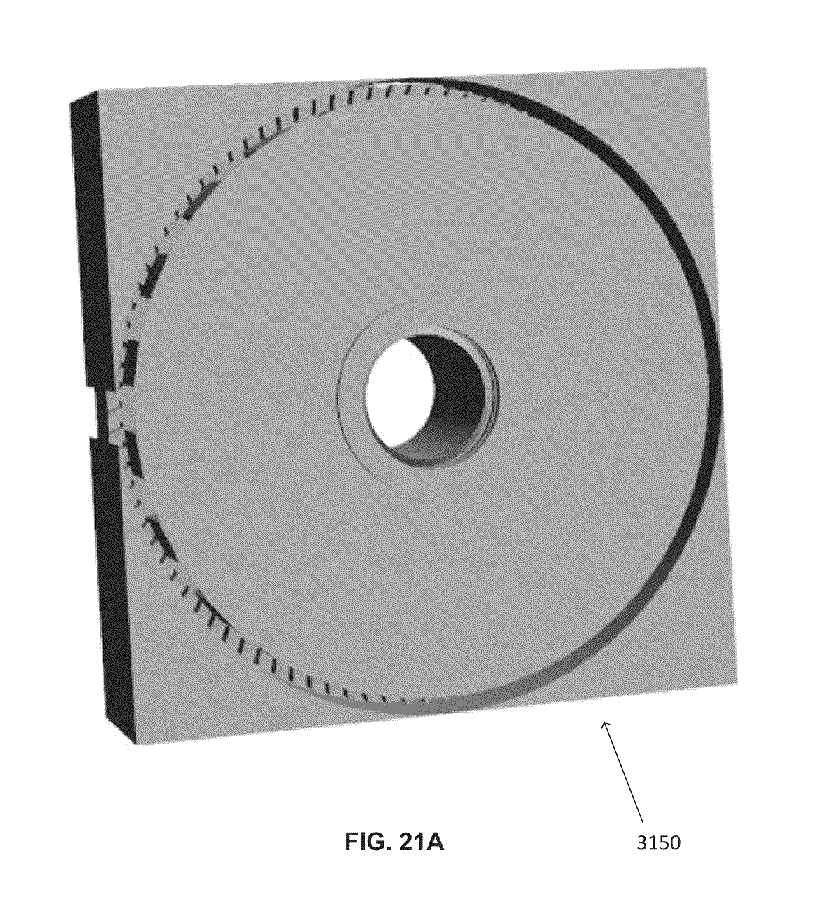

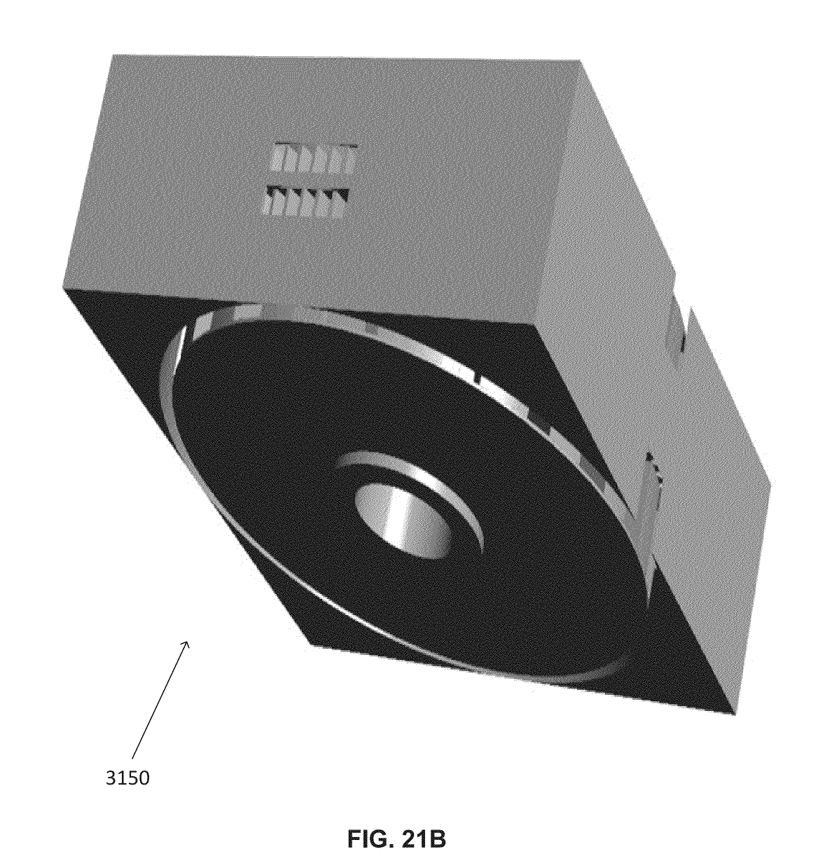

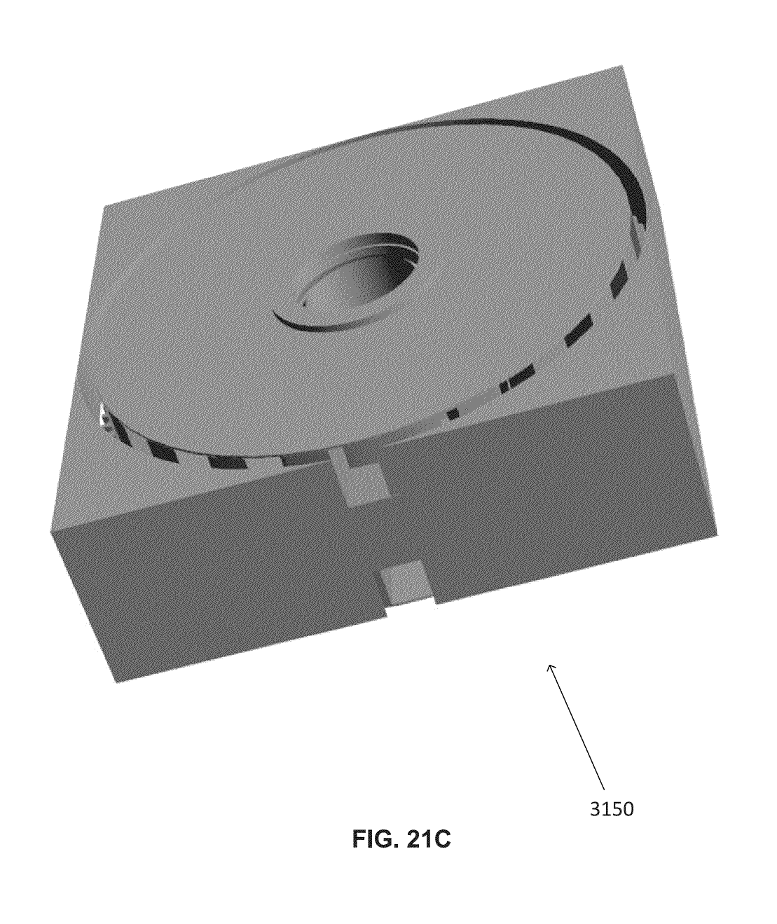

FIG. 21A is a perspective view of the second vial assembly 3150 with a cover disk 3000; FIG. 21B is another perspective view of the second vial assembly 3150; and FIG. 21C is yet another perspective view of the second vial assembly 3150.

Vial assembly 3150 may include a covering disk 3000 may be placed to enclose a concentric wheel 3100, comprising a spur gear 3900 and one or more wheels 3800, that has been installed in a vial body 3500. Said placement of a covering disk 3000 may be secured, for example, using ultrasonic wielding at a pharmacy 180. This may help prevent unauthorized access, for example, that may lead to patient overdosing and/or taking one or more units of medication not in accordance with their prescription.

In one embodiment, there may exist an inner gear 3600 that does not have a hollow cylinder. For example, said inner gear 3600 may be comprised of a ring, where evenly spaced wedge-shaped protrusions extend the length of the width of one face of said ring and taper towards the centre of the ring. In one embodiment, a concentric wheel 3100 may have one or more inner gears 3600 between the innermost inner gear 3600 and a spur gear 3900 that together comprise a concentric wheel 3100.

In a concentric wheel 3100, each protrusion attached to one or more co-axial rings of inner ring 3700 may intermittently align with a protrusion-created gap of an inner gear 3600. Any said alignment may prevent the release of a pill from said protrusion-created gap at the time when said protrusion-created gap may be aligned with pill outlet 3510 of vial body 3500. Any said intermittent alignment not involving a spur gear 3900 may also prevent the release of a pill from said protrusion-created gap, for example, into a protrusion-created gap in another inner gear 3600. An actuating mechanism of a dispensing device 100 may actuate said intermittent alignment.

In one embodiment, an actuating mechanism 40 of a dispensing device 100 may actuate the release of one or more units of medication from a first inner gear 3600 that may contain one or more units of medication and that is nearest vial body 3500. An actuating mechanism 40 may actuate the dispensing of one or more units of medication from a second inner gear 3600, for example, if a first inner gear 3600 has made a complete rotation and/or does not contain any units of medication. An actuating mechanism 40 may actuate the movement of an inner ring 3700 and a protrusion in inner ring 3700 may be or become unaligned with a protrusion-created gap of inner gear 3600. A protrusion-created gap of a first inner gear 3600 may be or become aligned with one or more protrusion-created gaps of one or more other inner gears 3600. A protrusion-created gap of one or more inner gears 3600 may be or become aligned with a pill outlet 3510 of vial body 3500. A units of medication contained in a protrusion-created gap of said first inner gear 3600 may move, for example, by gravity through one or more protrusion-created gaps of one or more inner gears 3600 and may move, for example, by gravity, through a medication outlet 3510 of vial body 3500.

For example, an actuating mechanism 40 may include a gear and said gear may engage teeth-like protrusions 3910 in a spur gear 3900 through a gear outlet 3520 of vial body 3500 when said actuating mechanism 40 actuates the dispensing of one or more units of medication. Said actuating mechanism 40 may separately engage one or more spur gears 3900 through one or more gear outlets 3520. For example, a controller 20 in dispensing device 100 may select the spur gear 3900 to engage based on data relating to type of medication contained in an associated vial 30, data relating to an association between an associated vial 30 and its location in a dispensing device 100, and type of unit of medication required to be dispensed, for example, based on data relating to a prescription schedule. In one embodiment, a stud 3920 on spur gear 3900 may engage a corresponding notch on an inner ring 3700 upon complete revolution of spur gear 3900. A spur gear 3900 may move and cause said inner ring 3700 to move. A protrusion of said inner ring 3700 may be or become unaligned with a protrusion-created gap in an inner gear 3600. A protrusion-created gap of said inner gear 3600 may be or become aligned with a pill outlet 3510 in vial body 3500. As said spur gear 3900, said inner ring 3700, and inner gear 3600 continue to move, a stud 3920 on spur gear 3900 may become disengaged from a corresponding notch on an inner ring 3700 and a notch 3720 on inner ring 3700 may become disengaged with a stud 3610 of an inner gear 3600. A pill may be contained in said protrusion-created gap and said pill may move, for example, by gravity, from an inner gear 3600, through zero or more protrusion-created gaps of one or more inner gears 3600, through a protrusion-created gap of spur gear 3900, and through a pill outlet 3510 of vial body 3500. In one embodiment, said pill may move, for example, by gravity, into a holding chamber, an acoustic chamber and/or an exit chamber of dispensing device 100. An actuating mechanism of dispensing device 100 may actuate engagement of teeth-like protrusions 3910 in a spur gear 3900 and may, for example, rotate said teeth-like protrusions 3910 until one or more units of medication are released from a vial 30. A sensor associated with a dispensing device 100 may register the release of one or more units of medication, for example, through medication outlet 3510 in vial body 3500 or upon landing in a holding chamber, an acoustic chamber, and/or an exit chamber, and a controller 20 in a dispensing device 100 may configure the actuating mechanism 40 to cease, for example, cease the rotation of a spur gear 3900. A dispensing device 100 may configure the actuating mechanism 40 to cease the rotation of a spur gear 3900, upon receipt by a processor 210 of data relating to the quantity of units of medication in a vial 30 and/or data relating to the appropriateness of pills contained in a vial 30, for example, data relating to the expiry or recall or that one or more units of medication contained therein are of a type no longer prescribed to the patient associated with said dispensing device 100.

Upon association, for example, installation or insertion, of body 3150 in a dispensing device 100, a covering, for example, tamper evident foil, over one or more pill outlets 3510 may be breached. When a pill is released from the vial 30, a sensor 250 in the dispensing device 100 receives data relating to said release and the dispensing device 100, for example, through a controller 20, may cause the actuating mechanism 40 to cease.

One or more protrusion-created gaps of spur gear 3900 may be filled by one or more units of medication by a pharmacy 180. A cover 3000 may be placed over a concentric wheel 3100 and sealed to prevent unauthorized access. A vial 30 may be associated with a unique identification code, for example, a pharmacy identifier code and/or a serial number. A patient may be associated with a single patient, for example, using a patient's medical card or medical insurance number. Said associations may be stored in memory in a computer at a pharmacy 180.

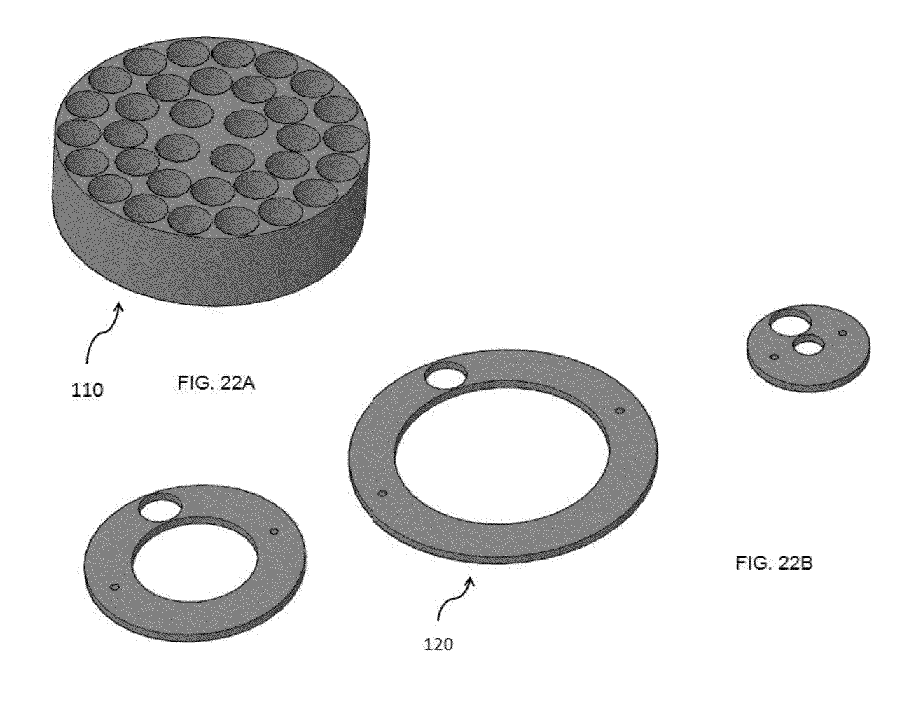

FIG. 22A is a perspective view of a slotted disk 110 in one exemplary embodiment, and FIG. 22B shows three rings 120 to be used with the slotted disk in FIG. 22A in one exemplary embodiment. In one embodiment, vial 30 may be comprised of a pocketed body 110. Said pocketed body 110 may have pockets configured in a concentric ring alignment, with each pocket in a given ring equally spaced apart. Each pocket may be reasonably sized to accommodate one or more units of medication of varying sizes. In one embodiment, each pocket may only contain one unit of medication and may be filled by a pharmacy 180. An actuating mechanism 40 of a dispensing device 100 may engage a release component, for example, a spur gear, installed in a vial 30 that has been associated with said dispensing device 100. Said release component of said vial 30 may actuate the release of one or more units of medication from said vial 30. FIG. 22B shows a view of an example of three ring components that may be installed in a vial 30. Each ring component may have an inner opening bordered by an inner periphery. An outer periphery and inner periphery of each ring component 120 may be of different circumferences. On one face of a ring, there may be a first notch located 180 degrees away from a second notch. Each notch may be located equidistant from the inner periphery and the outer periphery of the same face of said ring component 120. opposite ends of one face of Said release component may actuate the movement of one or more ring components 120. Each ring component may have an outlet of equal size located 90 degrees from a notch. If installed in an embodiment of a vial 30, said rings components 120 may be co-axial. Upon actuation by an actuating mechanism 40 of an associated dispensing device 100, one ring component may move and align with a pocket of pocketed body 110, a pill contained in a pocket of pocketed body 110 may be or become aligned with an outlet of a vial body, and said pill may move, for example, by gravity through said outlet of one or more ring components 120 and through said outlet of a vial body 30. A gear mechanism may be used to move, for example, rotate said ring components 120. When it is not time for one or more units of medication to be dispensed, the ring components 120 are aligned so that its said outlet is not aligned with any pocket in pocketed body 120. Actuation of actuating mechanism 40 of associated dispensing device 100 may be required to move said ring components to allow one of its outlets to become aligned with one pocket in pocketed body 110 to allow the release of an item, for example, a pill in said pockets.

### Processes for Fulfilment and Dispensing of Medication

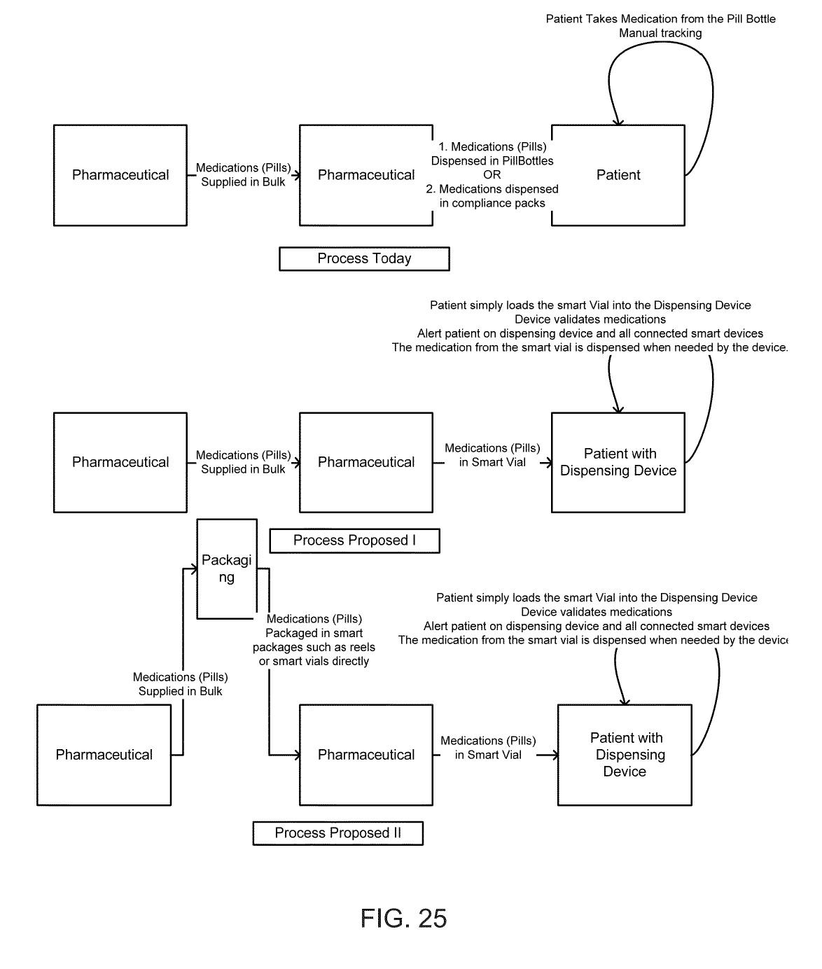

FIG. 25 is a view of an example of a process for production of units of medication, for example, in bulk by a pharmaceutical company, to dispensing of one or more of said units of medication using a dispensing device 100 and/or a vial 30, magazine, and/or compliance package. The pharmaceutical company may also refer to a pharmacy. The pharmacy may dispense the vial 30 with units of medication, for example. Vial 30 may also be referred to as a smart vial.

One or more units of medication may be dispensed, for example, by a pharmacy 180, in the form of, for example, a bottle or a compliance package. A patient may manually track their adherence with their prescription schedule, for example, when to take one or more units of medication, what type of medication to take, and how many of each type of medication to take. In one embodiment, a user may associate, for example, insert a vial 30 and/or magazine, with a dispensing device 100. A dispensing device 100 may validate that data associated with the vial 30 and/or magazine corresponds to data relating to, for example, the patient that the dispensing device 100 is associated with, the time for one or more units of medication to be dispensed according to one or more prescription schedules of said patient, the type of medication that is to be dispensed according to one or more prescription schedules or data about prescribed pill types of said patient, and/or tampering of the vial 30 and/or magazine. In one embodiment, a user may obtain one or more vials 30 and/or magazines from an organization, for example, a pharmaceutical company or manufacturer of units of medication or supplier of units of medication in bulk, and/or a pharmacy 180.

In one embodiment, an organization, for example, a pharmaceutical company, may produce units of medication in bulk. In another example, a pharmacy may package one or more units of medication in one or more vials 30, magazines, compliance packages, and/or strips or reels of units of medication, for example, blister strips, to an organization, for example, a pharmaceutical company, which may in turn dispense one or more vials 30, magazines, compliance packages, and/or strips or reels of units of medication, for example, blister strips, to a user, for example, a patient. For example, the pills dispensed may correspond to the units of medication prescribed for that patient. Vials 30 for dispensing may be packaged at the pharmacy for provision to user to load within device 100. The pharmaceutical organization may create strips or reels of units of medications which may then be cut into the size of dispensable number of units and packaged inside the vial 30 for dispensing by 100. This pre-packaged vial 30 may be dispensed by pharmacy or the cutting and packing may be done by the pharmacy, in some examples. This may enable the number of units of medication in the vial 30 to be changed at the pharmacy. Accordingly, the reference to pharmaceutical in FIG. 25 may refer to a pharmaceutical company and/or a pharmacy, as different entities may perform different operations for different example embodiments.

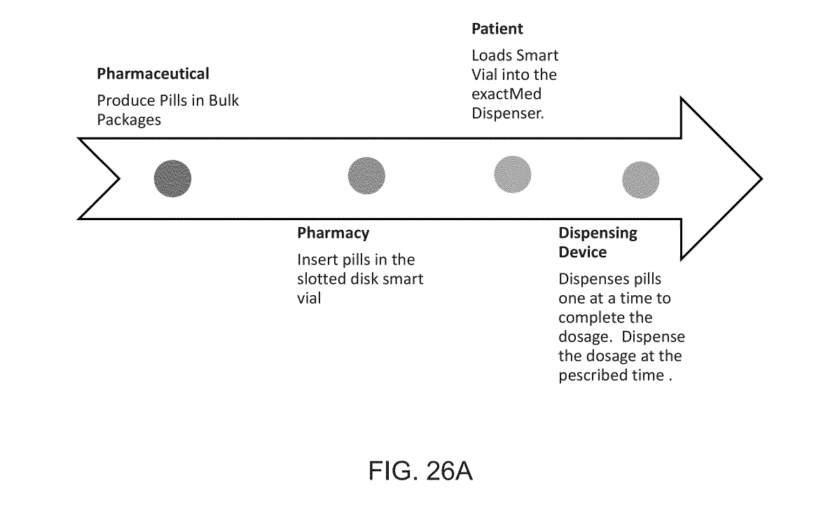

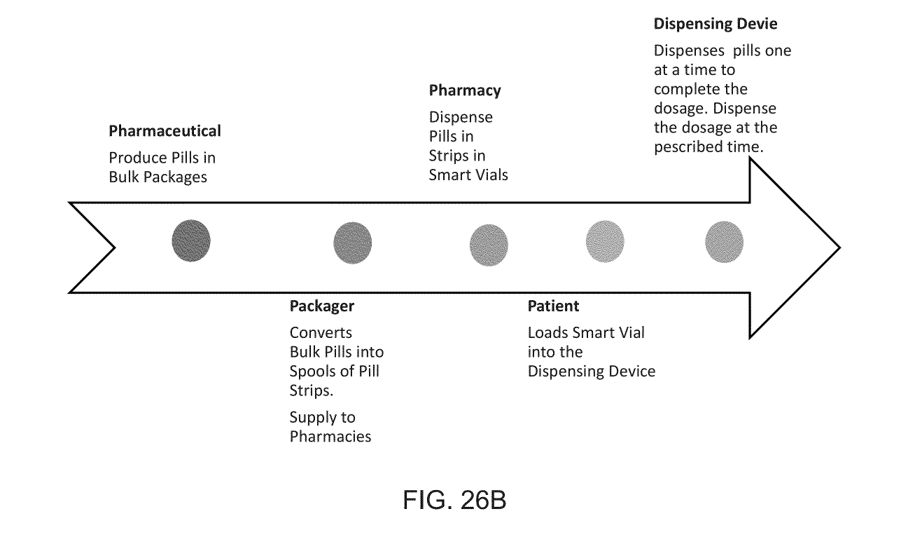

FIG. 26A is an example of a process for production of units of medication for a dispensing device 100. For example, one or more units of medication may be produced in bulk, for example, in bulk packages, by, for example, one or more pharmaceutical companies or pharmacies; one or more pills may be inserted into a vial 30, for example, a slotted disk smart vial 30 or a concentric slotted disk smart vial 30; one or more slotted disk smart vial 30 may be associated with, for example, loaded or inserted, into a dispensing device 100, for example, by a patient; a dispensing device 100 may dispense one or more units of medication at a time according to the dose for said patient and the time for said dose, based on data, for example, relating to a unique identification code associated with said vial 30 and/or magazine, a patient, one or more prescription schedules, pill type, and/or time.

FIG. 26B is an example of a process for production of units of medication for a dispensing device 100. For example, one or more units of medication may be produced in bulk, for example, in bulk packages, by, for example, one or more pharmaceutical companies or pharmacies; a packager may convert the units of medication in bulk to strips of units of medication, for example, spools of units of medication strips. In some examples, a packager may supply said strips of units of medication and/or bulk units of medication to one or more pharmacies; a pharmacy 180 may convert the units of medication in bulk to strips of units of medication, for example, spools of units of medication strips, and/or a pharmacy 180 may dispense units of medication to a user. That is, one or more pharmaceutical companies or pharmacies may convert the spool of strips into the dispensable size for a patient and packages the strips into vial 30.

For example, a patient, in strips in smart one or more vials 30 and/or magazines; a patient may associated, for example, insert or load, a vial 30 and/or magazine into a dispensing device 100; a dispensing device 100 may dispense one or more units of medication at a time according to the dose for said patient and the time for said dose, based on data, for example, relating to a unique identification code associated with said vial 30 and/or magazine, a patient, one or more prescription schedules, unit of medication type, and/or time.

In one embodiment, the process flow for use of a dispensing device 100 using a strip of units of medication may consist of the following steps: packaging, packaging strips, counting, smart vial, security and safety, loading, dispensing, and delivery. The operations may involve packaging bulk medications into spools of strips of units of medication, cut the strips into dispensable quantity of units of medication by counting, package into the cut strips into the vial 30 and tamper proofing, sealing, loading into device 100, dispensing by device 100, and delivering the dosage composed of correct number of units of medication(s). This provides an improved medication delivery system.

In one embodiment, the process may start with pharmaceutical companies that manufacture units of medication. These units of medication may be delivered to pharmacies in bulk packaging, in bottles, in blister packs, and/or containers. The process may start at the packaging stage where units of medication are placed in long strips that are one unit of medication wide. These strips are rolled up in large spools and are supplied to one or more pharmacies. The pharmacies may store these spools on racks. Effectively these spools may replace the bulk packaged medicines that may be previously delivered. These spools may be made at a pharmacy 180 or by a separate business entity that may specialize in packaging units of medication in strips.

One or more strips in which units of medication may be packed may be fashioned like 35 mm photographic film with slots cut along both edges of said strip. Said slots may be used by a corresponding mechanism built into a medication counting device used at a pharmacy 180 to count units of medication for dispensing. A similar mechanism may be built in a vial 30 and may be used by a dispenser to draw one unit of medication out at a time.

While delivering units of medication according to a prescription, a pharmacist may count units of medication and cut them out of a spool. Counting of units of medication may be manual or facilitated or completed using a counting device.

A strip that contains one or more units of medication may then be rolled and placed in a vial 30 and a vial 30 may be sealed using ultrasonic sealing technique. Said vial 30 may then be given a unique identification in the form of an identifier code for a pharmacy 180 and a serial number. Said serial number may be associated to a patient, for example, through a medical card or a medical insurance number.

A sealed vial 30 may then be processed through a machine that may place a heat shrinkable security wrap on said vial 30 or enclose said vial 30 with a heat shrinkable security wrap. The wrap may have a conducting pattern printed on it. The conducting pattern may have one or more specific electrical characteristics. After placing a wrap on a vial 30, an electrical characteristic may be measured and a value may be encoded in a bar code. Said code may be printed on the security wrap.

In another embodiment, data relating to one or more electrical characteristics may be sent over the internet to a corresponding dispenser.

The ultrasonic sealing technique may help prevent access to the units of medication contained in a vial 30 and may help prevent unauthorized access.

A patient or caregiver may then insert a vial 30 into a dispensing device 100. The dispensing device 100 may first read a code relating to the identification of a pharmacy 180 and/or a serial number associated with a patient medical card and/or health insurance number. After identifying the vial 30, a dispenser may check for tampering of said vial 30 by measuring electrical characteristics of a security wrap and may compare said measurement to data encoded in an information area 350, for example in a QR code, barcode, or NRC circuit, associated with the vial 30.

If the data corresponds, the vial 30 may be locked in the dispensing device 100, else it may be ejected from the dispensing device 100. The locking mechanism may cut the security wrap associated with the vial 30.

In another embodiment, data relating to electrical characteristics of the security wrap may be received over a network 150 and may be used to compare with the measured value of the security wrap to determine if the vial 30 has been tampered with.

The dispensing device 100 may engage the vial 30 and may pull one pill at a time from the vial 30. The dispenser may pull one or more units of medication out by rotating a gear mechanism that may engage with a plurality of slots cut on both the edges of the strip.

Once a pill is drawn from a vial 30 a pusher mechanism may be used to push the pill from the strip. The outer clear material of the strip may be ripped and a unit of medication may be made to move, for example, by gravity, in the collection tray below. The empty packaging may be wound around a take-up roller which may be driven by the dispensing device 100.

The units of medication may drop in a collection tray for a patient to collect. Once a vial 30 is empty, it may be ejected from the dispensing device 100.

There may be a process for dispensing units of medication from a dispensing device 100 using a segmented disk embodiment of a vial 30. The process may address the following: slotted disk vial; packaging and counting; sealing and assembly; security and safety; loading; dispensing; and delivery.

### Slotted Disk Vial

In one embodiment, a slotted disk embodiment of a vial 30 consists of a disk with slots formed into it. Each slot stores one pill. The total number of slots formed in the disk will depend on the size of the pill, the size of the disk and the number of units of medication per disk. A number of disk sizes can be made available to accommodate different size and number of units of medication.

The slotted disk 30 is placed in housing in which it can rotate around its axis like a wheel. The housing accommodates up to two disks. These disks are held together in the housing by an axle. The housing has an window formed in one of the side walls and is used for removal of units of medication the disks. In an unused vial 30, this window is sealed closed and the cut lines for the window are made in the housing.

The outer periphery of the slotted disk has a spur gear built in it. This gear engages with a corresponding gear in the dispenser and rotates the slotted disk. To dispense a unit of medication the disk is rotated until a slot in the disk aligns with the opening in the vial housing and at this point, the pill falls out of the slot under gravity.

The cut lines for the window are ripped when the vial 30 is inserted in the dispensing device 100 and the window opens. Once the window is open the vial 30 is ready for dispensing units of medication.

The pills are loaded in the slotted disk at the pharmacy 180. One unit of medication is placed in each slot and then the disk is sealed by a cover using ultrasonic wielding. In a vial 30 containing two disks, each disk is filled and sealed in sequence.

The vial 30 is then given a unique identification in the form of a pharmacy identifier code and a serial number. This serial number is associated to the patient either through a medical card or a medical insurance number.

The sealed vial 30 is then processed through a machine which puts a heat shrinkable security wrap on it. The wrap has a conducting pattern printed on it. The conducting pattern has a specific electrical characteristic. After placing the wrap the electrical characteristics are measured and the measured value is encoded in a bar code. This code is printed on the security wrapper.

In another embodiment, the electrical characteristics data is sent over the internet to the corresponding pill dispenser.

The ultrasonic sealing technique prevents access to the units of medication in the vial 30 and protects against unauthorized access.

The patient or the caregiver then inserts the vial 30 into the dispensing device 100. The dispensing device 100 first reads the pharmacy identification code and the serial number associated with the patient medical card or health insurance number. After identifying the vial 30, the dispensing device 100 checks for tampering by measuring the electrical characteristic of the security wrap and compares this measurement to the value encoded in a bar code.

If the readings match, then the vial 30 is locked in the system, else it is ejected from the dispensing device 100. The locking process cuts the security seal.

Alternatively, electrical characteristic data of the security wrap may be received over the Internet and may be used to compare the measured value of the security wrap to determine if the vial 30 has been tampered with.

An actuating mechanism 40 engages the disk in the vial 30 and rotates it. In an embodiment where a vial 30 contains two disks, each disk is engaged separately by the dispensing mechanism. To dispense one or more units of medication, the disk is rotated until a pill is dispensed through a slot in the disk.

A pill sensor registers the drop and stops the actuating mechanism 40 from rotating the disk any further.

One or more units of medication from the vial 30 drops in a collection tray that is exposed to a user. Once a vial 30 is empty, it is ejected from a dispensing device 100.

There may be a process for dispensing units of medication from a dispensing device 100 using a concentric slotted disk embodiment of a vial 30. The process may address the following: concentric slotted disk vial 30; packaging and counting; sealing and assembly; security and safety; loading; dispensing; and delivery.

### Concentric Slotted Disk Vial

In one embodiment, a concentric slotted disk embodiment of a vial 30 may consist of a number of disks with one or more slots formed into them. Each slot may store one pill. The total number of slots formed in a disk may depend on the size of the pill, the size of the disk, and/or the number of units of medication per disk. All concentric disks in a vial 30 may carry the same type of unit of medication. The inner disk that is closest to the axel or hub has the smallest diameter while the diameter of the outer disks increase progressively as distance from the axel or hub increases. Between each disk there may be a fence with slots cut in it; said fence may be free to move between adjacent disks. The slots of the fence are aligned so that they block the open slots of the inner disk. The purpose of the fence is to keep the pills in their respective slots and disks.

An actuating mechanism 40 of a dispensing device 100 may first dispense all the units of medication stored on the outermost disk, after which the fence between the outermost disk and the next inner disk is moved one slot so that units of medication in the inner disk can move under their own weight from the inner disk to the outer disk and on to the collection tray.

The concentric slotted disks are placed in a housing in which it can rotate around an axis like concentric wheels. The outermost disk may have the largest diameter and may have a spur gear formed on it. Said gear may be used to rotate the disk. The inner circumference of the outermost disk may have a stud formed in it; said stud upon completion of a complete revolution of an outer disk engages a corresponding notch in the fence and moves the fence by one slot. Upon further movement of an outer disk a fence which is engaged with the outer disk may move a stud formed in the inner disk and may rotate the inner disk with the outer disk. In this manner, the units of medication in the inner disk may under their own weight from their location in the inner disk through an open fence and pass through an outer disk into a collection tray.

A housing of a vial 30 may accommodate up to two concentric disks. Said disks may be held together in the housing by an axle. A housing has a window formed in one of the side walls and is used for removal of units of medication the disks. In an unused vial 30, said window is sealed closed and cut lines for the window may be made in the housing.

As discussed above, the outer periphery of the outer slotted disk may have a spur gear built in it. This gear may engage with a corresponding gear in the dispenser and may rotate the outer slotted disk. To dispense a pill, said disk may be rotated until a slot in the disk aligns with the opening in a vial housing and, at this point, a pill may fall out of the slot by gravity.

Cut lines for a window may be ripped when a vial 30 may be inserted in the dispenser and a window opens. Once the window is open, a smart vial 30 may be ready for dispensing units of medication.

Units of medication are put in a slotted disk at a pharmacy 180. One unit of medication may be placed in each slot and then a disk is sealed by a cover using ultrasonic wielding. Each concentric disk may be filled and sealed in the same manner.

A vial 30 is then given a unique identification in the form of a pharmacy identifier code and a serial number. This serial number may be associated to the patient either through a medical card or a medical insurance number.

A sealed vial 30 may then be processed through a machine which may put a heat shrinkable security wrap on it. Said wrap may have a conducting pattern printed on it. Said conducting pattern may have a specific electrical characteristic. After placing a wrap, said electrical characteristic may be measured and a value is encoded in a bar code. Said code may printed on the security wrapper.

In another embodiment, the electrical characteristics information may be sent over the Internet to the corresponding dispensing device 100. The ultrasonic sealing technique may prevent access to the units of medication in a vial 30 and may protect against unauthorized access.

A patient or a caregiver may then insert a vial 30 into the a dispensing device 100. Said dispensing device 100 first may read a pharmacy identification code and a serial number associated with the patient medical card or health insurance number. After identifying said vial 30, said dispensing device 100 may check for tampering by measuring the electrical characteristic of the security wrap and may compare this measurement value to that encoded in a barcode. This may be referred to as validation of the vial 20. There may be validation of link between the device 100, the patient and the vial(s) 30 loaded into the device 100.

If said readings match, then the vial 30 may be locked in the system else it may be ejected from the dispensing device 100. The locking process may cut the security seal.

Alternatively, electrical characteristic data of the security wrap may be received over the Internet and may be used to compare the measured value of the security wrap to determine if the vial 30 has been tampered with.

An actuating mechanism may engage the outer most disks in a concentric disk vial 30 and rotate it. To dispense one or more units of medication from one or more said disks, one or more disks may be rotated until a pill is dispensed from a slot in the disk and may fall under its own weight into a collection tray.

To dispense pill in the inner disks the outer disk has to first dispense all units of medication. This may be done by rotating the outer disk by 360 degrees or by one complete revolution. Upon completing the revolution the outer disk may engage with the fence between itself and the inner disk. This fence may be moved one slot in the direction of rotation of the outer disk. After moving one slot, the fence may engage the inner disk. Now when the outer disk is rotated by the dispenser the fence and the inner disk may also rotate.

The units of medication in the inner disk may now move under their weight and as the fence may no longer block their movement, they may from the inner disk through the fence and into the outer disk where they may be dispensed into a collection tray.

A medication sensor may register the drop and may stop the dispensing mechanism from rotating the disk any further.

One or more units of medication from the vial 30 may into a collection tray for a patient to collect. Once a vial 30 is empty, it may be ejected from a dispensing device 100.

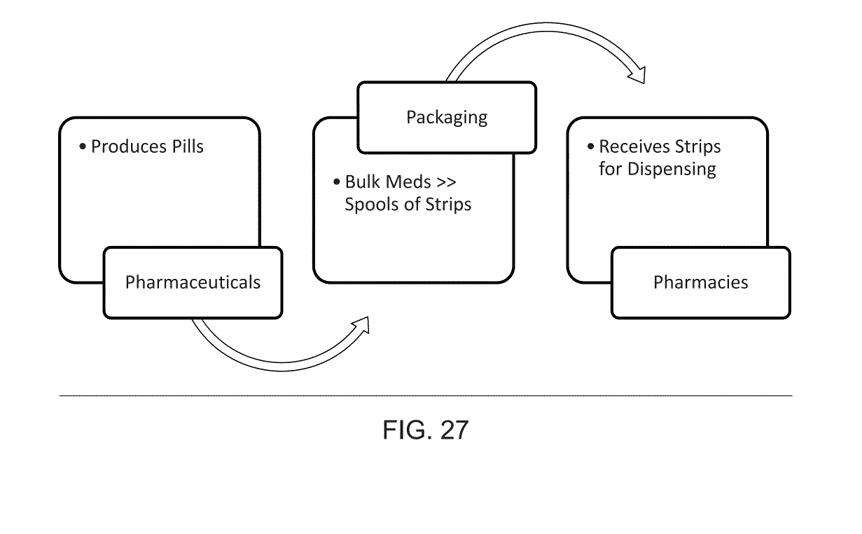

FIG. 27 is an example of a process for production of units of medication for dispensing at a pharmacy 180. For example, one or more units of medication may be produced by, for example, one or more pharmaceutical companies; units of medication in bulk may be packaged into spools of strips; and one or more strips may be dispensed, for example, received by and dispensed by one or more pharmacies.

In one embodiment, a feature of a dispensing device 100 may store a plurality of units of medication. For example, a dispensing device 100 may have the capacity to be associated with a plurality of smart vials 30. For example, a dispensing device 100 may have the ability to dispense medication from more than one associated vials 30 to form a dosage. For example, a dispensing device 100 may record adherence data and facilitate record management for more than one type of pill and/or medications.

In one embodiment, a vial 30, dispensing device 100, and/or its components may be of a size that may allow the accommodation of a plurality, for example, eight, vials 30 to be associated with, for example, inserted into, a dispensing device 100. In one embodiment, a vial 30, dispensing device 100, and/or its components may be of a design and/or size that optimizes a capacity to store items, for example, units of medication or medication. In one embodiment, a vial 30, dispensing device 100, and/or its components may be of a design and/or size to accommodate any size and/or shape of item, for example, units of medication or medication.

In one embodiment, a vial 30, dispensing device 100, and/or its components may be configured to carry one or more items, for example, units of medication and/or medication, such that each type and unit of said item may be dispensed reliably and/or individually.

In one embodiment, a vial 30 may be labelled to store data that relates to one or more types of items, for example, pills and/or medication. In one embodiment, a dispensing device 100 and its components, for example, a sensor 250, controller 20 and/or memory 220, may be able to, in relation to one or more types of items, for example, units of medication and/or vials 30, receive, read, transmit, store, process and/or associate with other data, for example, one or more prescription schedules; patient information, for example, relating to identification of a patient; time; one or more identification codes, for example, uniquely identifying a dispensing device 100 or a vial 30; medication or prescription information; one or more requests for the production of one or more compliance packages; and/or one or more tamper evident foil measurements.

In one embodiment, a dispensing device 100 may have one or more compartments that may be associated with a vial 30, for example, an inlet that may receive a vial 30. In one embodiment, a dispensing device 100 may be configured to process one or more vials 30, for example, validate; receive data relating to tamper evident foil; actuate; and/or configure an actuating mechanism 40 to dispense one or more units of medication from said vial 30. A dispensing device 100 may be configured to simultaneously process more than one vial 30, for example, configure an actuating mechanism 40 to dispense one or more pills from said vial 30. Said vial 30 may contain a pill type that corresponds to a type of unit of medication prescribed for a patient that said dispensing device 100 may be associated with.

In one embodiment, the system 10, for example, comprising one or more dispensing devices 100, vials 30, network 150, patient device 800, remote computer, data store 900, other user device 600, pharmacy 180, health care providers 300, and/or insurance 500, may be configured to manage user profiles with one or more types of units of medication, dosages of medication, and/or prescription schedules.

In one embodiment, a dispensing device 100 may be configured to accept a particular embodiment of a vial 30. For example, a dispensing device 100 may be configured to accommodate one or more vials 30 of a slotted disk vial design and/or a concentric slotted disk vial design. A dispensing device 100 may accommodate one or more types of units of medication in vials 30. A dispensing device 100 may ensure that a correct vial 30 is inserted into said dispensing device 100, for example, by comparing data relating to patient, pharmacy 180, and/or dispensing device identification; prescription schedule; type of units of medication; medication information; and/or tamper evident foil measurements. A dispensing device 100 may not accept a vial 30 that may have been tampered with. An actuating mechanism 40 may actuate the dispensing of the right medication at the right time, according to, for example, a prescription schedule corresponding to a patient that said dispensing device 100 is associated with, and said dispensing device 100 may record a collection time of said medication by, for example, a patient upon retrieval of one or more units of medication from an exit chamber associated with said dispensing device 100. A dispensing device 100, for example, via transfer of data using a controller 20, may alert one or more users, for example, a patient, client, or caregiver. An actuating mechanism 40 of a dispensing device 100 may actuate the dispensing of one or more units of medication individually and may collect said units of medication in a collection tray located, for example, in an exit chamber. Said dispensed units of medication may together form a prescription, for example, comprise one or more types of pills and/or multiple units of medication of a single type that together comprise a dose for a particular medication. A controller 20 in a dispensing device 100 may receive data relating to a prescription and data relating to a time that said prescription is to be taken by a patient. A controller 20 may be configured to actuate an actuating mechanism 40 and said actuating mechanism 40 may actuate the release or dispensing of one or more pills according to a type of units of medication prescribed for a patient and a time that said pill is to be taken by said patient associated with a dispensing device 100. A dispensing device 100 may have features including, for example, an ability to validate that a correct vial 30 is inserted in the dispensing device 100; check for tampering of a vial 30; validate contents of a vial 30 against a prescription; validate a number of units of medication in a vial 30 against a label printed on a vial 30; store and maintain a prescription and accept updates for example, to a prescription, from a physician; send out alerts at a prescribed time; dispense one pill at a time as per a prescription in an error proof manner when instructed by a client; make a dose on the fly and present a dose to a client; withdraw a dose if it is not retrieved within a predetermined time; store withdrawn units of medication in a secure and lockable container; connect to the Internet, for example, using Wi-Fi technology; connect to smart devices over Bluetooth technology; connect to mobile data networks; connect to a backend and updates dose or dosage collection data; and send out one or more alerts in the case of loss of main power supply and/or a low back-up power supply. A dispensing device 100 may have a back-up power supply.

In one embodiment, a vial 30 may be secure from tampering and in a safe container of medication, for example, UV, in accordance with established regulations. A dispensing device 100 may be able to check for tampering and act accordingly, may validate the vial to a user, and may be connected to a system 10 that facilitates validation through a network 150.

In one embodiment, a vial 30 and a dispensing device 100 may be child proof.

In one embodiment, system 10 may facilitate the traceability of one or more units of medication until said units of medication are dispensed from a vial 30 by a dispensing device 100.

In one embodiment, a vial 30 may be traceable and be configured to be tracked in situations where said vial 30 is lost, tampered, expired, cancelled, and/or recalled medication. For example, system 10 may be able to track a vial 30 that did not make to the destination device or did not make it untampered or expired before being associated with a dispensing device 100.

In one embodiment, a system 10 may be able to track data relating to medications, prescriptions, and/or dispensing data.

In one embodiment, a system 10 and/or a processor in a computer, for example, in a dispensing device 100, vial 30, or pharmacy 180 may be able to issue alerts and/or notifications relating to time for medication intake, intake of medication from a compliance package, refills, expiry of one or more units of medication, recalls, and/or changes in regimen. For example, a dispensing device 100 and/or other user devices 600 may be able to issue audio and/or visual alerts.

In one embodiment, a dispensing device 100 may dispense medication to form a dose composed of one or more units of one or more medications from one or more vials.

In one embodiment, a dispensing device 100 may dispense medication at the prescribed time based on data such as prescription data or time that the last mediation was dispensed.

In one embodiment, a dispensing device 100 may not dispense medications from a vial that has expired.

In one embodiment, a dispensing device 100 may alter the dosage, frequency, and time based on real-time changes to the prescription by a competent authority.

In one embodiment, a system 10 may facilitate alterations to a prescription regimen.

In one embodiment, a dispensing device 100 may be configured not to dispense recalled medication.

In one embodiment, a system 10 may communicate data relating to recalled medication over a network 150.

In one embodiment, a system 10 may allow prescription refill requests.

In one embodiment, a dispensing device may validate a vial 30 to the user by matching prescription and user data in offline and online modes.

In one embodiment, features of system 10 may include a patients portal, a community of care network, alerts to a community of care network where a dispensing device 100 initiates alerts to said community of care over a network pertaining to adherence data. In one embodiment, features of system 10 may include data relating to one or more prescriptions, data relating to adherence, an ability to report data pertaining to adherence, an ability to perform analytics on said adherence data, a vial 30 and/or a dispensing device 100 that is mobile or portable, an ability to produce compliance packages on the fly, a hub for connection of other health devices, and have audio and/or visual capabilities. A system 10 may enhance operational efficiency of one or more pharmacies 180 and may act as a supervisor of medication dispensing. A vial 10 may improve medication traceability and security of patient data and may enhance medication adherence. A system 10 may improve transportability of medication, provide for end to end traceability of medication from a pharmacy 180 to a patient, increase transportability, help ensure patient security, facilitate medication adherence, provide for efficiency and automation of dispensing, and provide for a system that has improved usability.

In one embodiment, a dispensing device 100 may be configured to accommodate one or more embodiments of a vial 30 that use a slotted disk and/or concentric slotted disk design.

### Pharmacy and Manufacturing Process

In one embodiment, there may be a process for producing one or more vials 30 or magazines. For example, a vial 30 or magazine may be filled at a pharmacy 180 and labeled. A vial 30 or magazine may be inserted in an inlet in a dispensing device 100, where a vial 30 or magazine may only be accepted after the label is read and compared with prescription data sent to the dispenser directly from the pharmacy 180.

Units of medication may be received in bulk, bulk packaging, bottles, blister packages, and/or containers from one or more organizations, for example, pill manufacturers or pharmaceutical companies.

The packaging of units of medication into units of medication into bulk reels may be performed by a pharmacy 180 or by a third party organization, for example, a company certified to handle medicines. In the latter case, for example, one or more bulk reels may be transported to a pharmacy 180 where one or more bulk reels may be loaded into a strip dispensing machine that may have a counting and/or cutting mechanism.

When one or more bulk reels are loaded on or into the dispensing machine, the number of units of medication that may be requested for dispensing may be received via a keyboard. The units of medication may be automatically dispensed by the strip dispensing machine. For example, the strip dispensing machine may count and cut the bulk reels at the desired length. The strip dispensing machine may be associated with local memory that enables the production, for example, printing, of one or more labels that may contain data, for example, a QR code or a barcode containing data, for example, relating to one or more tamper evident foil measurements; one or more prescription schedules; time; one or more types of units of medication, for example, pill types that a patient has been prescribed; patient data, for example, relating to identification of a patient for whom units of medication are associated or prescribed; one or more identification codes, for example, uniquely identifying a dispensing device 100, vial 30, magazine, and/or pharmacy 180; and/or medication data.

### Bulk Filled Strips of Units of Medication

A bulk reel and/or blister strip may be placed in a container, for example, a vial 30 or a magazine or a container, for example, vial 30, in a magazine. A vial 30 or magazine may be configured to store data in an information label area, which may contain data stored in a format such as a QR code, a bar code, or an NRC circuit. In another embodiment, a vial 30 or magazine may store data in local memory in the vial 30 or magazine. In one embodiment, the data may correspond to one or more tamper evident foil measurements; one or more prescription schedules; time; one or more types of units of medication, for example, a type of medication that the vial 30 or magazine may contain; patient data, for example, relating to identification of a patient for whom units of medication are associated or prescribed; one or more identification codes, for example, uniquely identifying a dispensing device 100, vial 30, magazine, and/or pharmacy 180; and/or medication data. In one embodiment, a vial 30 or magazine may be configured to store data before the vial 30 or magazine is given to a patient.

In one embodiment, a patient may load a vial 30 or a magazine in a dispensing device 100 and the vial 30 or magazine may only be accepted after the label is read by a sensor associated with the dispensing device 100 and compared with prescription data stored in local memory in the dispenser or transmitted to the dispenser from a remote computer, for example, a computer at a pharmacy 180 or central server connected to network 150 and storing data in data store 900.

In one embodiment, one or more units of medication may be packaged in strips in bulk reels, for example, of blister strips. In one embodiment, a bulk reel may be made by a bulk reel packing machine or manually by a user, for example, a pharmacist. For example, a bulk reel packing machine may orientate one or more units of medication in a single column in one or more pockets in the blister strip. Each pocket may be reasonably sized to accommodate one or more units of medication of different sizes. In one embodiment, each pocket may contain only one unit of medication. In one embodiment, the pockets may be sealed, for example, by paper or by foil. In one embodiment, the blister strips may have a standardized width and spacing between the units of medication and/or pockets. For example, a blister reel may contain units of medication equally spaced apart and in pockets, with only one pocket at any given cross-sectional axis that is perpendicular to the periphery of an unwound blister reel that, when wound, has a periphery that extends along the circumference of the blister reel. In one embodiment, a bulk reel packing machine may be configured to take and/or process bulk packaged units of medication and to produce single strip blister reels, for example, with paper or foil backing. In one embodiment, the bulk reel packing machine may have a hopper through which bulk packaged units of medication are loaded in the bulk reel packing machine. A filled strip of units of medication may be sealed, for example, heat sealed, between material, for example, between clear plastic and paper. A pocket in a blister reel may be produced by sealing units of medication between material where each pill is an equal distance apart. The units of medication may then be automatically filled in blister strips and the strip may be wound on reels. A label may be printed that states medicine data along with the number of units of medication in the bulk reel. A pharmacy 180 may store blister reels or spools on racks. The blister reels may replace the form that the units of medication were delivered in to the pharmacy 180. The production of blister reels or spools may be performed by a pharmacy 180 or by another organization, for example, a separate business entity which may specialize in packaging units of medication in strips.

In one embodiment, a strip dispensing machine may be an intelligent machine that automatically counts and dispenses units of medication, for example, in the form of a blister strip. In one embodiment, a strip dispensing machine may be configured to take and/or process strip blister reels and to produce one or more single strip blisters. A strip dispensing machine may record, for example, in local memory, data relating to one or more or all units of medication or doses dispensed by the strip dispensing machine or data relating to one or more or all requests received by the strip dispensing machine, including, for example, the date and time of request or dispensing, data relating to a user, for example, the identification of a pharmacist, one or more tamper evident foil measurements; one or more prescription schedules; time; one or more types of units of medication, for example, a pill type that the request or dispensing may relate to; patient data, for example, relating to identification of a patient for whom the request or dispensing may relate to; one or more identification codes, for example, uniquely identifying a dispensing device 100, vial 30, magazine, and/or pharmacy 180; and/or medication data.

In another embodiment, a user, for example, a pharmacist, may count and separate strips of units of medication, for example, blister strips.

A magazine 5000 may carry, hold, or be associated with one or more vials 30 and/or one or more strips, for example, one or more blister strips that may contain one or more units of medication and/or may have been produced by a strip dispensing machine.

In one embodiment, a vial 30 or magazine may transfer to or receive data from a remote computer, for example, a server, a personal computing device, or a computer at a pharmacy 180; a dispensing device 100; or a compliance pack over a network 150. In one embodiment, a vial 30 or magazine may store data, for example, in local memory, a QR code, a bar code, or an NRC circuit. A vial 30 or magazine may have a mechanism, for example, GPS capabilities, to enable its tracking, for example, by a pharmacy 180.

### Tamper Evidence Foil

In one embodiment, the vial 30 or magazine may be associated with machine-readable tamper evident foil and its characteristics, for example, electrical characteristics such as resistance and capacitance, may be measured, for example, by the tamper evident foil sealing machine, and stored and/or transferred to a remote computer. In one embodiment, the tamper evident foil measurement(s) may be processed by a computer, an output produced, and the output stored and/or transferred to a remote computer. In one embodiment, the tamper evident foil may be heat shrunk, for example, on a part of or on the entire body of, the vial 30 or magazine 5000.

In one embodiment, the data corresponding to tamper evident foil measurement(s) may be stored in local memory associated with the vial 30 or magazine. In one embodiment, the data corresponding to the tamper evident foil measurement(s) may be printed on the security foil, vial 30, and/or magazine. In another embodiment, the data corresponding to the tamper evident foil measurement(s) may be stored in a NFC circuit. In another embodiment, the data corresponding to the tamper evident foil measurement(s) may be stored in a label such as a QR code or a bar code. In another embodiment, the data corresponding to the tamper evident foil measurement(s) may be stored in local memory associated with the vial 30 or magazine. For example, a tamper evident foil sealing machine may transfer data relating to one or more tamper evident foil measurements to a vial 30 and/or magazine, and a controller associated with the vial 30 and/or magazine may actuate the storage of data in local memory associated with the vial 30 and/or magazine. In one embodiment, a controller in a vial 30 and/or magazine may transfer data relating to a tamper evident foil measurement to a remote computer.

In one embodiment, data corresponding to a measurement of tamper evident foil may be associated with a vial 30 or magazine 5000, for example, a vial's or magazine's unique identifier code.

For example, a controller in a tamper evident foil sealing machine may process, store and/or transfer data or processed data to a dispensing device 100 and/or to a remote computer, for example, a computer at a pharmacy 180. In one embodiment, a controller in a tamper evident foil sealing machine, dispensing device 100, and/or remote computer may store the data or processed data in memory and/or associate the data or processed data with data relating to a vial 30, magazine, and/or patient, for example, a unique identification number for a vial 30 and/or magazine or a patient identifier. For example, an association and/or an algorithm to produce an association between the pieces of data may be stored in memory.

In one embodiment, a solution is provided against tampering by making tampering evident and machine readable. The purpose of presenting this solution is to have a tamper evident sealing system for the vial 30 or magazine 5000. This tamper evident solution would be machine readable and in case of tampering of the vial 30, the dispensing device 100 would detect tampering and would not accept the vial 30.

The machine readable tamper evident sealing foil may be printed with conducting ink with electric characteristics. These characteristics may be measurable by the sealer and the dispensing device 100.

After the vial is filled with the medication it may be sealed and tamper evident foil can be heat shrunk on it. The electrical characteristics such as resistance and capacitance of the heat shrink foil would then be measured and would record it against the vial identification number. This information may be then communicated to the dispensing device 100 registered against the patient whose prescription is being embedded in the vial 30.

The communication measure electrical values of the security foil can be done in one of the following manner.

The measured value can be coded and then printed on the security foil so that they may be verified by the dispensing device 100.

The measured electrical characteristic value can be sent over the internet to the corresponding dispensing device 100 for verification.

An RFID tag attached to the vial 30 can record this information (e.g. information area label 350) and the RFID reader on the dispensing device 100 can read and verify the value of the electrical characteristics of the security wrap.

In case of tampering such as cutting of the security wrap to access the medicines inside the vial, or even replacement of the security wrap may be detected as the electrical characteristics of the wrap would different than those registered against the identification number of the vial 30.

When the vial 30 is inserted in the dispensing device 100, the dispensing device 100 would read the serial number and compare the characteristics measured by the dispensing device 100 to those recorded by the measurement device at the pharmacy. If these characteristics match then the vial would be accepted by the dispensing device 100, otherwise the vial would be rejected.

This solution provides benefits such as: the unique identification of the vial 30 ensures that only the correct vial is inserted in the dispensing device 100; the measurement, recording and comparison of the electrical characteristics of the shrink wrap ensure that the medicines from any vial that has been tampered would not be used; the unique identification number maintains traceability of the both the vial 30 and the medicines stored in the vial.

### Exit Chamber or Pick-Up Tray

In one embodiment, an actuating mechanism 40 associated with a dispensing device 100 may actuate the dispensing of one or more units of medication. For example, an actuating mechanism 40 associated with a dispensing device 100 may actuate the release of one or more units of medication from a vial 30, a magazine, a holding chamber, and/or an acoustic chamber. Actuation of the release of one or more units of medication from a vial 30 or a magazine may be one at a time. One or more units of medication may pass through one or more chambers, for example, a holding chamber and/or an acoustic chamber, and then land in an exit chamber, which may include, for example, a collection tray. In one embodiment, an actuating mechanism 40 associated with a dispensing device 100 may successively actuate the release of one or more units of medication from a vial 30 and/or magazine into a holding chamber, from a holding chamber into an acoustic chamber, from an acoustic chamber into an exit chamber, for example, into an exit tray component associated with an exit chamber. For example, upon actuation of said release, one or more units of medication may move, for example, by gravity, into the chamber, for example, holding chamber, acoustic chamber, and/or exit chamber, into which same has been released.

In one embodiment, a dispensing device 100 may have a haptic activator component. In one embodiment, a controller 20 in a dispensing device 100 may receive, store, and/or transmit data, for example, relating to adherence, for example, data relating to actuation of a haptic activator, actuation of an actuating mechanism 40 associated with the dispensing device 100, exposure of one or more dispensed units of medication to a user, retrieval of one or more units of medication from the dispensing device 100, actuation of an alert, and/or receipt of an alert, such as a signal conveying receipt of data and/or a user-generated indication received, processed, and/or transmitted from a remote computer to the dispensing device 100.

Haptic activator is used to initiate dispensing mechanism, but only at correct time; Haptic activator may also used to retrieve the dispensed units of medication. For example, a dispensing device 100 may have a haptic activator. Actuation of said haptic activator, for example, by flipping or pushing a component, may actuate the actuating mechanism 40 associated with the dispensing device 100, for example, directly or through actuation of a controller 20 associated with the dispensing device 100. In one embodiment, the haptic activator may not be actuated until it is time for dispensing one or more units of medication, according to, for example, data relating to one or more prescription schedules, a time keeping mechanism associated with the dispensing device 100, and/or a signal or data from a controller in a computer, for example, a computer at a pharmacy 180, personal computing device, vial 30, and/or magazine. For example, when it is time to dispense one or more units of medication, a controller 20 associated with the dispensing device 100 may actuate an alert, for example, a display on the user interface component, an alarm, and/or a component that may be illuminated, for example, a haptic activator component. A controller 20 associated with the dispensing device 100 may actuate the transfer of data, for example, relating to an alert, to one or more remote computers, for example, a computer at a pharmacy 180 and/or personal computing device belonging to a patient and/or a caregiver. The haptic activator may be used to actuate the exposure of one or more dispensed units of medication to a user, for example, by unlocking a lid of an exit tray component associated with an exit chamber. In one embodiment, a controller 20 associated with the dispensing device 100 may actuate an alert, for example, a display on the user interface component, an alarm, and/or a component that may be illuminated. For example, this alert may indicate that the patient may retrieve one or more units of medication from the dispensing device 100, for example, an exit tray or exit chamber associated with the dispensing device 100.

Dispensing mechanism is initiated automatically at the correct time and haptic activator is only used to retrieve the dispensed units of medication: In another embodiment, an actuating mechanism 40 associated with the dispensing device 100 may actuate the dispensing of one or more units of medication at the time for the dispensing of same, without need for actuation by the haptic activator, and the haptic activator may be used to actuate the exposure of one or more dispensed units of medication to a user.

In one embodiment, the dispensing device 100 may pick up a pill from the holding chamber. The mechanism used to pick up a pill may be lowered by the dispensing device 100 into the holding chamber. In another embodiment, the dispensing device 100 may have an inlet for a container, for example, a pill bottle, to be associated with the dispensing device 100, for example, it may be inserted into the dispensing device 100. The mechanism used to pick up a pill may be lowered by the dispensing device 100 into the container to pick up a pill. In some embodiment, the mechanism may be used successively to pick up more than one pill. For example, the dispensing device 100 may use the mechanism to successively pick up units of medication to build a dose to be dispensed at the same time and that contains an amount of medication equal to the amount of medication prescribed for the patient that the dispensing device 100 is associated with to be taken at that time. The dispensing device 100 may move the mechanism over a chamber and pill may be released. In one embodiment, the chamber may be an acoustic chamber. In another embodiment, the chamber may be an exit chamber.

In one embodiment, the mechanism used to pick up a pill may take the form of a picker that includes a cone shaped structure. For example, this may allow units of medication ranging from 3 mm to 30 mm in size to be picked up. The picker may have a flexible tube attached to the narrower end of the cone shaped structure and the tube may be connected to a vacuum pump. The vacuum pump may generate a vacuum. In one embodiment, the cone picker may be lowered into the holding chamber or container, the picker that includes a cone shaped structure may sense its location in the holding chamber, for example, by recognizing a corresponding sensor, transmitter, label, circuit, or magnet associated with the holding chamber or container, and the vacuum pump may be switched on and may suck in one or more units of medication. The vacuum pump may progressively increase the vacuum generated until the picker that includes a cone shaped structure senses an obstruction in its cone shaped structure or until a maximum pressure is reached. At that time, the vacuum pump may cease generation of the vacuum. For example, the maximum pressure may be specified by the dispensing machine, for example, in its local memory or as transferred from a remote computer. For example, the pressure specified may be one beyond which the mechanism may become unsafe. One or more units of medication may be held in the cone shaped structure by the picker that includes a cone shaped structure and the picker that includes a cone shaped structure may sense the obstruction and may cease generation of a vacuum. A single pill may be lodged near the tapered end of the cone shaped structure and any other units of medication may move, for example, by gravity, into the holding chamber or container. If no units of medication are lodged in the cone shaped structure at the time the generation of the vacuum is ceased, the picker that includes a cone shaped structure may sense that no units of medication are lodged, transmit a signal to the dispensing device 100, and the dispensing device 100 may store, transmit, and/or display data relating to the receipt of the signal. If a pill is lodged in the cone shaped structure at the time the generation of the vacuum is ceased, the dispensing device 100 may lift the picker containing the cone shaped structure and move it over a chamber. In one embodiment, the chamber may be an acoustic chamber. In another embodiment, the chamber may be an exit chamber. In one embodiment, the dispensing device 100 or picker may sense its location, for example, by recognizing a corresponding sensor, transmitter, label, circuit, or magnet associated with the exit chamber or container, and a mechanical release mechanism may then expand a part of the wall of the cone shaped structure and the lodged pill may be released into the exit chamber. In one embodiment, the chamber may be an acoustic chamber. In another embodiment, the chamber may be an exit chamber.

### Vacuum Picker

In one embodiment, the mechanism used to pick up a pill may take the form of a vacuum implement. For example, the vacuum implement may be configured to pick up units of medication from 1 mm to 25 mm in size. The vacuum pump may generate a vacuum. In one embodiment, the vacuum implement may be lowered into the holding chamber or container, the vacuum implement may sense its location in the holding chamber, for example, by recognizing a corresponding sensor, transmitter, label, circuit, or magnet associated with the holding chamber or container, and the vacuum pump may be switched on and may suck in one or more units of medication. The vacuum pump may progressively increase the vacuum generated until the vacuum implement senses an obstruction in the vacuum implement or until a maximum pressure is reached. For example, the maximum pressure may be specified by the dispensing machine, for example, in its local memory or as transferred from a remote computer. For example, the pressure specified may be one beyond which the mechanism may become unsafe. One pill may be held by the vacuum generated by the vacuum implement and the vacuum implement may sense the obstruction. If no units of medication are lodged in the vacuum implement at the time the maximum pressure is reached, the vacuum implement may sense that no units of medication are lodged, the vacuum implement may cease generation of the vacuum, and the vacuum implement may transmit a signal to the dispensing device 100, and the dispensing device 100 may store, transmit, and/or display data relating to the receipt of the signal. If a pill is lodged in the vacuum implement, the dispensing device 100 may lift the vacuum implement and move it over a chamber. In one embodiment, the chamber may be an acoustic chamber. In another embodiment, the chamber may be an exit chamber. The dispensing device 100 or vacuum implement may sense its location, for example, by recognizing a corresponding sensor, transmitter, label, circuit, or magnet associated with the chamber or container, the vacuum implement may then cease generation of the vacuum [and the pill may move, for example, by gravity, into a chamber. In one embodiment, the chamber may be an acoustic chamber. In another embodiment, the chamber may be an exit chamber.

### Gravity Picker

In one embodiment, a mechanism used to pick up a pill may comprise a picker mechanism, a carousal of containers that hold various units of medication, a mechanism to drop one or more units of medication from a container into a picker, a mechanism to return one or more units of medication back to said container, a mechanism to eject a pill from a throat of a picker to an identification tray, and a mechanism to deliver a pill to either a collection tray or said container based on results of its identification. In one embodiment, said picker mechanism may take the form of a funnel-shaped device. Said funnel-shaped device may be made of appropriate material for durability, such as medical grade silicon and/or rubber.

The dispensing device 100 may position, for example, align, the funnel-shaped device with a holding chamber, for example, by moving a carousal of pill containers associated with said dispensing device 100, and upon actuation by the dispensing device 100 of the release of one or more units of medication from the holding chamber, the dispensing device 100 may open a portion of side of the holding chamber that is parallel to the opening of the funnel-shaped device, and one or more units of medication may move, for example, by gravity, from the holding chamber into the funnel-shaped device, and one pill may become lodged near the tapered end of the funnel-shaped device. The rest of the units of medication that may be contained in the funnel-shaped device but that did not become lodged may be returned to a holding chamber, for example, by movement using a sweeping mechanism in the direction of said holding chamber. In another embodiment, the dispensing device 100 may invert the funnel-shaped device to return, by gravity, the units of medication that are not lodged to the holding chamber. In one embodiment, a pill lodged near a tapered portion of said funnel-shaped device may be moved to a chamber, for example, an acoustic recognition chamber and/or an identification tray, for example, by a mechanical expansion of the diameter of said funnel-shaped device. In said acoustic recognition chamber and/or identification tray, the quantity and/or type of pill may be detected and data, for example, relating to quantity and/or type may be transferred to a processor 210 in a dispensing device 100, where verification with data relating to same in one or more prescription schedules may be performed. For example, if the number and/or type of units of medication correspond to that prescribed according to, for example, data in a prescription schedule, a processor 210 may be configured to move one or more units of medication in said identification tray to a collection tray, else move said units of medication to said holding chamber. In one embodiment, a pill contained in an identification tray may be moved either to a collection tray located, for example, in an exit chamber, or be returned to said holding chamber. In one embodiment, said movement may be accomplished by a mechanism that actuates the tilting of said identification tray to such that said tray may form an incline sloped towards either said collection tray or towards said holding chamber. In one embodiment, said movement may be accomplished, for example, using a pusher mechanism that sweeps said pill through a trap door.

In any embodiment, any mechanism may comprise mechanical parts, electromechanical parts, and control electronics.

The picking mechanism may provide for multiple units of medication to be dispensed at once, for one or more units of medication of different types to be dispensed at once, and/or for one or more units of medication of different sizes to be dispensed at once.

In one embodiment, there may be one or more mechanisms that may provide verification that dispensed units of medication match the medication prescribed to be taken at that time. For example, there may be a mechanism to capture one or more pictures of a portion of or the entire exit chamber, for example, the collection tray. A picture taken may be received by and/or stored in the dispensing device 100, and/or transferred to a remote computer, for example, a server.

### Alternative Embodiment of Dispensing Device 100

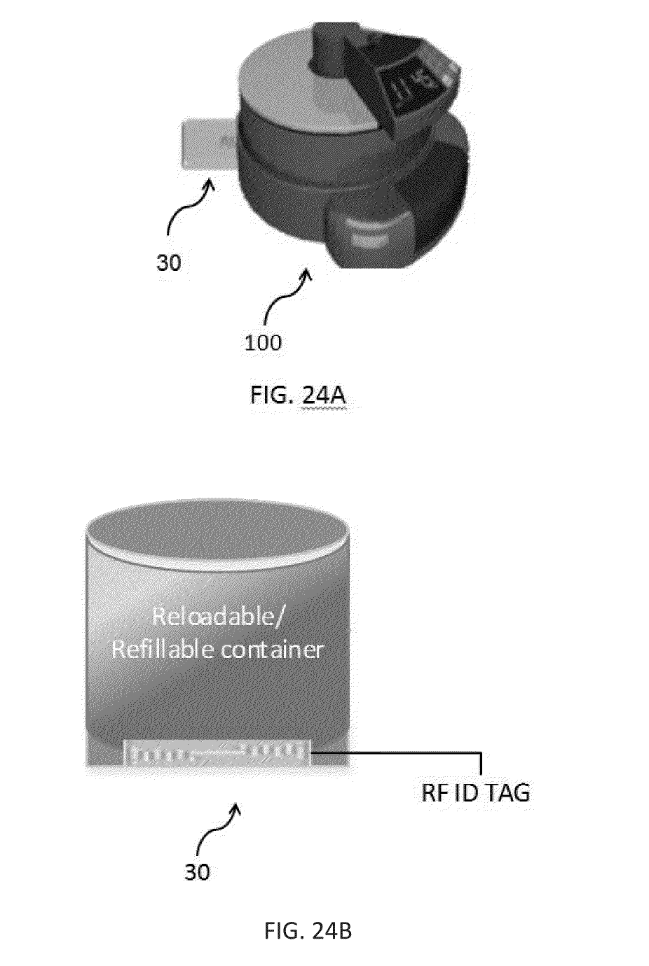

FIG. 24A is another example embodiment of a dispensing device 100 with vial 30. A dispensing device 100 may be associated with a unique code. This may help with uniquely identifying the dispensing device 100. A unique code may be generated by a manufacturer of the dispensing device 100 and/or a controller associated with a computer, for example, at a pharmacy 180. For example, the unique code may be associated with a patient name, medical card, OHIP code, and/or a medical insurance number and stored in local memory associated with a dispensing device 100 and/or local memory associated with a remote computer, for example, a computer at a pharmacy 180.

In one embodiment, a dispensing device 100 may transfer to or receive data from a remote computer, for example, a server, a personal computing device, or a computer at a pharmacy 180; a vial 30; a magazine; or a compliance pack over a network 150. For example, a dispensing device 100 may be connected to the Internet and/or a cloud based application that may, for example, allow access to a user portal, where, for example, a user may view and/or modify data relating to patient prescription history and adherence record. A dispensing device 100 may be configured to connect to a remote computer; to a network, for example, a mobile data network; and/or to a personal computing device, using, for example, the Internet, Wi-Fi technology; Bluetooth technology. In one embodiment, a dispensing device 100 may store data, for example, in local memory, a QR code, a bar code, or an NRC circuit.

In any embodiment, the holding chamber, acoustic chamber, and exit chamber may be made using injection molded parts.

In one embodiment a dispensing device 100 may receive, store, and/or transmit data relating to time that a patient may have retrieved one or more units of medication from the dispensing device 100, whether a patient retrieved one or more units of medication from the dispensing device 100, the number of units of medication retrieved from the dispensing device 100, the type or types of units of medication dispensed and/or retrieved, patient data, for example, relating to identification of a patient; one or more identification codes, for example, uniquely identifying a dispensing device 100, vial 30, magazine, and/or pharmacy 180; one or more prescription schedules; and time, for example, current time.

In one embodiment, an actuating mechanism 40 associated with a dispensing device 100 may actuate the release of one or more units of medication from an associated vial 30 or magazine. In another embodiment, the vial 30 or magazine may release one or more units of medication into the holding chamber upon being associated with the dispensing device 100.

In one embodiment, when a pill is released from the vial 30 or magazine, it may land in the holding chamber in the dispensing device 100. An actuating mechanism 40 associated with a dispensing device 100 may actuate the release of one or more units of medication from the holding chamber onto the acoustic membrane in the dispensing device 100. In another embodiment, when a pill is released from the vial 30 or magazine, it may land on an acoustic membrane in the dispensing device 100.

Shown in FIG. 24B is a reloadable or refillable container or vial for use with the dispensing device 100 in FIG. 24A. A number of vials or containers (e.g. 6-8) can be inserted into the dispensing device 100 to carry and dispense medication. Each container or vial can be uniquely identified. A compatible vial or container from the pharmacy 180 can be used. Empty vials may be returned to pharmacy 180 for refill if needed.

### Optional Acoustic Chamber

FIG. 23 is a view of an example of an acoustic chamber 130. Said acoustic chamber may have a microphone to detect audio and may be configured to detect sound waves generated when one or more units of medication strike the floor of said chamber. In one embodiment, the dispensing device 100 may contain an acoustic channel. In one embodiment, the acoustic channel may be located in an acoustic chamber in the dispensing device 100. An acoustic chamber may have a control board and electronic sensors. In one embodiment, when a pill lands on an acoustic membrane, a signal may be produced by the acoustic channel and recognized by local memory in the dispensing device 100. The recognition of the signal may be via audio sensors located in the acoustic chamber. In one embodiment, the dispensing device 100 may process the signal. In another embodiment, the dispensing device 100 may transfer data relating to the signal to a remote computer, for example, a server. The remote computer may then process the data and transfer data to the dispensing device 100. For example, the data may be processed to identify the number of units of medication released. In one embodiment, data relating to the signal produced by the acoustic channel may be compared with data relating to signals. In another embodiment, the data relating to the signal produced by the acoustic channel may be identified to correspond to a particular type of pill. In one embodiment, the comparison and/or identification may be performed by local memory in the dispensing device 100. In another embodiment, the comparison and/or identification may be performed by a remote computer. For example, data relating to the signal produced by the acoustic channel may be identified to correspond to a particular type of pill. The identification may be performed using a library of data relating to audio signals that stores or allows an algorithm to compute an association between data relating to a signal and a particular type of pill. In any embodiment, the dispensing device 100 and/or remote computer may store data, for example, unprocessed or processed, in local memory.

### Library

In one embodiment, a library of acoustic signals and their association with particular types of items may be developed using data relating to acoustic signals produced by an acoustic channel. In one embodiment, the development of the library may be through machine learning algorithms. This may provide for increasingly accurate and efficient identification of items, for example, units of medication. For example, data relating to a signal produced from an acoustic channel in one or more dispensing devices 100 may be used to develop a single library. In one embodiment, the library may be stored on a remote computer, for example, a server. For example, a dispensing device 100 may transfer data relating to a signal produced from an acoustic channel to the remote computer and the remote computer may transfer data corresponding to the identification of the item that produced the signal to the dispensing device 100. In another embodiment, the library may be stored on a dispensing device 100.

This system may provide for the automation of pill recognition and improve the accuracy and efficiency of identifying and/or counting items, for example, units of medication. This system may also provide for accuracy in the identification of the number of and the type of units of medication, even where multiple units of medication, for example, units of medication of the same or different type, are released onto an acoustic channel. This system may also provide for the release of multiple units of medication in a given dose for a given prescription at one time.

In one embodiment, one or more units of medication may be stored in the dispensing device 100 in a holding chamber that may receive units of medication.

In one embodiment, a vial 30 or magazine may be associated with the dispensing device 100 such that the dispensing device 100 may receive units of medication from the vial 30 or magazine. In one embodiment, a vial 30 or magazine may only be associated with the dispensing device 100 in one orientation.

In one embodiment, the vial 30 or magazine may be inserted into the dispensing device 100. In another embodiment, the vial 30 or magazine may be attached to the dispensing device 100. In one embodiment, when the vial 30 or magazine is associated with the dispensing device 100, the vial 30 or magazine may be locked in place, for example, with a physical key, a locking association between the vial 30 or magazine and dispensing device 100, or by transferring a code into the dispensing device 100 that locks the vial 30 or magazine in place if the code corresponds to a code stored in the dispensing device 100. In one embodiment, the vial 30 or magazine is part of the dispensing device 100 and may not be removed. In one embodiment, the locking mechanism may breach tamper evident foil associated with a vial 30 or magazine.

In one embodiment, once the vial 30 or magazine is inserted into or otherwise coupled with the dispensing device 100, one or more units of medication in the vial 30 or magazine is released into the holding chamber in the dispensing device 100. For example, the dispensing device 100 may have a mechanism to move the magazine, for example, rotate as in a carousel, to position, for example, align, the magazine for release of one or more units of medication, for example, from one or more containers in the magazine, into the holding chamber in the dispensing device 100. Any units of medication in the holding chamber may be inaccessible except as released by the dispensing device 100 at the prescribed time(s). In another embodiment, the vial 30 or magazine may only be unassociated from the dispensing device 100 when there are no more units of medication in the holding chamber or when all the units of medication in the holding chamber are not appropriate, for example, expired, recalled, or not one of the type or types of units of medication prescribed for the patient with whom the dispensing device 100 is associated. For example, a dispensing device 100 may disengage, for example, unlock, disable and/or eject, a vial 30 from said dispensing device 100 upon determination that one or more units of medication in said vial 30 is expired, recalled, or not prescribed to the patient with whom said dispensing device is associated. The device 100 may also discard medication into a separate compartment if the medication has not been picked up from the holding/drop tray after a pre-configured duration for safety purposes.

That could be achieved by sensing weight of the chamber and comparing it to empty chamber or sensing opening of the tray after dispensing and so forth.

The dispensing device 100 is configured to receive, from an external device via a network communication interface, a stop notification relating to medication contained in a vial of the one or more vials and stop dispensing using the vial based on the stop notification. Thee stop notification may be include at least one of a recall notification, a physician discretionary notification, expiry notification, safety notification, and prescription notification. This may provide dispensing device 100 with the ability to stop dispensing based on an external trigger, including recall, physicians discretion, expiry reached, and so on. This provides improved safety aspects that cannot be implemented using known pill bottles or unconnected systems.

In another embodiment, once the vial 30 or magazine is associated with the dispensing device 100, no units of medication in the vial 30 are released from the vial 30 until the actuating mechanism 40 associated with the dispensing device 100 actuates said release.

In other embodiments, a dispensing device 100 may be able to be associated with other kinds of containers that hold units of medication.

In another embodiment, one or more units of medication may be inserted into the optional holding chamber by manually placing one or more units of medication into an inlet. In said embodiment, the holding chamber is inaccessible and cannot receive one or more units of medication until the dispensing device 100 has read data, including data corresponding to a patient and a pill type, compared the data, and verified that the data corresponds to the patient that the dispensing device 100 is associated with and to the type of units of medication prescribed for that patient.

In one embodiment, a vial 30 may sense or detect whether one or more units of medication contained in said vial 30 is not appropriate and/or which pill that may be. One or more sensors installed in vial 30, for example, in one or more protrusion-created spaces 3040, may sense or detect the quantity of units of medication stored in said vial 30 and/or its capacity to store additional units of medication and/or may transfer data relating to a quantity of units of medication to a computer and/or a processor installed, for example, in a vial 30, a dispensing device 100, a computer at a pharmacy 180, a health care provider 300, and/or other user devices 600. A processor installed in a vial 30 may process and/or transfer data relating to pill quantity and/or capacity to store additional units of medication to a remote computer, for example, a processor in a dispensing device 100, a computer at a pharmacy 180, and/or other user devices 600. A processor installed in a vial 30 may actuate the updating of data stored in an information label area 350, for example, an NRC code. A dispensing device 100 may receive said data and store said data in local memory 220 and/or transmit said data to a remote computer, for example, at a pharmacy 180, health care provider 300, and/or other user devices 600.

In one embodiment, the dispensing device 100 may measure characteristics, for example, electrical characteristics such as resistance and capacitance, of computer-readable tamper evident foil associated with the vial 30 and/or magazine. This may provide a way to detect tampering of the vial 30 and/or magazine, for example, breaching the security wrap, vial 30, and/or magazine to access the units of medication. For example, a sealed vial 30 may have an initial value of A, for example, relating to resistance and/or capacitance data. Data relating to one or more tamper evident foil measurements from a sealed vial 30 may be stored, for example, at a pharmacy 180 and/or engraved, encoded, printed, and/or programmed into a label information area 350 associated with a vial 30. If a user breaches said tamper evident foil after said vial 30 has been sealed, the electronic characteristics, such as the resistance and/or capacitance, may change from an initial value of A. Thus, upon association of a vial 30 with a dispensing device 100, sensor 250 associated with dispensing device 100 may be configured to detect the characteristics of said tamper evident foil associated with said vial 30 and may determine, receive, and/or read data relating to current electrical characteristics, for example, resistance and/or capacitance of said tamper evident foil. Said data may indicate current electrical characteristics differ from an initial value A. Thus, upon receiving and/or transferring said data to a processor 210 associated with a dispensing device 100, said processor 210 may determine that a vial 30 has been tampered with.

FIG. 24A shows a view of a dispensing device 100 and a vial 30 with an NRC circuit contained in an information label area 350. In some example embodiments, the vial 30 or magazine may be connected to receive from and/or transfer data to the dispensing device 100 or other device connected over a network 150. Data from the information area label of the vial 30 or magazine may be read by a sensor 250 of a dispensing device 100. In one embodiment, a sensor 250 on a dispensing device 100 may scan an information label area 350 on a vial 30 that may contain, for example, a QR code or a barcode. In another embodiment, the dispenser may read data from an NFC circuit. In one embodiment, the dispensing device 100 may receive the data from a remote computer over a network 150. In one embodiment, the dispensing device 100 may be configured to store received data in a local memory 220 installed in the dispensing device 100. In one embodiment, a processor 210 installed in a dispensing device 100 may process data such that said dispensing device 100 may automatically dispense the units of medication in an accurate and safe manner, for example, using an actuating mechanism 40. A processor 210 may compare the data. In one embodiment, the processor 210 may compare the data with data stored in the dispensing device 100. In another embodiment, the dispensing device 100 may transfer to or receive data from a remote computer, for example, a server, a personal computing device, or a computer at a pharmacy 180; a vial 30; or a compliance package, over a network 150. For example, this data may include data corresponding to one or more tamper evident foil measurements; one or more prescription schedules; time; one or more types of units of medication, for example, pill types that a patient has been prescribed; patient data, for example, relating to identification of a patient for whom units of medication are associated or prescribed; one or more identification codes, for example, uniquely identifying a dispensing device 100, vial 30, magazine, and/or pharmacy 180; and/or medication data. In another embodiment, data may be downloaded via a physical connection from another computer.

In one embodiment, the dispensing device 100 may receive and/or store one or more prescription schedules. The prescription schedule may include data, for example, on the amount and type of medication that the patient has been prescribed and time that the medication is to be taken.

The dispensing device 100 may receive and/or store data relating to how much medication has been prescribed for a single dose for the patient with whom the dispensing device 100 is associated.

In one embodiment, a dispensing device 100 may receive and/or store data corresponding to a tamper evident foil measurement.

In one embodiment, the dispensing device 100 may transfer a signal to a remote computer, for example, a server, to request data corresponding to time and then receive data from a remote computer, for example, a server. In one embodiment, this data may be then stored in the dispensing device 100. In another embodiment, the requested data may instead correspond to whether an actuating mechanism 40 associated with a dispensing device 100 may actuate the release of one or more units of medication from the vial 30, magazine and/or a holding chamber. In one embodiment, the dispensing device 100 may contain a time keeping mechanism. In one embodiment, the time keeping mechanism may be calibrated with a time keeping mechanism on a remote computer, for example, a server. For example, the time keeping mechanism in the dispensing device 100 may be calibrated to match the time keeping mechanism on a remote computer. For example, the dispensing device 100 may be configured to be calibrated at specified intervals after which the configuration capabilities are locked by either a physical key or key received by a controller and/or stored in local memory or may be calibrated upon transmission of a signal from a remote computer, for example, a server.

A dispensing device 100 may be associated with a single patient. This may help with the security of the medication. The dispensing device 100 may receive and/or store data that uniquely identifies a patient. In one embodiment, the patient may be uniquely identified using their medical card, OHIP code, and/or medical insurance number. In another embodiment, the patient may be uniquely identified using a code assigned to the device and associated with a single patient in a remote computer, for example, a server.

The dispensing device 100 may receive and/or store data that relates to one or more types of units of medication prescribed to the patient that the dispensing device 100 is associated with and/or stored in a vial 30.

The dispensing device 100 may receive data from a remote computer. In one embodiment, the dispensing device 100 may process the data. In one embodiment, the dispensing device 100 may store the data. In one embodiment, the dispensing device 100 may alter data stored in the dispensing device 100. For example, the dispensing device 100 may change and/or update data corresponding to one or more prescription schedules, expiry date(s) for one or more types of pill(s), or the type of pill(s) prescribed for the patient with whom the dispensing device 100 is associated, for example, if a type of pill has been recalled or is no longer prescribed for the patient. This may provide for the ability for a remote computer to update data on a dispensing device 100, alter when or if an actuating mechanism associated with a dispensing device 100 actuates release of units of medication from one or more vials 30 or magazines, and/or dispenses medication. For example, this may provide for ease of obtaining prescribed units of medication from the dispensing machine without visiting or calling a physician as prescriptions may be updated remotely.

For example, in one embodiment, the dispensing device 100 may receive and/or store data relating to an identification code, for example, relating to a unique identifier for a patient. The dispensing device 100 may then transfer a signal or data relating to a request for data to a remote computer, for example, a computer at a pharmacy 180 over a network 150. A remote computer that receives and/or stores said request may transfer a signal or data relating to the request and/or relating to the data requested, for example, data associated with a unique identifier for a patient. For example, the data may relate to one or more tamper evident foil measurements; one or more prescription schedules; time; one or more types of units of medication, for example, pill types that a patient has been prescribed; patient data, for example, relating to identification of a patient for whom units of medication are associated or prescribed; one or more identification codes, for example, uniquely identifying a dispensing device 100, vial 30, magazine, and/or pharmacy 180; and/or medication data.

In another embodiment, a sensor associated with the dispensing device 100 may read data from an information area label of a vial 30 or magazine, as described above. For example, the data may relate to one or more tamper evident foil measurements; one or more prescription schedules; time; one or more types of units of medication, for example, pill types that a patient has been prescribed; patient data, for example, relating to identification of a patient for whom units of medication are associated or prescribed; one or more identification codes, for example, uniquely identifying a dispensing device 100, vial 30, magazine, and/or pharmacy 180; and/or medication data. In one embodiment, a controller 20 in the dispensing device 100 may transfer a signal or data relating to a request for data to a remote computer, for example, a computer at a pharmacy 180 over a network 150. For example, a request for data may relate to data not received from the vial 30 or magazine. If the dispensing device 100 is unable to transfer data over a network 150 a controller 20 associated with the dispensing device 100 may record data relating to that fact and/or relating to the data requested, may cause the display of data on a display component associated with the dispensing device 100, for example, data relating to any inability to receive requested data, and may actuate an actuating mechanism 40 associated with the dispensing device 100 to actuate the dispensing of one or more units of medication.

In another embodiment, at any time, a processor associated with the dispensing device 100 may receive and/or transfer data or a request for data to and/or from a remote computer. For example, the data may relate to one or more tamper evident foil measurements; one or more prescription schedules; time; one or more types of units of medication, for example, pill types that a patient has been prescribed; patient data, for example, relating to identification of a patient for whom units of medication are associated or prescribed; one or more identification codes, for example, uniquely identifying a dispensing device 100, vial 30, magazine, and/or pharmacy 180; medication data; and/or one or more compliance packages. For example, data received and/or stored in a local memory associated with the dispensing device 100 may be updated by data transferred from a remote computer, for example, a computer at a pharmacy 180. For example, data received and/or stored in a remote computer, for example, a computer at a pharmacy 180, may be updated by data transferred from a dispensing device 100. In any embodiment, the data transferred may be processed by a processor, for example, associated with a dispensing device 100 or associated with a remote server, before it may be used by a processor to update data, for example, data that is stored in a dispensing device 100 or in a remote server.

In one embodiment, the dispensing device 100 may process the data. The data may be processed, for example, locally in the dispensing device 100 or it may be transferred to a remote computer, for example, a server, and the server may process it and transfer an output to the dispensing device 100.

In one embodiment, the dispensing device 100 may generate the result of the comparison of data as an output. In one embodiment, that output may be displayed on a display component associated with the dispensing device 100 and/or transferred to a remote computer, for example, a computer at a pharmacy 180 or a server.

A dispensing device 100 may receive data from a vial 30 and/or remote computer relating to a quantity of units of medication in a vial 30 and/or a vial's 30 capacity to hold additional units of medication and said dispensing device 100 or a component therein, for example, a processor 20, may compare said data to data read from an information label area 350 on a vial 30. In one embodiment, an actuating mechanism 40 in a dispensing device 100 may not actuate the release of one or more units of medication from an associated vial 30 if said comparison does not reveal an appropriate correspondence. A processor 20 may transfer said data to a remote computer, for example, at a pharmacy 180. A processor at pharmacy 180 may be configured to record data in memory. This may provide a way to track or compute data relating to adherence and/or tampering of a vial 30.

An actuating mechanism 40 associated with a dispensing device 100 may actuate the release of one or more units of medication from the vial 30, magazine, and/or holding chamber, based on the comparison of data. In one embodiment, the actuation of one or more units of medication from the vial 30, magazine, and/or holding chamber may be influenced or determined by the comparison of data. In another embodiment, the actuation may be influenced or determined by processed data. Specifically, an actuating mechanism 40 associated with a dispensing device 100 may actuate the release of one or more units of medication from the vial 30, magazine, and/or holding chamber if the patient for whom the units of medication contained in the vial 30 or magazine are prescribed matches the patient with which the dispensing device 100 is associated, if the units of medication contained in the vial 30 or magazine are of the same type as that prescribed for the patient with which the dispensing device 100 is associated, if the time for the units of medication to be released corresponds to the current time, if one or more identification codes, for example, relating to a vial 30, magazine, dispensing device 100, and/or pharmacy 180, corresponds to one or more identification codes, for example, relating to relating to a vial 30, magazine, dispensing device 100, and/or pharmacy 180. In one embodiment, an actuating mechanism 40 associated with a dispensing device 100 may only actuate the release of one or more units of medication from the vial 30, magazine, and/or holding chamber if the data associated with the measurement made by the dispensing device 100 of the tamper evident foil associated with the vial 30 or magazine corresponds to the data associated with the tamper evident foil measurement. In one embodiment, if the actuation mechanism associated with a dispensing device 100 does not actuate the dispensing of one or more units of medication, a controller 20 associated with a dispensing device 100 may actuate the display of data on a display component associated with the dispensing device 100; record data, for example, data relating to a failed validation; transfer a signal or data to a remote computer, for example, a computer at a pharmacy 180; and/or disassociate a vial 30 or magazine from the dispensing device 100 or allow said disassociation to occur. For example, an inlet with a vial 30 or magazine inserted in it and that is associated with the dispensing device 100 may unlock, unhook, disengage, and/or eject a vial 30 or magazine from said inlet. In one embodiment, a dispensing device 100 may first compare data relating to, for example, identification of a pharmacy 180 and/or patient, and then compare data relating to one or more tamper evident foil measurements, for example, stored in a bar code.

An actuating mechanism 40 associated with a dispensing device 100 may actuate the release of one or more units of medication from a vial 30, magazine, holding chamber, and/or acoustic chamber and the number of units of medication released may correspond to the number required according to the prescription schedule. For example, an actuating mechanism 40 associated with a dispensing device 100 may actuate the release of the number of units of medication that together contain the amount of medication to be taken by the patient at the time that the actuation is initiated.

An actuating mechanism 40 associated with a dispensing device 100 may actuate the release of one or more units of medication from a vial 30, magazine, compartment, holding chamber, and/or acoustic chamber that are of a type that corresponds to the type of pill or units of medication required according to the prescription schedule and/or according to the data relating to the type of pill prescribed for the patient that the dispensing device 100 is associated with. For example, a dispensing device 100 may have one or more sensors 250 that may sense, detect, receive, and/or transmit data, for example, relating to one or more types of units of medication and/or an association with, for example, storage in, one or more compartments associated with a dispensing device 100, where said compartments number, for example, six, seven, or eight. In one embodiment, one or more units of medication may be stored in one or more compartments associated with a dispensing device 100. In one embodiment, one or more vials 30 may be stored in one or more compartments associated with a dispensing device 100. In one embodiment, one said compartment may store only one type of item, for example, units of medication. In one embodiment, if one or more units of medication of the same type or if vial 30 storing one or more units of medication of the same type are associated with, for example, inserted into, said compartment, a dispensing device 100 may receive data associating said compartment with said pill type. For example, a sensor may read a QR code, bar code, and/or NRC code associated with said vial 30, for example, in an information label area of vial 30. For example, a sensor 250 may receive data from an acoustic recognition chamber or a component of an acoustic recognition chamber relating to the type of said pill. In one embodiment, an actuating mechanism 40 may receive data from a controller 20 relating to the compartment associated with one or more types of units of medication and said actuating mechanism 40 may actuate the release of one or more types of units of medication, according to data, for example, relating to a prescription schedule or pill type that has been prescribed for a patient. For example, the controller 20 associated with the dispensing device 100 or remote computer may determine correspondence, if any, between this data by comparing the data or by processing the data and comparing the processed data. In one embodiment, a remote computer may transfer a signal or data relating to a cue to actuate the release of one or more units of medication and/or the type of pill for which release is to be actuated. Said signal or data may be transferred over a network 150 and received by a controller 20 of a dispensing device 100.

In one embodiment, the actuation may be performed at a time determined using a time keeping mechanism associated with the dispensing device 100; one or more prescription schedules; and/or a signal or data from a controller in a computer, for example, a computer at a pharmacy 180, personal computing device, vial 30, and/or magazine. For example, the controller 20 associated with the dispensing device 100 or remote computer may determine correspondence, if any, between the current time and the time that actuation may be performed by comparing the data or by processing the data and comparing the processed data. In one embodiment, a remote computer may transfer a signal or data relating to a cue to actuate the release of one or more units of medication and/or the time that the release is to be actuated. For example, a remote computer may be a computer at a pharmacy 180.

In one embodiment, one or more units of medication released by the vial 30, magazine, and/or holding chamber may be verified to be the correct pill(s) to be released at that time. For example, this verification may be performed using an acoustic membrane described above.

In one embodiment, the actuating mechanism 40 may be driven by an electrical machine or a motor, for example a DC motor or a stepper motor. Said actuating mechanism 40 may be configured to register an angular displacement, if any, of a drive shaft. For example, said motor may be coupled to a gearbox and a shaft encoder to register said angular displacement. A spur gear installed in a dispensing device 100 may be positioned on a drive shaft. Said spur gear may be configured to engage a gear, for example, a spur gear 3900 or 3030, installed in a vial 30. Said drive shaft may have a groove that may allow a spur gear to slide along the shaft and maintain engagement with said shaft. A spur gear on a drive shaft installed in a dispensing device 100 may engage a spur gear 3900 or 3030 on a slotted disk or concentric slotted disk vial 30. Said motor may rotate a shaft and move, for example, rotate a spur gear 3900 or 3030. Said spur gear 3900 or 3030 may actuate the release of one or more units of medication, for example, one pill at a time, from a vial 30, as described elsewhere. The pill may be the pill at the lowest point in a slotted disk vial 30 or concentric slotted disk vial 30, and said pill may move, by gravity, out of said vial 30. In one embodiment, one or more units of medication released may be detected electronically and may be collected in a collection tray that may be located near a component holding one or more vials 30. A spur gear on a drive shaft may be aligned with a spur gear 3900 or 3030 of a slotted disk or concentric slotted disk vial 30 by moving, for example, sliding along, said drive shaft. Said spur gear may be moved along said drive shaft by a fork that may be attached to a worm gear that may be driven by a stepper motor. Said stepper motor may assist with positioning. In one embodiment, a dispensing process may begin by the identification of a correct vial 30 from which one or more units of medication may be dispensed. Said identification may be performed by comparison of data by a processor 210, where said data may relate to an association of pill type and/or vial 30 to a particular compartment associated with a dispensing device 100, as described elsewhere. A positioning motor may move a spur gear along a drive shaft and may align it with a spur gear 3900 or 3030 of a correct slotted disk or concentric slotted disk vial 30. A spur gear on a drive shaft may be engaged with a spur gear 3900 or 3030 of a correct vial 30. A dispensing motor may then move, for example, rotate, a component on said correct vial 30, for example, a spur gear 3900 or 3030, until one or more units of medication may be released from said vial 30. One or more units of medication may move, for example, by gravity, out of a vial 30. A door may be installed in a dispensing device 100 and may be opened by said motor used to drive said spur gear. Said door may provide a physical barrier to an opening of a dispensing device 100. A dispensing device 100 may sense, as described elsewhere, a release of one or more units of medication and may actuate the movement of said door. Said door may be moved, for example, by a cam associated with a spur gear, such that it may not provide a physical barrier to an opening of a dispensing device 100. For example, a cam associated with said spur gear may push a push rod installed in said dispensing device 100. Said push rod may move, for example, open, said door, which may be located under said correct vial 30. In one embodiment, a pill may move, for example, by gravity from a vial 30, into a compartment associated with a dispensing device 100, for example, a holding chamber, an acoustic chamber, and/or an exit chamber. One or more units of medication release may be counted by a counting mechanism, for example, an optical counter installed with a sensor. A counting mechanism may be attached to a worm gear driven by a stepper motor. Said counting mechanism may be attached to a pusher pad. Said pusher pad may be used to push one or more units of medication from an intermediate space, for example, an exit chamber, to a collection tray that may be exposed to a user at correct times or to a reject compartment that may not be exposed to a user without initiation of an unlocking mechanism. One or more released units of medication may be counted by said counting mechanism. In one embodiment, if only one pill is released, said pill may be pushed by a pusher pad to an extreme end of said intermediate space. Said intermediate space may be installed with a trap door leading to a collection tray. Said trap door may then be opened by said cam attached to said spur gear. A motor may move, for example, rotate, said cam to open said trap door and said pill may move to a collection tray. A lock, for example, an electromagnetic lock, may be disengaged and a user may gain access to said collection tray. If more than one pill is released by a single actuation of an actuating mechanism 40, a motor may move, for example, rotate, said cam to open a trap door installed leading to a reject tray. Said cam may open said trap door and push said units of medication to a reject tray. Initiation of an actuating mechanism 40 may be via a component configured to receive data from a user, for example, a haptic activator that allows for a request for one or more units of medication to be dispensed. A dispensing device 100 may receive said data and then alert a user at a prescribed time. A user may then arrive at a dispensing device 100 and actuate a haptic activator, for example, a button. Upon actuating said haptic activator, a dispensing device 100 may actuate an actuating mechanism 40 and assemble one or more units of medication for release. When all units of medication for a given dose are collected in a collection tray associated with said dispensing device 100, a dispensing device 100 may alert one or more users. A sensor, for example, optical, that may be installed in a collection tray may sense a retrieval of one or more units of medication and may receive, stored, and/or transfer data relating to a time. Said data may be associated with a user's adherence record, for example, upon transfer of data to a remote computer via a network 150.

In one embodiment, a dispensing device 100 may have an actuating mechanism 40. An actuating mechanism 40 may be driven by a stepper motor. For example, said motor may be coupled to a gearbox and a shaft encoder to register angular displacement of a drive shaft. A gear, for example, a spur gear may be attached to said shaft and said gear may slide along the length of said shaft and maintain engagement with said shaft. One or more vials 30, for example, pill strip vials 30, may be associated with, for example, inserted into a container in, a dispensing device 100. A strip of units of medication that may be rolled up in a vial 30 may be moved, for example, pulled out, by a set of interlocked free-running spur gears. Said gears may engage one or more notches in a pill strip. Upon engagement, movement of said gears may pull said strip out of a vial 30. As a strip is pulled, it enters a reverse tapper chamber that may be, for example, shaped like a hollow prism built across a length of a section of a dispensing device 100 where said dispensing device 100 is associated with said vial 30, for example, a container in dispensing device 100 where said vial 30 is inserted. Upon release from a vial 30, a pill may move, for example, by gravity, into a container, for example, a holding chamber, an acoustic chamber, and/or an exit chamber. Said container may be tapered in a direction away from the end of vial 30 where one or more units of medication may be released from said vial 30. The shape of said container may facilitate the movement of one or more units of medication into a collection tray. A sensor 250 installed in a dispensing device 100 may sense or detect a release of a pill and/or the drop of a pill and may then cease the movement of one or more spur gears. In turn, the cessation of said movement may cease the movement of a strip from a vial 30. Said spur gears may be coupled to a drive shaft by a second spur gear that may be attached to said drive shaft. A spear gear may be positioned by a fork like attachment that may ride a worm gear that may be driven by a stepper motor. Said stepper may be a different motor than a stepper motor that may rotate the drive shaft. The former may be used to facilitate the positioning of internal components of an actuating mechanism 40, while the latter, a dispensing motor, may be used to move, for example, rotate a drive shaft.

In one embodiment, a dispensing process may begin by the identification of a correct vial 30 from which one or more units of medication may be dispensed. Said identification may be performed by comparison of data by a processor 210, where said data may relate to an association of pill type and/or vial 30 to a particular compartment associated with a dispensing device 100, as described elsewhere. A positioning motor may move a fork that may engage a spur gear along a drive shaft and may align it with one or more spur gears that may engage a pill strip. A dispensing motor may move, for example, rotate one or more spur gears that may be engaged with a notched pill strip and may move, for example, turn, said spur gears until one or more units of medication are released from said strip and/or moved into a chamber, for example, a holding chamber, acoustic chamber, and/or exit chamber, and/or into a collection tray. In one embodiment, a pill may move, for example, by gravity from a vial 30, into a compartment associated with a dispensing device 100, for example, a holding chamber, an acoustic chamber, and/or an exit chamber. One or more units of medication release may be counted by a counting mechanism, for example, an optical counter installed with a sensor. A counting mechanism may be attached to a worm gear driven by a stepper motor. Said counting mechanism may be attached to a pusher pad. Said pusher pad may be used to push one or more units of medication from an intermediate space, for example, an exit chamber, to a collection tray that may be exposed to a user at correct times or to a reject compartment that may not be exposed to a user without initiation of an unlocking mechanism. One or more released units of medication may be counted by said counting mechanism. In one embodiment, if only one pill is released, said pill may be pushed by a pusher pad to an extreme end of said intermediate space. Said intermediate space may be installed with a trap door leading to a collection tray. Said trap door may then be opened by said cam attached to said spur gear. A motor may move, for example, rotate, said cam to open said trap door and said pill may move to a collection tray. A lock, for example, an electromagnetic lock, may be disengaged and a user may gain access to said collection tray. If more than one pill is released by a single actuation of an actuating mechanism 40, a motor may move, for example, rotate, said cam to open a trap door installed leading to a reject tray. Said cam may open said trap door and push said units of medication to a reject tray. Initiation of an actuating mechanism 40 may be via a component configured to receive data from a user, for example, a haptic activator that allows for a request for one or more units of medication to be dispensed. A dispensing device 100 may receive said data and then alert a user at a prescribed time. A user may then arrive at a dispensing device 100 and actuate a haptic activator, for example, a button. Upon actuating said haptic activator, a dispensing device 100 may actuate an actuating mechanism 40 and assemble one or more units of medication for release. When all units of medication for a given dose are collected in a collection tray associated with said dispensing device 100, a dispensing device 100 may alert one or more users. A sensor, for example, optical, that may be installed in a collection tray may sense a retrieval of one or more units of medication and may receive, stored, and/or transfer data relating to a time. Said data may be associated with a user's adherence record, for example, upon transfer of data to a remote computer via a network 150.

A sensor 250 may be installed in a dispensing device 100, for example, in an exit chamber or pick-up tray, and may detect the presence of one or more units of medication or compliance packages and/or the quantity of units of medication or compliance packages in a location, for example, in an exit chamber, in a dispensing device 100 and may transfer data relating to said detection to a processor 210 in a dispensing device 100. A processor 210 may actuate a removal mechanism in a dispensing device 100 that may in turn actuate the removal of one or more units of medication in said location, for example, in an exit chamber, and move said units of medication to a chamber that is not exposed to a user. Said removal mechanism may be configured in a manner similar to an actuating mechanism 40.

Dispensing device 100 may have a component enabling a back-up power supply. A dispensing device 100 may send out one or more alerts in the case of loss of a main power supply and/or a low back-up power supply.

In one embodiment, the user interface of the dispensing device 100 may have of a “Make Dosage” button this is used to order the making of the dosage at the prescribed time. The dosage making process starts with loading the prescription along with the prescription time in the dispensing device 100. Once this information is available the dispensing device 100 alerts the patient or client at the time of talking dosage. The client is then required to come to the dispensing device 100 and press the “Make Dosage” button. Upon depressing this button the dispensing device 100 start making the dosage and once all the pills in the dosage are collected in the pick-up tray 1500, the dispensing device 100 can then send out an alert asking the client to pick up the pills.

An optical sensor in the pick-up tray may sense the picking up of the pills and logs this time in the client's adherence record.

### Production of Compliance Packs

This system may provide for the dispensing of units of medication to be taken immediately or saved for future use. For example, this may provide for a method to create compliance packages. This may provide for flexibility in how the dispensing device 100 may assist with medication compliance. This may also provide for efficiency and financial and/or time savings, for example, to the pharmacy 180, as pharmacies may not need to spend as much time producing compliance packages and interfacing with patients. This may also provide flexibility in creating compliance packages covering doses over one or more durations.

In one embodiment, the dispensing device 100 may package one or more units of medication that are in a chamber, for example, the exit chamber. In one embodiment, this process may be controlled by a compliance package control mechanism. In one embodiment, the dispensing device 100 may create a single package containing one or more units of medication from one or more doses. For example, the dispensing device 100 may configure an actuating mechanism 40 to successively dispense one or more units of medication corresponding to a single dose and package all units of medication for one or more doses in a single package or multiple packages. In one embodiment, the dispensing device 100 may produce data corresponding to the contents of one or more packages. In one embodiment, the dispensing device 100 may store, transfer to a remote computer, and/or include in a label, data. In one embodiment, the dispensing device 100 may label a package with data, for example, data corresponding to its contents. The data may include, for example, the current time, the time one or more doses are to be consumed based on prescription data associated with the patient with whom the dispensing device 100 is associated, data associated with the identification of the patient with whom the dispensing device 100 is associated, and/or data relating to the type of pill(s) contained in the package. The labelling of the package by the dispensing device 100 may take the form of, for example, printing data on a package or printing data on a label that is applied to the package. For example, the data may be text or figures or a code, for example, a QR code or bar code. In one embodiment, the labelling of the package by the dispensing device 100 may take the form of one or more transfers of data to the package over a network 150. In one embodiment, the dispensing device 100 may use said data to cease dispensing units of medication corresponding to the dose or doses contained in compliance packages. This may assist with safety as a patient may not be able to access medication corresponding to the same dose more than once.

In one embodiment, a compliance package may be dispensed into a chamber, using a mechanism similar to an actuating mechanism for the release of one or more units of medication, described elsewhere.

In one embodiment, the dispensing device 100 may have one or more mechanisms that may provide verification that any units of medication in a compliance pack match the medication prescribed to be taken at a given time. For example, there may be a mechanism to capture one or more photographs of a portion of or the entire chamber containing dispensed compliance packages. A photograph taken may be received by and/or stored in memory 220 installed in dispensing device 100, and/or transferred to a remote computer, for example, a server.

In one embodiment, the dispensing device 100 may have a mechanism for producing compliance packages, for example, containing units of medication corresponding to one or more doses according to a prescription schedule associated with a patient with whom the dispensing device 100 is associated with. The mechanism may include, for example, a mechanism to label a compliance package, for example, a printer; a mechanism to seal a compliance package; a mechanism to separate compliance packages, for example, a blade; a location for empty compliance packages, for example, a roll of flattened packing tube; and a location for filled compliance packages. For example, an empty compliance package may have two openings, one at each end. The dispensing device 100 may have a mechanism for moving a compliance package from an initial location and through the compliance package producing mechanism. The compliance package producing mechanism may have a mechanism for filling a compliance package with one or more units of medication. The compliance package producing mechanism may seal, for example, by heat, one or both openings of a compliance package. In one embodiment, the compliance package producing mechanism may move one or more empty compliance packages from an initial location, fill one or more compliance packages with one or more units of medication corresponding to one or more medication doses according to a prescription schedule associated with a patient with whom the dispensing device 100 is associated with, separate a compliance package containing one or more units of medication from an empty compliance package, seal the open ends of one or more compliance packages that contain one or more units of medication, label one or more, for example, all, compliance packages that contain one or more units of medication, and move one or more compliance packages containing one or more units of medication in a location accessible to a person, for example, outside the dispensing device 100 or in a compartment. In another embodiment, the compliance package producing mechanism may also separate one or more compliance packages that contain one or more units of medication.

In one embodiment, the compliance package producing mechanism may be controlled by a micro-controller circuit, which may transfer to or receive data from a remote computer, for example, a server, a personal computing device, or a computer at a pharmacy 180; a dispensing device 100; or a vial 30 or magazine over a network 150. In one embodiment, a compliance package producing mechanism may store data, for example, in local memory, a QR code, a bar code, or an NRC circuit. In one embodiment, the compliance package producing mechanism may be made of various metals, plastic, and/or hard rubber. In one embodiment, the data may relate to the quantity of compliance packages produced.

For tracking of compliance package; in some example embodiments, the compliance package has controller and connectivity to network: In other example embodiments, the compliance pack is not an active device by itself and the compliance pack may be a pouch or package that contains a dosage for a specific time/day. Compliance pack data may be in the device 100 for provision to remote computers, and device 100 may not dispense until the time last compliance pack is consumed without some level of user override.

In one embodiment, a controller in a compliance package may receive, store, and/or transmit data relating to a compliance package, for example, to a dispensing device 100 that produced it or to a remote computer, for example, a server or a personal computing device. For example, said data may relate to whether a compliance package has released one or more units of medication; how many units of medication a compliance package has released; the location of a compliance package; and/or data relating to a compliance package, for example, that may be transferred from a remote computer, for example, a server or a personal computing device. For example, the location of a compliance package may be determined by a controller in the compliance package that receives data from a GPS-enabled component. For example, a user may cause the transmission of data relating to one or more compliance packages being lost. In one embodiment, a controller 20 in a dispensing device 100 may actuate the transmission of data, for example, relating to data received from a user, for example, that one or more compliance packages have been lost. In one embodiment, a controller 20 in the dispensing device 100 may only actuate an actuating mechanism 40 to dispense one or more units of medication if one or more or all compliance packages produced by a dispensing device 100 have released one or more or all units of medication. In one embodiment, a controller 20 in a dispensing device 100 may actuate the display of data on a display component associated with a dispensing device 100, for example, the data may relate to a warning or notification indicating to the user that units of medication may not be dispensed until one or more or all units of medication are released from compliance packages produced by a dispensing device 100. For example, said data may be displayed on a user interface component associated with the dispensing device 100. In one embodiment, a controller 20 in a dispensing device 100 may actuate the transmission of data relating to this refused request to a remote computer, for example, a server or a personal computing device.

In one embodiment, a dispensing device 100 may have a mechanism to receive data from a user, for example, via a user interface component associated with a dispensing device 100 or via a remote computer, for example, a personal computing device or a pharmacy server. In one embodiment, the mechanism to receive data from a user may include, for example, a key pad. In one embodiment, a dispensing device 100 may receive and/or store data and/or transmit data to a remote computer, for example, a server, where the data may relate to one or more requests for the production of one or more compliance packages. For example, in any embodiment, data received by a dispensing device 100 may, for example, relate to one or more prescription schedules; one or more types of units of medication, for example, pill types that a patient has been prescribed; patient data, for example, relating to identification of a patient; time; one or more identification codes, for example, uniquely identifying a dispensing device 100, vial 30, magazine, and/or pharmacy 180; medication data; one or more requests for the production of one or more compliance packages; one or more requests for one or more units of medication; and/or one or more tamper evident foil measurements.

In one embodiment, the dispensing device 100 may receive data from a mechanism to receive data from a user, for example, a user interface component. In one embodiment, the dispensing device 100 may receive data from a remote computer, for example, a server or a personal computer device. Upon receipt of said request, an actuating mechanism 40 of a dispensing device 100 may actuate the dispensing of one or more compliance packages. For example, an actuating mechanism 40 may actuate the dispensing of one or more compliance packages in a quantity corresponding to the data relating to one or more requests for the production of one or more compliance packages.

In one embodiment, a user interface component may include a haptic activator, for example, a button, that may be actuated to request a one or more units of medication, for example, according to a prescription. For example, said actuation may transfer a signal or data to a processor 210 that may be configured to actuate an actuating mechanism 40. Actuation of said haptic activator may only initiate said actuating mechanism 40 at a prescribed time, for example, according to a prescription schedule, and/or if one or more vials 30 have been associated with said dispensing device 100 and determined by a processor 210 to contain one or more appropriate units of medication and/or if one or more vials 30 have been verified according to data, for example, relating to one or more prescription schedules; one or more types of units of medication, for example, pill types that a patient has been prescribed; patient information, for example, relating to identification of a patient; time; one or more identification codes, for example, uniquely identifying a dispensing device 100 or a vial 30; medication or prescription information; one or more requests for the production of one or more compliance packages; and/or one or more tamper evident foil measurements.

In one embodiment, when it is time for a controller 20 associated with the dispensing device 100 to actuate an actuating mechanism 40 to dispense one or more units of medication, a controller 20 associated with the dispensing device 100 may actuate an alert, for example, a display on the user interface component, an alarm, and/or a component that may be illuminated, for example, a haptic activator component. An alert may also involve the transfer of data by a processor 210 to a remote computer, for example, in a patient device 800 or in other user devices 600. In one embodiment, one or more similar alert may also be actuated when it is time for a patient to take one or more units of medication, actuate the dispensing of one or more units of medication from a dispensing device 100, and/or actuate take one or more units of medication from a dispensed compliance package.

### Insurance

In one embodiment, adherence data received, stored, and/or transferred by a processor, for example, in a dispensing device 100, vial 30, compliance package, and/or remote computer, for example, at a pharmacy 180, may be transferred to an insurance-related component 500, for example, an insurance company. Said insurance-related component may use said data to influence one or more insurance plans and/or insurance-related products or services.

### Community of Care

Receipt of data on other user devices 600 may allow users of said devices to receive and/or use said data to improve medication adherence of a user to whom said data relates. The community of care may include friends and families of patient with suitable devices 600 to help encourage the patient to better adhere to his or her medication schedule.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A vial for storing and automatically dispensing medication, the vial comprising:
a housing comprising a machine-readable medication information label area readable by a dispensing device to validate the vial and a user receiving the medication;
a first opening at a first end of the housing; and
a container storing a plurality of units of medication, each unit of medication being of a same amount of medication, the container comprising a plurality of slots, each slot configured to release a single unit of medication of the plurality of units of medication through the first opening when the respective slot is aligned with the first opening;
wherein the first opening is configured to engage with the dispensing device to trigger dispensing of a dosage of medication made up of a number of units of medication of the plurality of units of medication of the vial, the dispensing by a number of slots of the plurality of slots corresponding to the number of units of medication.

2. The vial of claim 1, wherein the first opening is sealed prior to engagement with the dispensing device.

3. The vial of claim 2, further comprising a locking mechanism configured to engage with a corresponding locking mechanism of the dispensing device to secure the vial within the dispensing device.

4. The vial of claim 1, wherein the vial comprises a second opening at a second end of the housing, the second opening configured to receive the plurality of units of medication and to be sealed after the plurality of units of medication have been stored within the vial.

5. The vial of claim 1, wherein the medication information label area comprises data comprising one or more of: an identification number, patient information, medication information, dosage information, user information linking the vial to the user receiving the medication, and tamper evidence information.

6. The vial of claim 1, wherein the plurality of units of medication are arranged within a strip of medication, the strip containing the plurality of slots on one or more sides of the strip.

7. The vial of claim 1, further comprising one or more disks within the housing, each disk comprising one or more slots of the plurality of slots, each slot configured to release a unit of medication.

8. The vial of claim 8, wherein the one or more disks are configured to rotate about a common axis to align a slot of the one or more slots with the first opening to release the unit of medication through the respective slot.

9. The vial of claim 9, wherein the one or more disks are configured to dispense a pill by aligning a slot containing the pill with the first opening.

10. The vial of claim 10, wherein the dispensing device rejects the vial if it cannot validate the vial or the user using the medication information label area.

11. The vial of claim 1, wherein the container comprises one or more spur gears that engage the dispensing device to rotate the container about a common axis to align one of the plurality of slots at a time with the first opening to release the corresponding unit of medication of the respective slot.

12. The vial of claim 1, wherein the container has two faces, one face having a set of slots for releasing a first type of medication and the other face having a set of slots for releasing a second type of medication, the dosage of medication made up of the first and second type of medication.

13. A dispensing device configured to automatically dispense a dosage of medication made up of a number of units of medication released from one or more vials, wherein the dispensing device comprises:
a housing;
one or more inlets on an upper portion of the housing, each inlet configured to receive one of the one or more vials;
an outlet on a lower portion of the housing, the outlet configured to receive a dosage of medication made up of one or more units of medication released from at least one of the one or more vials;
a sensor within the housing configured to receive information from at least one of the one or more vials to validate the at least one vial, the dosage of medication, and a user receiving the dosage of medication; and
an actuating mechanism to actuate releasing of the dosage of medication from the one or more vials upon a trigger based on the information received from at least one vial.

14. The dispensing device of claim 14, wherein the dispensing device is wirelessly connected to a network to receive data to validate the at least one vial and transmit compliance or adherence data after dispensing.

15. The dispensing device of claim 14, wherein the actuating mechanism comprises a gear configured to engage the at least one of the one or more vials or at least a portion of the one or more vials.

16. The dispensing device of claim 16, wherein the dispensing device is configured to, for each of the one or more vials based on information of the vial, determine or receive: vial identification, current amount of available units of medication, patient or user information, medication and dosage information and tamper evidence information.

17. The dispensing device of claim 16, wherein the dispensing device is configured to trigger the actuating mechanism for releasing of the one or more units of medication from one or more vials based on the medication and dosage information, the medication and dosage information comprising one or more of: medication ingredients, total dosages available, prescribed usage, current amount of available units of medication, and timing information for taking medication.

18. The dispensing device of claim 14, wherein the dispensing device is configured to receive, from an external device via a network communication interface, a stop notification relating to medication contained in a vial of the one or more vials and stop dispensing using the vial based on the stop notification, wherein the stop notification is based on at least one of a recall notification, a physician discretionary notification, expiry notification, safety notification, and prescription notification.

19. A system for automatically dispensing medication comprising a plurality of vials, each vial storing a plurality of units of medication, and a dispensing device to dispense of a dosage of medication made up of a number of units of medication of one or more vials of the plurality of vials, the dosage of medication of released by the one or more vials;
each of the plurality of vials having:
a housing comprising a medication information label area readable by a dispensing device to validate the vial;
a first opening at a first end of the housing; and
a container storing the plurality of units of medication, each unit of medication being of a same amount of medication, the container comprising a plurality of slots, each slot configured to release a single unit of medication of the plurality of units of medication;
the dispensing device having:
a housing;
one or more inlets on an upper portion of the housing, each inlet configured to receive one of the one or more vials;
an outlet on a lower portion of the housing, the outlet configured to receive the dosage of medication from at least one of the one or more vials; and
a sensor within the housing configured to receive information from at least one of the one or more vials about the dosage of medication; and
an actuating mechanism to actuate each vial of the one or more vials to align at least one slot of the plurality of slots of the respective vial with the first opening of the respective vial, upon a trigger based on the information received from the respective vial, releasing of the dosage of medication by a number of slots of the plurality of slots corresponding to the number of units of medication.

20. The system of claim 19 wherein the dosage of medication is made up of at least two types of medication stored by the one or more vials.
